(19) United States
(12) Patent Application Publication
(10) Pub. No.: US 2021/0183252 A1
(43) Pub. Date: Jun. 17, 2021

(54) REMOTE, UNMANNED VEHICLE OPERATIONS MANAGEMENT CENTER SYSTEM TO OPERATE, CONTROL AND MONITOR UNMANNED VEHICLES WITH PRE-FLIGHT CHECKS, FLIGHT PATH OBSTACLE AVOIDANCE, INFLIGHT OPERATING ISSUES, FLIGHT PATH RECONFIGURATION, MID-MISSION RECHARGING, AND RADIO AND TELECOMMUNICATIONS SYSTEMS

(71) Applicant: Aeronyde Corporation, Melbourne, FL (US)

(72) Inventors: Donald Bittar, Palm Bay, FL (US); Alexander Bilous, Citrus Springs, FL (US); Edgar Munoz, Orlando, FL (US)

(21) Appl. No.: 16/713,315

(22) Filed: Dec. 13, 2019

(51) Int. Cl. G08G 5/00; G08G 5/04; G06Q 10/00

(52) U.S. Cl. CPC G08G 5/003; G08G 5/0013; G08G 5/0043; G06Q 10/20; G08G 5/045; G08G 5/0069; G08G 5/006

(57) ABSTRACT

An integrated method and system for centralized, remote, unmanned vehicle operations management center system to operate, control and monitor unmanned vehicles with pre-flight checks, flight path obstacle avoidance, inflight operating issues, flight path reconfiguration, mid-mission recharging, and radio and telecommunications systems.

### BACKGROUND OF THE RELATED ART

One problem in using remotely operated unmanned Vehicles is that no integrated methods and systems existed, until Aeronyde Corporation was founded, for operating multiple unmanned Vehicles from a remote operations management command center (herein referred to as a “Management Control Center”) located anywhere in the world and beyond a visual line of sight (BVLOS) of the Vehicle. Vehicles operating and controlled from a remote central location, have many commercial applications. Some of the applications include surveillance, imaging, video recording, and environmental data collection.

A primary use for remotely controlled and monitored unmanned Vehicles is the inspection of outdoor infrastructure, structures, equipment, facilities, agricultural crops, and other assets. Another major use of remotely controlled and monitored unmanned Vehicles is improving the delivery of emergency public services and commercial goods. Remotely controlled and monitored unmanned Vehicles offer a more effective and timely method than manual inspections for inspecting outdoor infrastructure, structures, equipment, facilities, agricultural crops, and other assets. Human inspection of large, outdoor assets is far more time consuming than remotely controlled and monitored unmanned Vehicle system surveillance.

Additionally, the quantity, quality, and variety of data that can be captured with each human inspection is generally less comprehensive than inspections by remotely controlled and monitored unmanned Vehicles. Furthermore, the large, outdoor assets are often in remote, hazardous, or relatively inaccessible locations, environments in which the use of remotely controlled and monitored unmanned Vehicle is more appropriate. In addition to the many and varied uses set forth herein, there are valuable, efficient, and cost-effective applications for remotely controlled and monitored unmanned Vehicles in industries such as power generation, telecommunications, fossil fuel exploration and production, transportation infrastructure (including railroads, commuter trainlines, waterways, dams, highways, bridges, construction), public safety, and natural disaster response.

Using a single pilot to individually operate and control a single unmanned Vehicle is costly, slow, and causes potential operational and safety hazards for pilots, users, and the public welfare. Also, using a single pilot to operate and control an unmanned Vehicle is difficult to scale operationally due to its high operating cost and issues related to standardization. The standardization of operating practices and procedures with this method is also difficult to manage and insure, which creates a variance in the quality of data collection between pilots; the incertitude of this data quality creates risk to users and, by extension, public welfare.

### BRIEF DESCRIPTION OF THE DRAWINGS

The present invention can be more easily understood and the advantages and uses thereof more readily apparent when the detailed description of the present invention is read in conjunction with the figures wherein:

FIG. 1 illustrates an exemplary directing the flight and operation of the next priority mission set, for at least one Vehicle, by the Vehicle Flight Management and the related process of the Pilot determining the next priority mission set; the process of the Pilot confirming the Visual Observer, Vehicle, Sensors onboard the Vehicle and FAA waivers are ready for flight; the process of the Pilot updating the Vehicle flight logs; the process of the Pilot reconfiguring the mission set; the process of the Pilot notifying pilots in geographic areas adjacent to the mission set that the mission is active; the process of the pilot determining if the mission set requires beyond visual line of sight operation or a Visual Observer; and the process of the Pilot speaking with the Visual Observer to notify the Visual Observer the mission is ready of the present invention.

FIG. 2 describes an exemplary pre-flight checking of the Vehicle by the Vehicle Flight Management and includes the related processes the Visual Observer confirming a visual inspection of the Vehicle and updating the Flight Log; the related process of the Pilot performing a pre-flight check for the Vehicle and the Sensors; the pilot performing a pre-flight check of the mission plan flight plan check; the process of the Pilot reconfiguring the Vehicle flight plan; the related process of the Pilot issuing a command to a Vehicle to launch; and the related process of the Pilot issuing a command to Vehicles, which are assigned to a Fleet to begin communicating, by radio transmission, with each other.

FIG. 3 shows an exemplary directing the flight and operation of Vehicles to the Vehicle's next Waypoint in the mission set by the Vehicle Flight Management and the related process of sending the Vehicle a command to the Vehicle for the Vehicle to proceed to the flight plan altitude; the related process of the Vehicle send an acknowledgement to the Management Center that the Vehicle is at the flight plan altitude; the related process of the Pilot sending the Vehicle a command to proceed to the next Waypoint.

FIG. 4 illustrates an exemplary operating and control of a Vehicle, while the Vehicle is in flight, by the Vehicle Flight Management and the related process of the Pilot confirming the Vehicle reaching the Project Set, entering the first Waypoint and its location; the related process of the Pilot updating the flight log; the related process of the Pilot confirming the Vehicle is on time; the related process of the Pilot confirming the Vehicle fuel level is sufficient to complete the mission set; the related process of the Pilot confirming there are no obstacles ahead in the Vehicle's path; the related process of the Pilot sending a command to the Vehicle to travel to the Waypoint; the related process of the Pilot confirming the Vehicle has completed the Project Set; the related process of the Pilot sending a command to a Vehicle to advance to the return home altitude; and the related process of the Pilot confirming the Vehicle acknowledging it has reached the return home altitude.

FIG. 5 demonstrates an exemplary operating and control of a Vehicle, to return to its origin location, by the Vehicle Flight Management and the related process of the Pilot confirming the Vehicle reaching the origin location; the related process of the Pilot sending a command to the Vehicle to land, the related process of the Visual Observer confirming the Vehicle has landed; the related process of the Pilot confirming Vehicle has landed; the related process of the Pilot sending a command to the Vehicle to down Vehicle systems and processes.

FIG. 6 shows an exemplary operating and control of a Vehicle by the Vehicle Flight Management and the related process of the Pilot determining if there is a flight issue; the related process of the Pilot determining if there is a flight obstacle; the related process of the Pilot determining there is a flight obstacle ahead; the related process of the Pilot confirming there is a flight issue with the Visual Observer; the related process of the Pilot determining there is a an emergency threat to the vehicle or to the public; the related process of the Pilot confirming there is a flight issue with the Visual Observer; the related process of the Pilot confirming with the Visual Observer there is a an emergency threat to the vehicle or to the public; the related process of the Pilot confirming there is a flight issue with the Visual Observer; the related process of the Pilot issuing a command to the Vehicle to immediately land and down Vehicle systems and processes; the related process of the Pilot sending the Vehicle the location of the landing zone for the Vehicle; the related process of the Pilot sending the Vehicle a command to immediately land at the landing zone.

FIG. 7 illustrates an exemplary creating of new Project Set Waypoints for a Vehicle by the Vehicle Flight Management and the related process of the Pilot speaking to the Visual Observer to inform the Visual Observer of new Waypoints for the Vehicle; the related process of the Pilot issuing new Waypoints to the Vehicle; the related process of the Pilot determining the new flight path for the Vehicle; and the related process of the Pilot send the Vehicle a command to stop moving.

FIG. 8 demonstrates an exemplary operating and controlling a Vehicle to recharge by the Vehicle Flight Management and the related process of the Pilot determining if the Vehicle needs a recharge; the related process of the Pilot assessing the location of the nearest Charger to the Vehicle; the related process of the Pilot determining there is insufficient fuel for the Vehicle to reach the Charger; the related process of the Pilot authorizing the Vehicle to proceed to the location of a Charger for which the Vehicle is not authorized; the related process of the Pilot approving the recharging operation for the Vehicle; and the related process of the Pilot telling the Visual Observer the recharge status for the Vehicle.

FIG. 9 shows an exemplary operating and controlling a Vehicle to be repaired by the Vehicle Flight Management and the related process of the Pilot determining the Vehicle needs repair; the related process of the Pilot sending the Vehicle to perform a full system test; the related process of the Pilot reviewing the results of the Vehicle full system test; the related process of the Pilot confirming, with the Visual Observer, the Vehicle needs repair; and the related process of the Pilot determines the nearest Repair Depot.

FIG. 10 illustrates an exemplary operating and controlling a Vehicle with flight issues other than equipment malfunctions by the Vehicle Flight Management and the related process of the Pilot determining the nature of the issues other than equipment malfunction; the related process of the Pilot determining if the Vehicle returns to home; and the related process of the Pilot telling the Visual Observer the nature of the issue other than equipment malfunction.

FIG. 11 demonstrates an exemplary Vehicle Flight Management process and system for transmitting radio signals and the related process of converting a ‘Snap’ to digital data for transmission; the related process of converting the digital data to analog signals for transmission; the related process of selecting the transmitting radio frequency; the related process of the frequency selector switch device selecting either the 700 MHz radio transmission system or the 1250 MHz radio transmission system; the related process of inputting the digital data into the 700 MHz band modem device; the related process of inputting the radio frequency signal into the 700 MHz band time division and frequency division multiplexor; the related process of inputting the radio frequency signal into the 700 MHz band radio transmitter; the related process of inputting the radio frequency signal into the 700 MHz band radio antenna; the related process of the radio frequency signal into the 700 MHz band radio transmitter; the related process of inputting the digital data into the 1250 MHz band modem device; the related process of inputting the radio frequency signal into the 1250 MHz band time division and frequency division multiplexor; the related process of inputting the radio frequency signal into the 1250 MHz band radio transmitter; and the related process of inputting the radio frequency signal into the 1250 MHz band radio antenna;

FIG. 12 demonstrates an exemplary Vehicle Flight Management process and system for receiving radio signals and the related process of receiving the radio frequency signal from the 1250 MHz band radio antenna; the related process of inputting the radio frequency signal into the 1250 MHz band radio transmitter; the related process of inputting the radio frequency signal into the 1250 MHz band signal filter; the related process of inputting the radio frequency signal into the 1250 MHz band modem device; the related process of receiving the radio frequency signal from the 700 MHz band radio antenna; the related process of inputting the radio frequency signal into the 700 MHz band radio transmitter; the related process of inputting the radio frequency signal into the 700 MHz band signal filter; the related process of inputting the radio frequency signal into the 700 MHz band modem device; and the related process of converting the analog signals to digital data; the related process of decrypting the digital data into a Snap; the related process of interfacing the Snap data with a data store.

FIGS. 13.1-13.98 illustrate exemplary communication methods used in the present invention and include: Accessory Data Vehicle Snap, Autonomous Aerial Communications Coupler Snap, Connect/Disconnect Vehicle & Charger Snap, Start of Message Snap, Remote Connect/Disconnect Vehicle & Charger Snap, Sensor Data Snap, End of Message Snap, Vehicle Data Snap, Vehicle Image Data Snap, Vehicle or Component ID Snap, Vehicle to Charger Communications Method, Vehicle ID to Management Center Snap, Mate Vehicle with Fleet Snap, Vehicle Authorized in Geographic Area Snap, CC or Frwd Message Snap, Mate Vehicle with Vehicle Snap, Resend Images from Vehicle Snap, Flight Plan Approved Snap, 4D Environment Communication Snap, Vehicle Full System Test Request Snap, Request Vehicle Type and Frequency Data Snap, Vehicle Full System Test Results Snap, Landing Zone Identification Snap, Vehicle or Charger Communication with Electrical Connector Snap, LAANC Authorization Number Snap, Submit Flight Plan Request to Management Center Snap, Flight Time Spent in Geographic Area Snap, Data Type to be Sent from Vehicle Snap, Exit Geographic Area Snap, Hand-Off Vehicle from Management Center to Another Snap, Flight Plan Restrictions Snap, Geographic Lockout Snap, Request Vehicle to Resend Images Snap, Vehicle Grounded by Repair Depot Snap, Vehicle Grounded Status Removed Snap, Return to Active Service Snap, Acknowledgment Images Received Snap, Repair Depot Assignment Snap, Enterprise Data Snap, Fleet Data Communication method, Pilot Assigned to Fleet Snap, Pilot Assigned to Vehicle Snap, Visual Observer Assigned to Fleet Snap, Visual Observer Assigned to Vehicle Snap, Fleet Assigned to Mission Set Snap, Mission Set Identification Snap, Project Set Assigned to Fleet Snap, Charger ID Assigned to Fleet Snap, Charger ID Snap, Visual Observer ID Snap, Pilot ID Snap, Pilot Assigned to Mission Set Snap, Visual Observer Assigned to Mission Set Snap, Next Priority Mission Snap, Flight Log Snap, Fleet Ready to Execute Mission Set Snap, FAA Waiver Approved Data Snap, FAA Waiver ID Snap, Vehicle Ready to Execute Mission Set Data Snap, Pilot Ready to Execute Mission Set Snap, Visual Observer Ready to Execute Mission Set Snap, Mission Set Checklist Data Snap, Enterprise ID Snap, Fleet ID Snap, Repair Depot ID Snap, Geographic Area ID Snap, Vehicle Assigned to Geographic Area Snap, RF Frequency Used in Geographic Area Snap, RF Frequency Used by Antenna Snap, Geographic Area Ping Test Request Snap, Charger Full System Test Request Snap, Charger Full System Test Results Snap, Vehicle Down Snap, Flight Checklist ID Snap, Flight Plan Checklist ID Snap, Flight Plan Checklist Data Snap, FAA Waiver Data Snap, Waypoint Data Span, Visual Operator Ready for Launch Snap, Mission Set Altitude Snap, Next WayPoint Snap, Reconfigured Flight Plan Data Snap, Status Snap, Date and Time Snap, Land Command Snap, Project Set ID Snap, Vehicle Location Snap, Emergency Landing Data Snap, Obstacle Data Snap, Stop Command Snap, Flight Issue Snap, Charger Location Snap, Vehicle Recharge Command Snap, Vehicle Fuel Level Snap, Launch Snap, Return to Origin Snap, Encrypted Data Snap, and Decrypted Data Snap.

FIGS. 14.1-14.50 illustrate an exemplary data architecture for the present invention and include the following data tables: Data Base Architecture, Battery Profile Table, Cargo Profile Table, Certification Profile Table, Charger Table, Charger Type Table, Data Priority Profile Table, Enterprise Table, Event Table, Event Profile Table, FAA License Table, Flight Plan Table, Geographic Area Table, Jobs Table, Mission Set Table, Mission Set Profile Table, Mission Status Table, Mission Journal Table, Operator Table, Operator Profile Table, Project Set Table, Project Set Data Priority Table, Radio Frequency Table, Sensor Table, Sensor Profile Table, Status Table, Status Profile Table, Sub-Enterprise Table, Vehicle Table, Vehicle Profile Table, Waypoint Table, What3Words Table, Pre-Flight Charger Checklist Table, Fleet Table, Pilot Table, Visual Observer Table, Repair Depot Table, Mission Set Checklist Table, FAA Waiver Table, LAANC Table, Encryption Table, Flight Log Table, Pre-Flight Checklist Table, Pre-Flight Vehicle Checklist Table, Pre-Flight Sensor Checklist Table, Pre-Flight Flight Plan Checklist Table, Emergency Landing Zone Location Table, Recent Obstacle Table, Flight Issue Profile Table, and Data Profile Table.

FIG. 15 illustrates the symbols used in the figures.

In accordance with common practice, the various described features are not drawn to scale, but are drawn to emphasize specific features relevant to the invention. Like reference characters denote like elements throughout the figures and text.

### DETAILED DESCRIPTION OF THE PRESENT INVENTION

The following are definitions of terms used in the description of the invention.

An “FAA Waiver” is an official authorization document issued by the Federal Aviation Administration (FAA), which approves specific operations of unmanned aerial Vehicle or plurality of unmanned aerial Vehicles outside the restrictions and limitations of a regulation defined in the FAA 14 CFR Part 107 and under 49 U.S.C. § 44809(a), as amended.

A “Filter” is a device which excludes predefined radio frequencies from input to a radio receiver.

A “Fleet” is plurality of unmanned Vehicles operating independently from and in concert with each other.

A “Fleet Management Center” is a subset of the Management Center. The Fleet Management Center is located within the Management Center, which is at a location remote from the unmanned Vehicles, associated with FAA 14 CFR (Code of Federal Regulations) Part 107 licensed Pilots, as amended, responsible for creating, operating, and monitoring Fleets of unmanned Vehicles.

A “Flight Management Center” is a subset of the Management Center. “Flight Management Center” and “Vehicle Flight Management” are used interchangeably in the present invention. It is located within the Management Center, which is at a location remote from the unmanned Vehicles, associated with FAA 14 CFR Part 107 licensed Pilots, as amended, responsible for operating and monitoring unmanned Vehicles.

A “Full System Test” is a test of a complete and fully integrated unmanned Vehicle, Charger, Sensor, Shipping Container, or a combination thereof. A Full System Test includes a series of different sub-tests, the sole purpose of which is to exercise individual components of the unmanned Vehicle, Charger or Sensor. The hardware, software and firmware are tested individually and together. The Full System Test evaluates the test results and compares those results against a set of desired or required results.

A “Geographic Area” or “Geo Area” is a demarcated area of the Earth is defined by a longitude and latitude for each significant boundary point of the area. The surface of the earth is divided into an established grid, bounded by longitude and latitude lines. Each cell of the grid defines a specific geographic area.

“LAANC” is the FAA Low Altitude Authorization and Notification Capability. It directly supports Unmanned Aerial Systems integration into the controlled airspace. LAANC automates the application and approval process for airspace authorizations. Through automated applications developed by an FAA approved Unmanned Aerial System Service Suppliers (USS) pilots apply for an airspace authorization to operate an unmanned Vehicle, in accordance with Public Law 112-95, § 333 and its implementing regulations at 14 CFR Part 107 and under 49 U.S.C. § 44809(a), as amended.

A “Land Command” or “Land” is a command to the Vehicle to move from its present location and elevation to another location on the ground and to cease flying.

A “Landing Zone” or “LZ” or “L/Z” is the longitude and latitude identifying the physical fixed location or mobile platform from which a Vehicle departs, takes off or on which a Vehicle arrives, lands.

“Launch” is the process of a Vehicle leaving a stationary place on the ground and moving to its Next position in a mission set.

A “Management Center” is a location remote from the unmanned Vehicles, associated with licensed FAA 14 CFR Part 107 Pilots responsible for operating and monitoring unmanned Vehicles, unmanned Vehicle fleets and chargers. “Management Center” and “Management and Control Center” are all used interchangeably in the present invention.

A “Mission Set” includes a collection of operating rules, operating instructions, locations, device and Fleet lists, used to perform a task or series of tasks at a specific time and location. It is a collection of one or more Project Sets.

A “Modem” is a device for modulation and demodulation of radio frequency signals. It converts digital data to be transmitted into an analog signal and converts a received analog radio signal into digital data.

A “Multiplexor” or “MUX” is a device allowing one or more analog or digital input signals to be selected, combined and transmitted at a higher speed on a single shared medium or within a single shared device. Thus, when multiplexed, several signals may share a single device or transmission medium, such as a radio frequency transmitter.

A “Next” as associated with the terms Mission Set, Project Set, Flight Plan, WayPoint, LZ, Vehicle as part of a Fleet, Fleet, Charger and other things, is a first, or second, or third and continuing sequential instances until the last instance of a Mission Set, Project Set, Flight Plan, WayPoint, LZ, Vehicle as part of a Fleet, Fleet, Charger and other things.

An “Origin Location” (“Origin”), is the latitude, longitude, and altitude of the fixed geographic location or mobile platform from which the Vehicle ss launched.

A “Pilot” or “Licensed Pilot” or “FAA Part 107 Pilot” is a member of Company Personnel, who directs, operates and controls a Vehicle or plurality of Vehicles. The Pilot is licensed by the Federal Aviation Administration (FAA) under 14 CFR Part 107 and under 49 U.S.C. § 44809(a) of the FAA, as amended, to remotely operate and control an unmanned Vehicle or plurality of unmanned Vehicles.

A “Ping” is a process to test if a specific receiving entity is reachable by a specific transmitting entity. It is a diagnostic that checks if the transmitting entity is connected to a receiving entity. A Ping sends a data packet from a transmitting entity to a receiving entity. If it is received by the receiving entity, the receiving entity returns a data packet to the transmitting entity acknowledging receipt of the data packet.

A “Project Set” is a subset of a Mission Set. The Project Set includes a collection of operating rules, operating instructions, locations, events, and lists of Pilots, Vehicles, Sensors, Chargers and Fleets that are used to perform specific event tasks at a specific time and location associated with the Project Set. It also includes but is not limited to a Flight Plan, Start time, End time. It also includes a plurality of project Waypoints and L/Zs.

A “Repair Technician” or “RT” is a member of Company Personnel authorized to repair Vehicles, Vehicle Components, Sensors, Chargers and other things.

A “Return to Home Altitude” is a predefined or real-time determined altitude, to which the Vehicle ascends or descends and continues at that altitude until it reaches its origin location.

A “Shipping Container” is a container built with a plurality of materials and used to protect and enclose Vehicles, Vehicle Components, Sensors, Chargers and other things for and during shipping.

A “Regional Identifier” or “RID” is an alphanumeric identifier of a region.

A “Sectional Identifier” or “SID”, is a subset of a “RID”, and an alphanumeric identifier of a section of a region.

A “Snap” is a connection between two or more entities in a network. It virtually affixes two or more entities to each other within the network.

A “System” is an interconnected, integrated, coordinated, functioning operation of Vehicles, or Fleets, or Chargers, or equipment, or hardware, or software, or humans, or procedures, or objects.

“Uvionics” is a commercial name of an onboard, Vehicle operating and control system, that allows licensed Pilots to remotely operate multiple Vehicles, concurrently and efficiently. Such a Vehicle Control System is commercially referred to as a Uvionics System, available from the Aeronyde Corporation of Melbourne, Fla.

A “Vehicle” is an unmanned remotely operated and monitored aerial, surface, sub-surface, maritime, or sub-marine device or system used for transporting people, goods, Sensors or other objects.

A “Visual Observer” or “VO” is a member of Company Personnel, required under the FAA 14 CFR Part 107 of the FAA Rules and Regulations, as amended, to coordinate the remote operation of an unmanned Vehicle with a Pilot. The Visual Observer is situated at the site of the unmanned aircraft and scans the airspace where the unmanned aircraft is operating for any potential collision hazards and maintains awareness of the position of the unmanned aircraft through direct visual observation.

A “Waypoint” is a subset of a Project Set. The WayPoint includes but is not limited to a digital or analog collection of operating rules, operating instructions, device lists, and a specific location's longitude, latitude and altitude, used for executing a task or “Event” at a specific location, altitude, and time.

“What3Words” is a geocode system for the communication of locations' longitudes and latitudes with a resolution of three meters. What3words encodes geographic coordinates into three dictionary words address; the encoding is permanently fixed. The What3Words system relies on a fixed algorithm rather than a large database of every location on earth. It works on devices with limited storage and no Internet connection.

These and other features and advantages of this invention are described in, or are apparent from, the following detailed description of various exemplary embodiments.

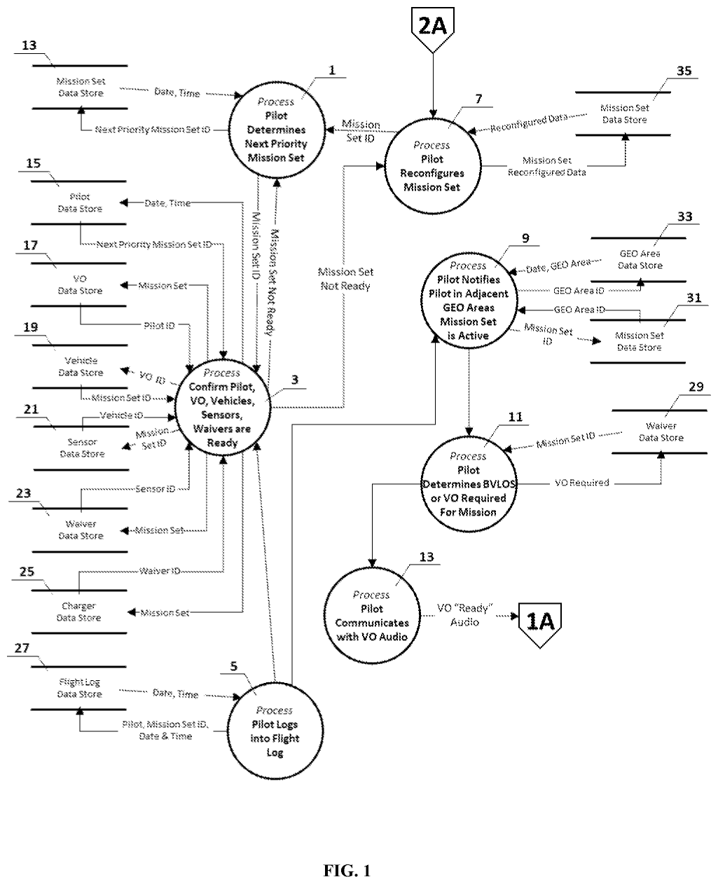

A reference to ‘(1.X)’ in the following description refers to FIG. 1 of the drawings and element number ‘X’ included in the FIG. 1.

FIG. 1 illustrates an exemplary Vehicle Flight Management to Direct Vehicle Flight for the Next Priority Mission process and related processes of the present invention.

According to the process, Pilot Determines Next Priority Mission Set, illustrated in (1.1) the pilot determines the next priority missions set. As shown in FIG. 1, the process (1.1) interacts with an associated Mission Set Data Store (1.13) by providing the Next Priority Mission Set ID and the data store replies with date and time of the mission set.

The process, Confirm Pilot, VO (Visual Observer), Vehicles, Sensors, Waivers are Ready, (1.3) confirms that all components of the mission set are ready. The process (1.3) interacts with an associated Pilot Data Store (1.15) by providing a date and time and the Next Priority Mission Set ID is then provided by the data store. The process (1.3) interacts with an associated VO Data Store (17) by providing a Mission Set, and the Pilot ID is then provided by the data store. The process (1.3) interacts with an associated Vehicle Data Store (1.19) by providing a VO ID, and the Mission Set is then provided by the data store. The process (1.3) interacts with an associated Sensor Data Store (1.21) by providing a Mission Set, and the Vehicle ID is then provided by the data store. The process (1.3) interacts with an associated Waiver Data Store (1.23) by providing a Mission Set and the Sensor ID is then provided by the data store. The process (1.3) interacts with an associated Charger Data Store (1.25) by providing a Mission Set and the Waiver ID is then provided by the data store.

The process, Pilot Logs into Flight Log, (1.5) allows the pilot to log into the Flight Log. The process (1.5) interacts with an associated Flight Log Data Store (1.27) by providing a Pilot, Mission Set ID, Date and Time; the Date and Time are then confirmed by the data store.

The process, Pilot Reconfigure Mission Set, (1.7) allows the pilot to reconfigure the mission set. The process (1.7) interacts with an associated Mission Set Data Store (1.35) by requesting reconfigured data and the Reconfigured Data is then provided by the Data Store (1.35).

The process, Pilot Notifies Pilot in Adjacent Geo Areas Mission Set is Active, (1.9) allows the Pilot to notify Pilots in adjacent Geo Areas that the Mission Set is now active. The process (1.9) interacts with an associated Mission Set Data Store (1.31) by providing the Mission Set and the Data Store (1.31) then provides the Geo Area ID. The process (1.9) interacts with an associated Geo Area Data Store (1.33) by providing the Geo Area ID and the Data Store (1.33) then provides the Geo Area Data.

The process, Pilot Determines BVLOS or VO Required for Mission, (1.11) allows the pilot to determine if a BVLOS or a VO is required for the mission. The process (1.11) interacts with an associated Waiver Data Store (1.29) by inputting that a VO is required and the Data Store (1.29) then provides the Mission Set.

The process, Pilot Communicates with VO Audio, (1.13) allows the Pilot to communicate with the VO via an Audio link.

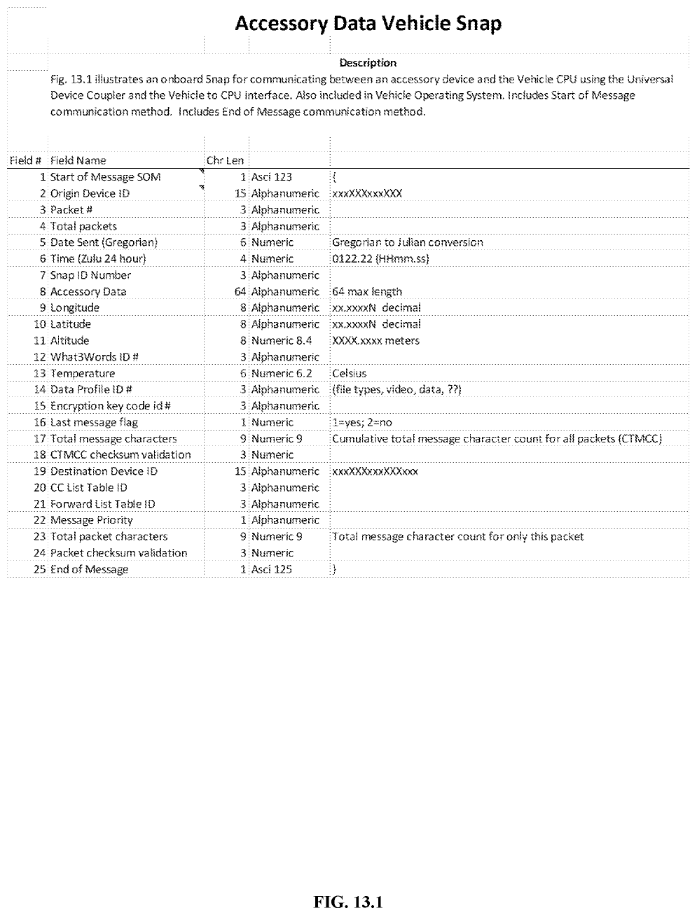

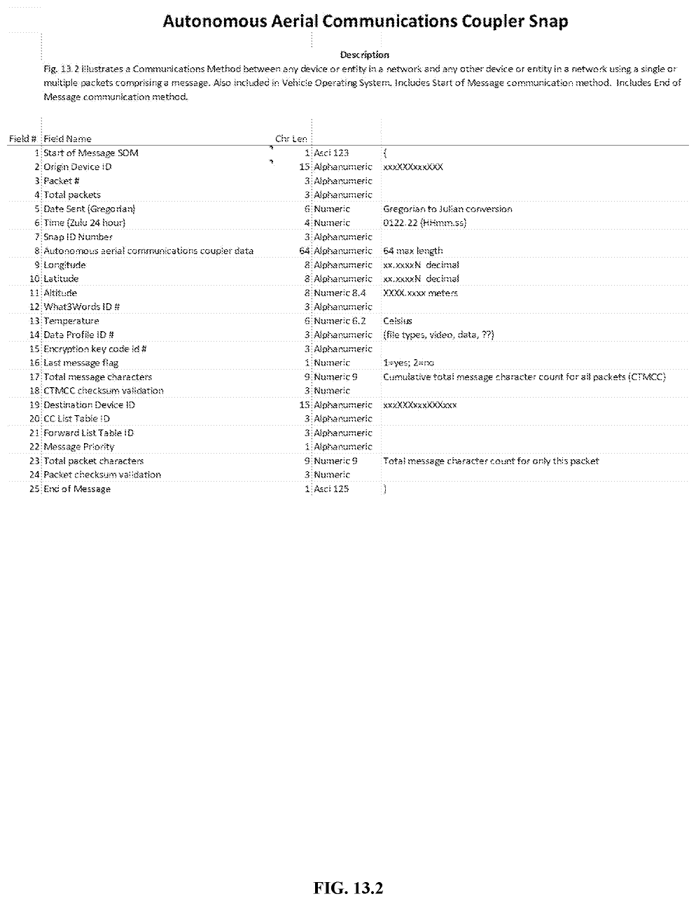

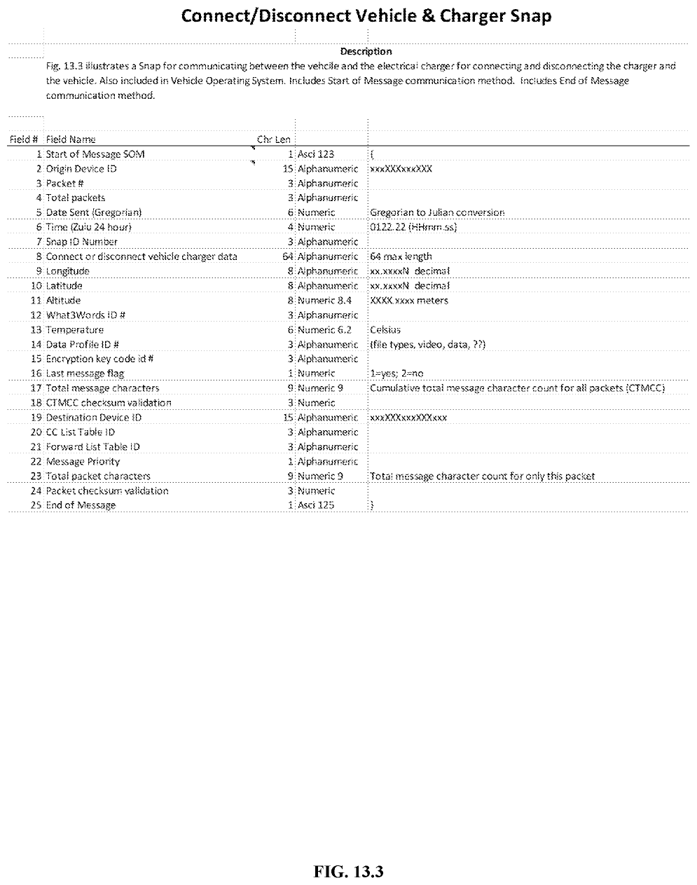

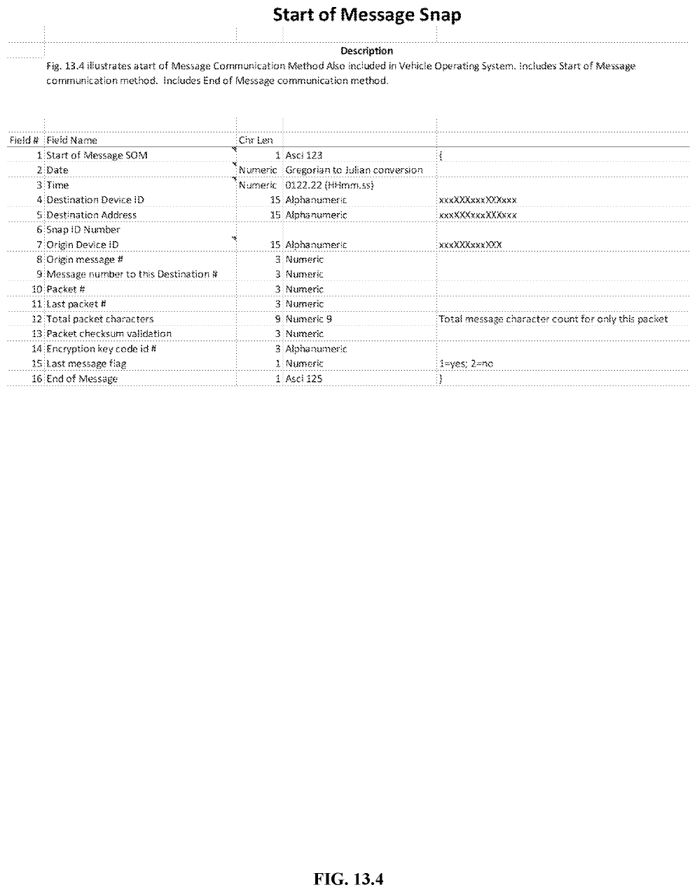

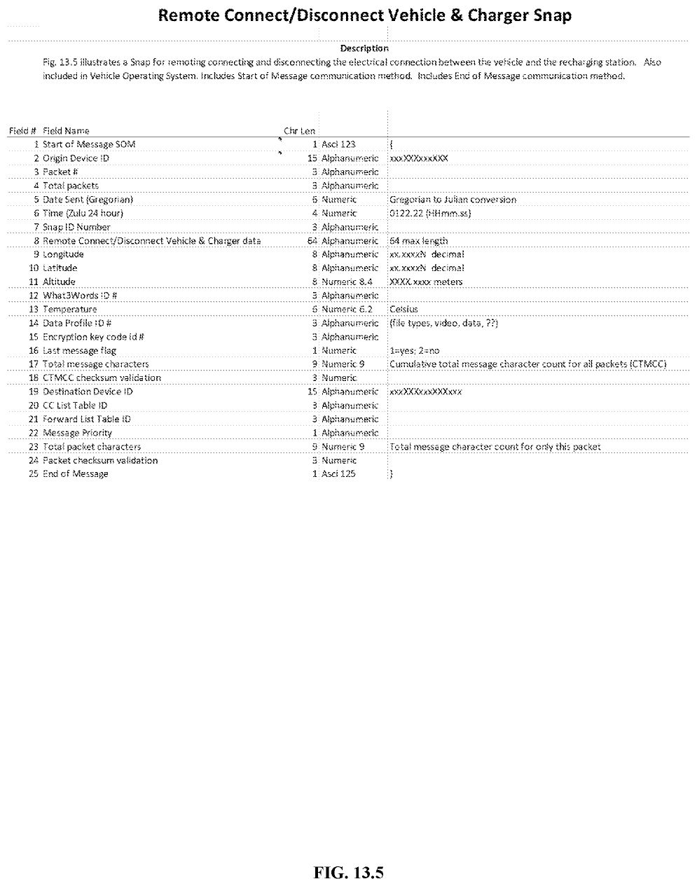

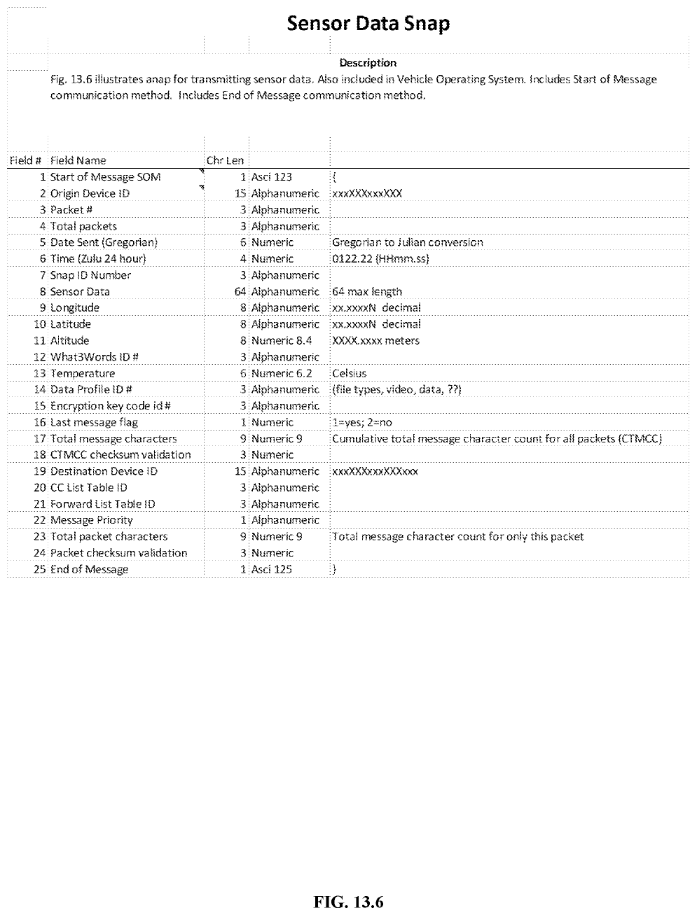

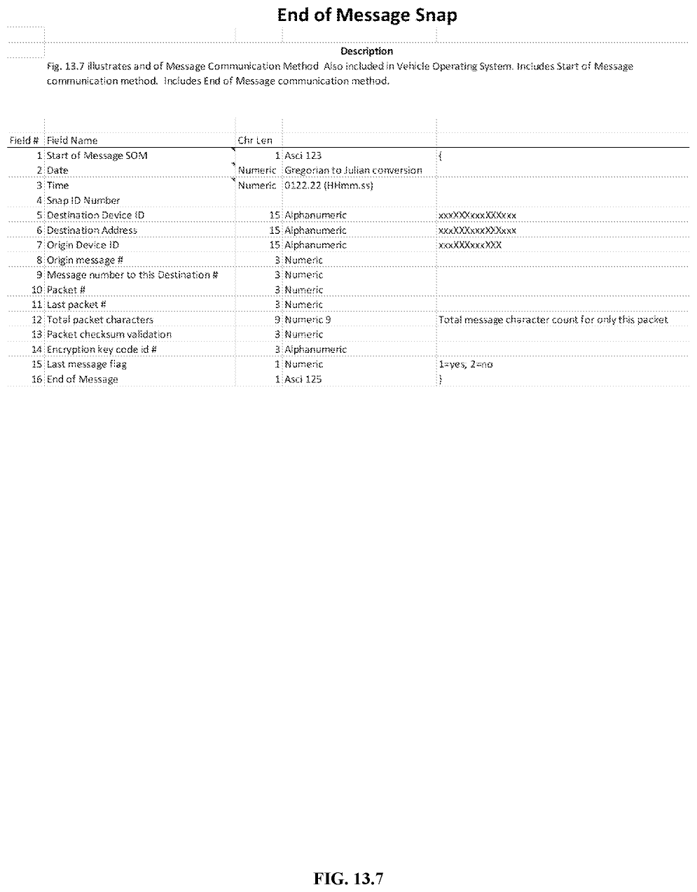

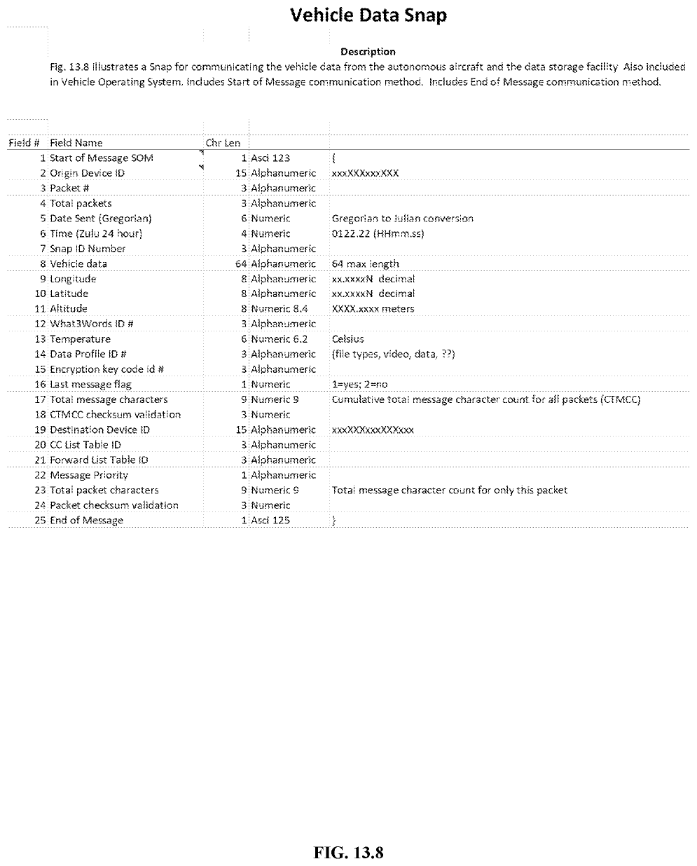

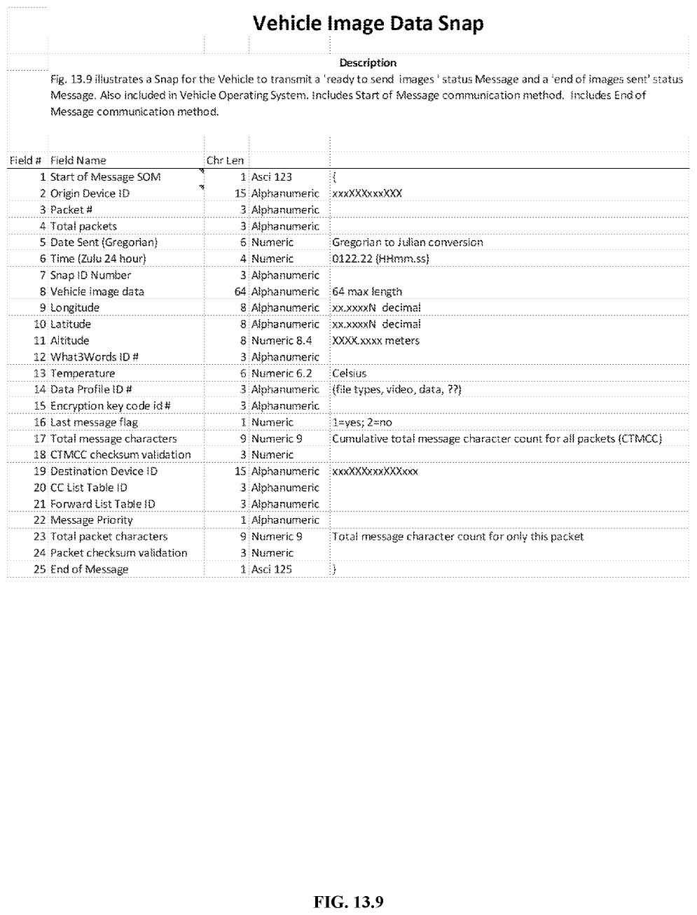

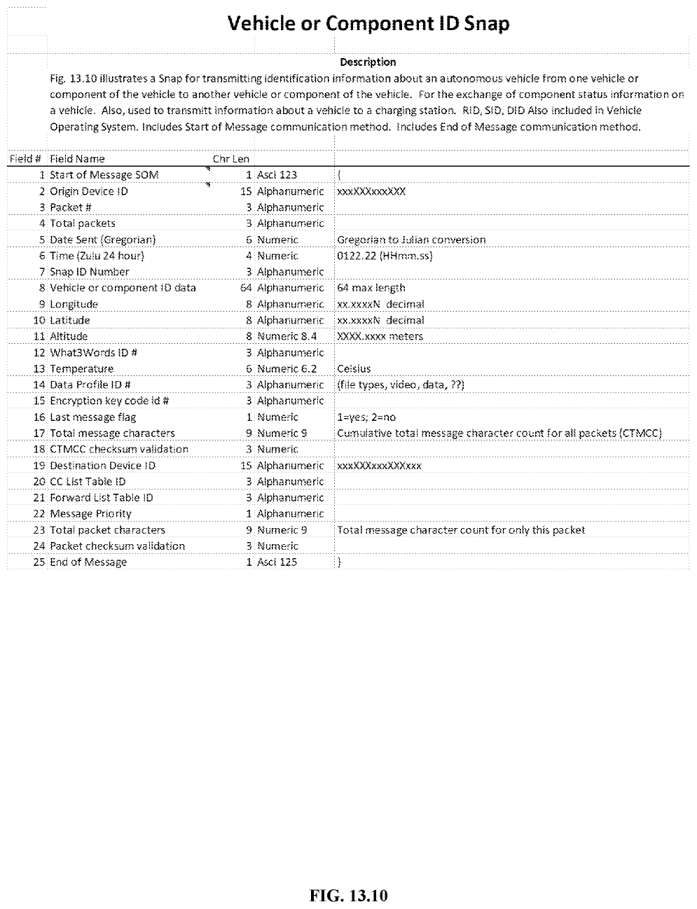

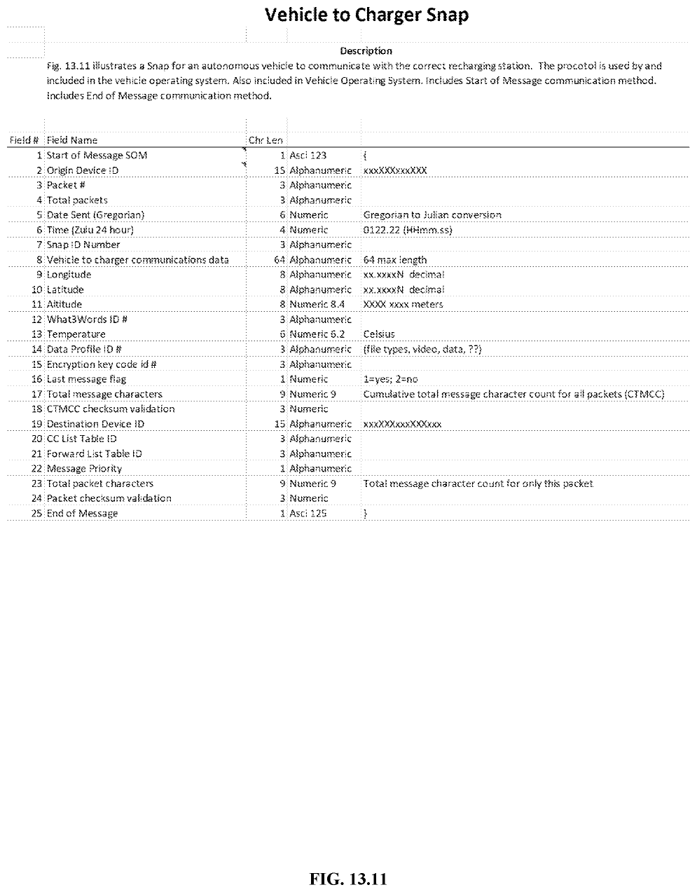

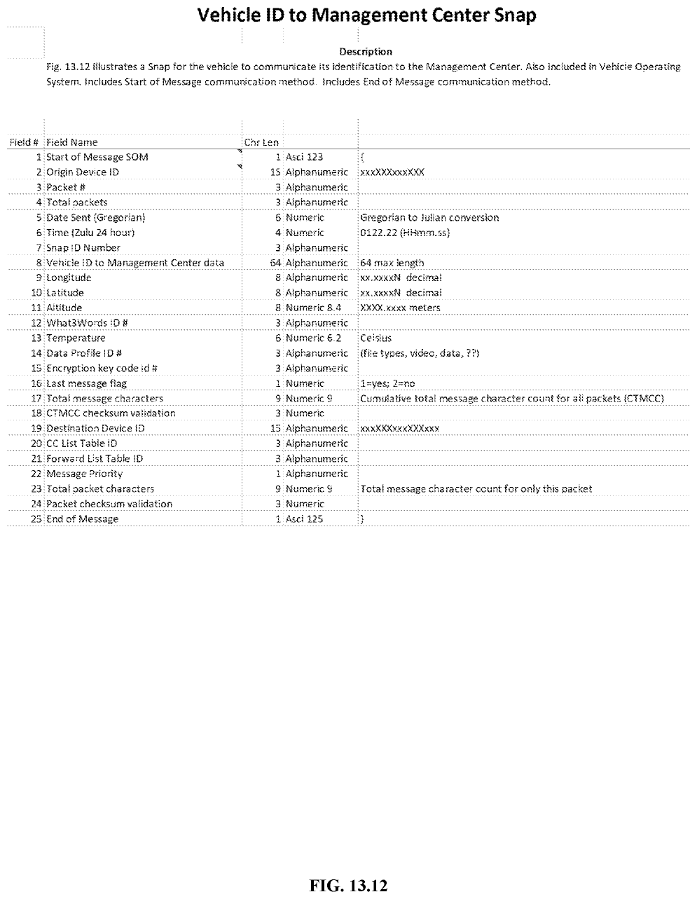

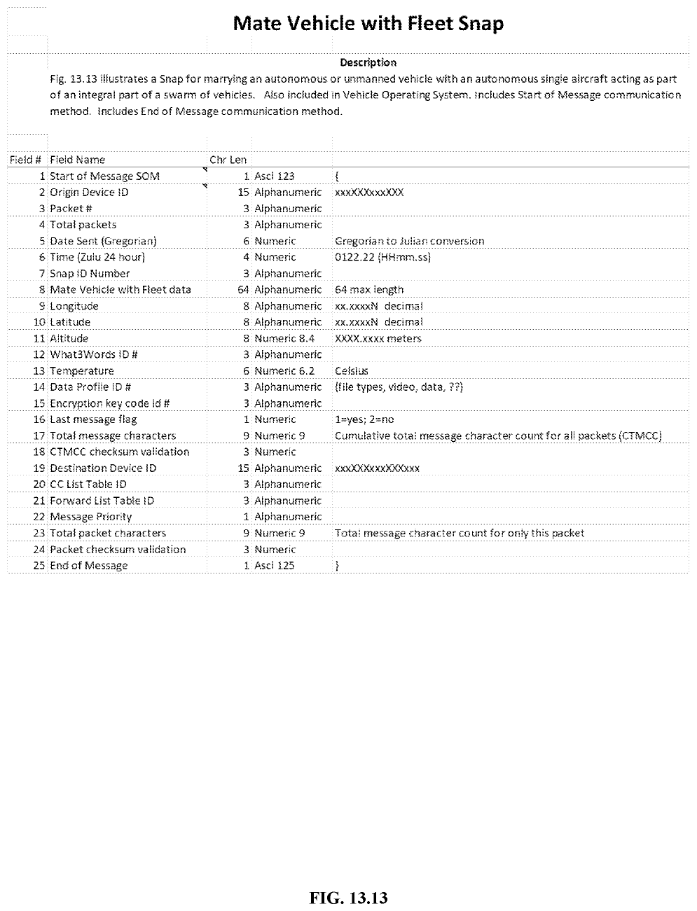

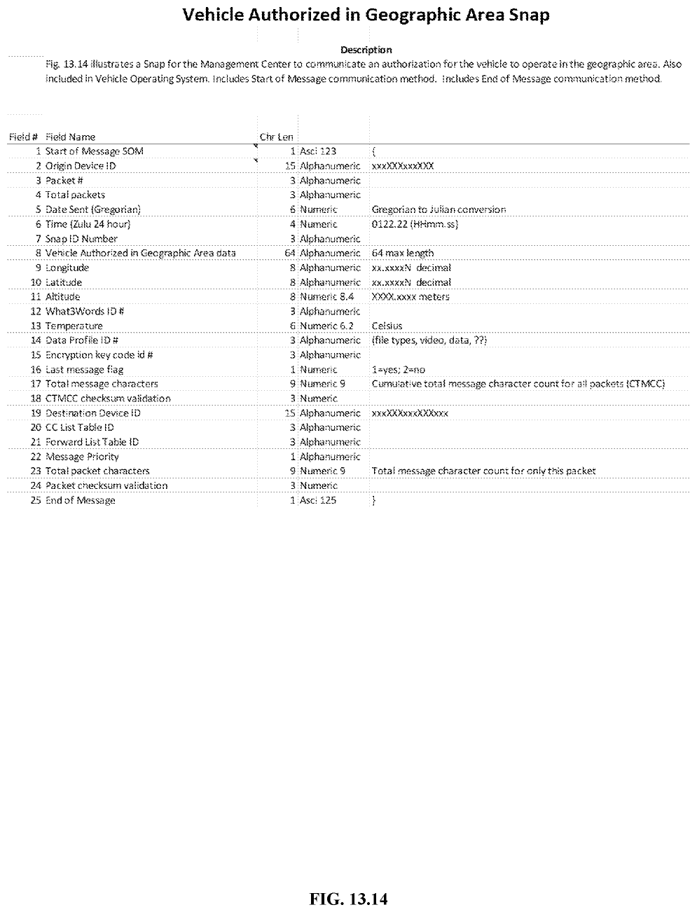

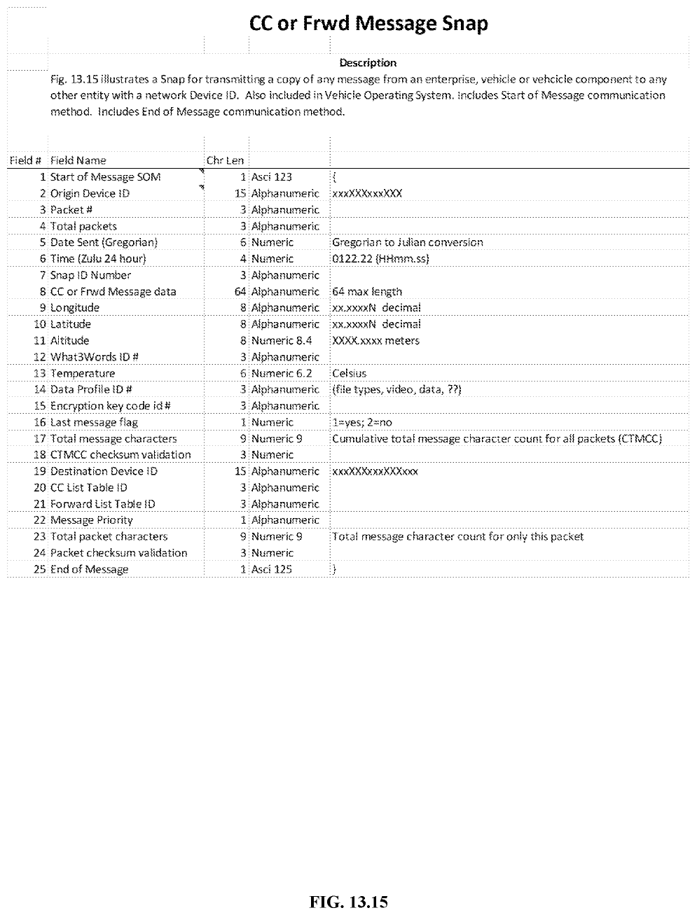

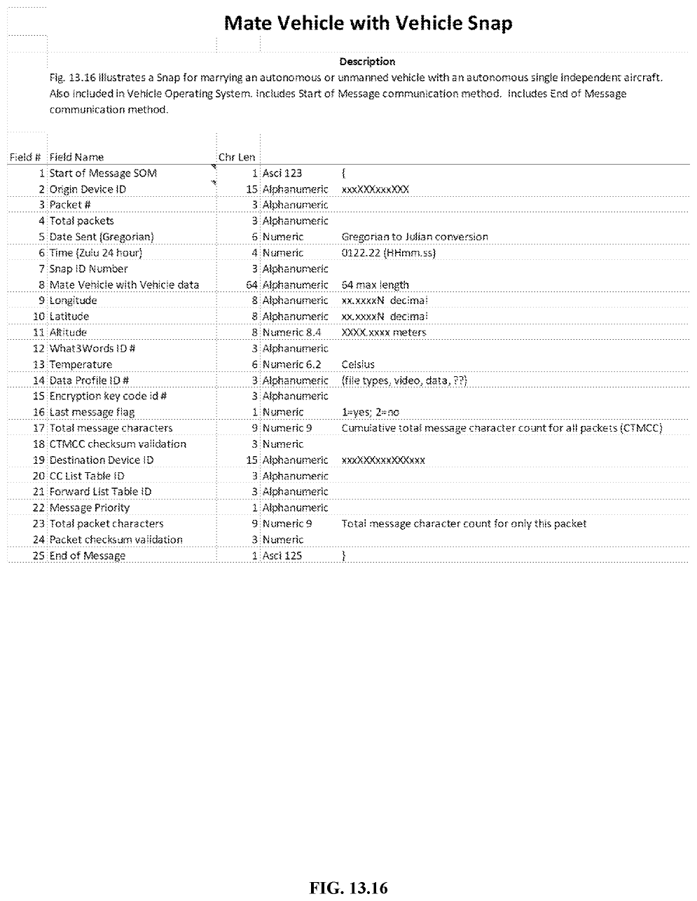

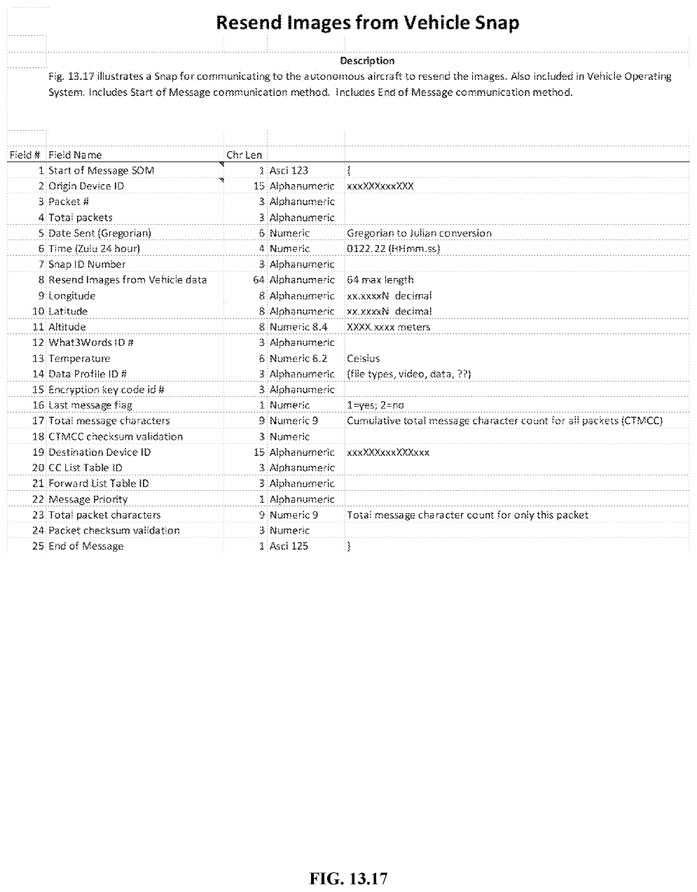

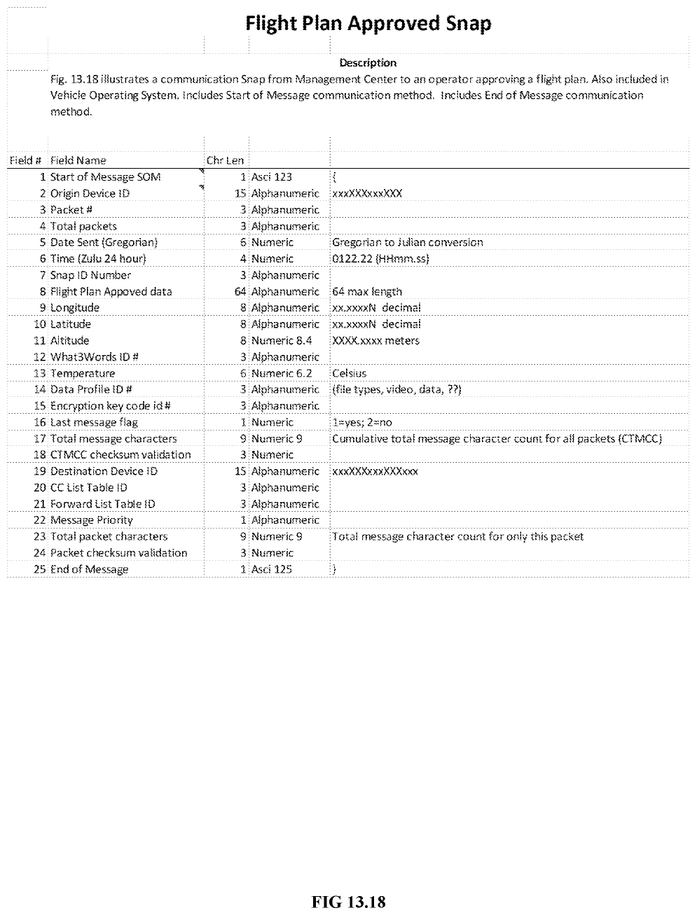

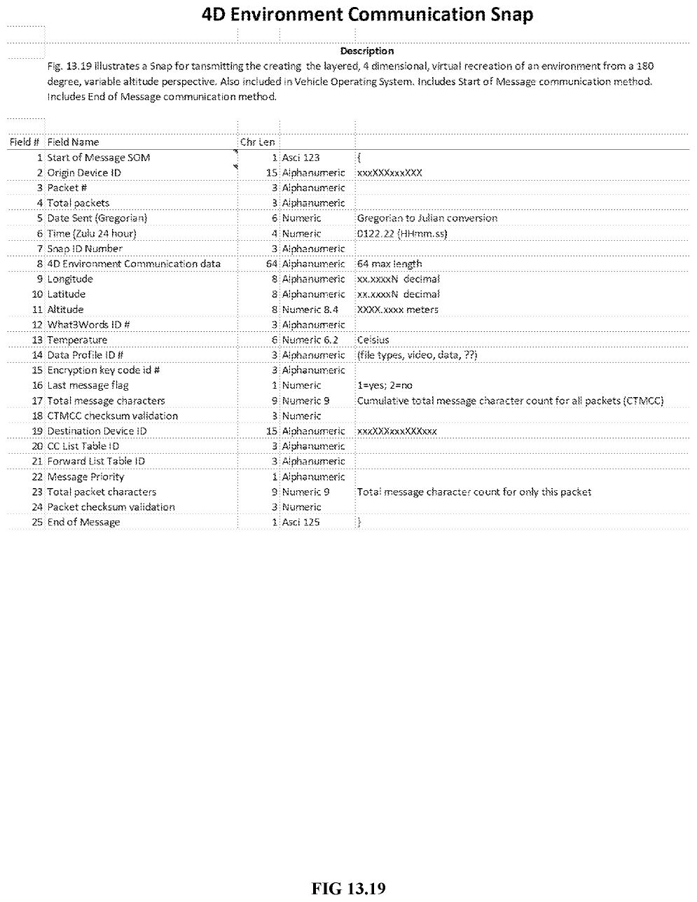

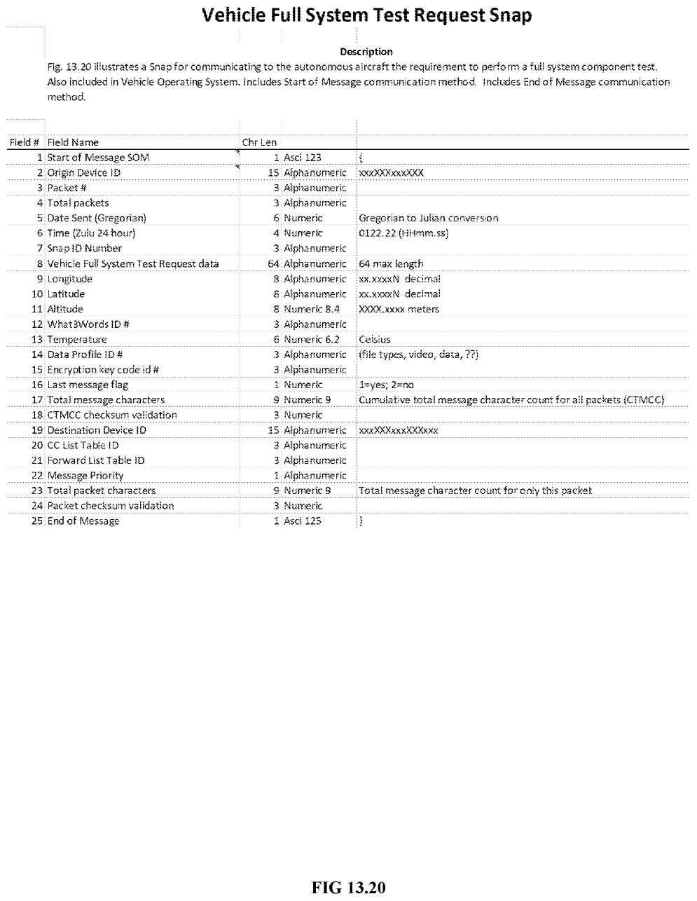

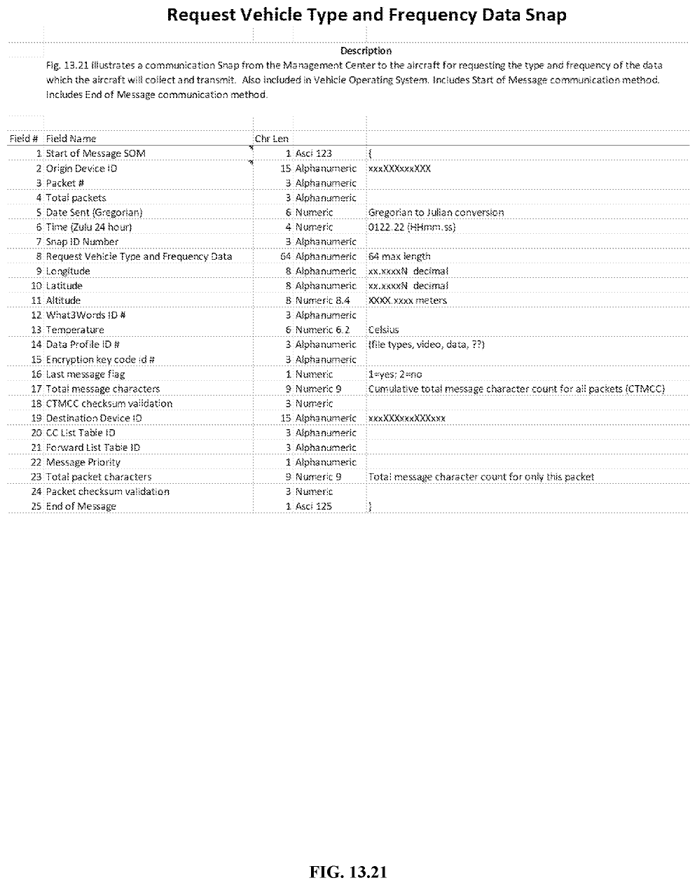

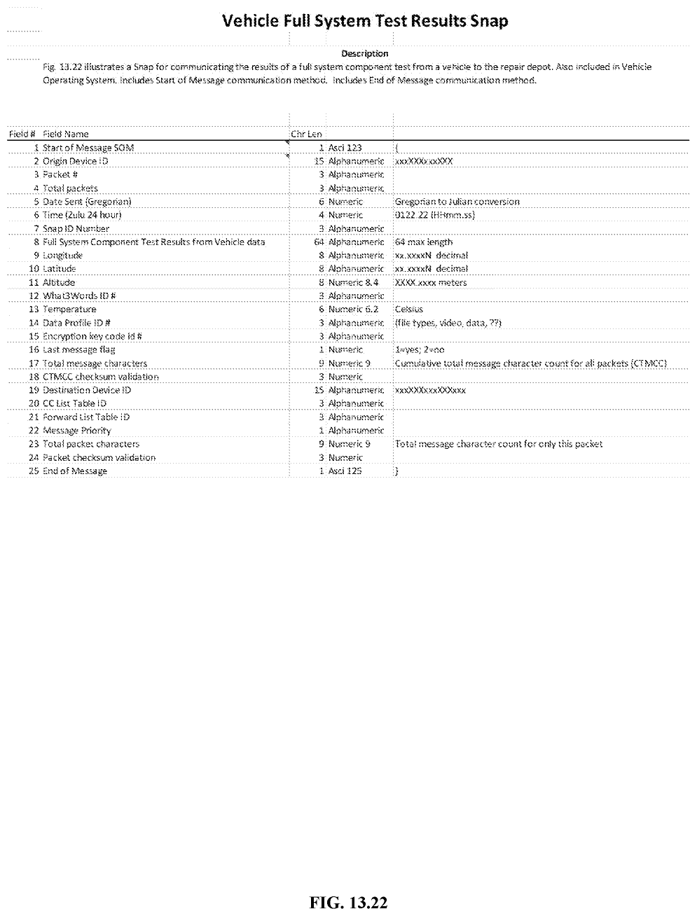

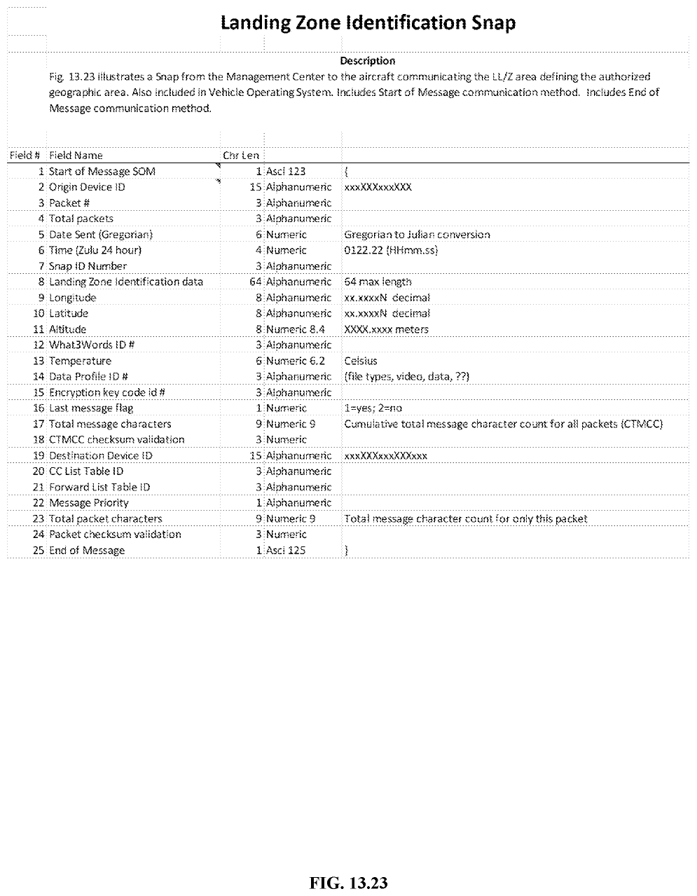

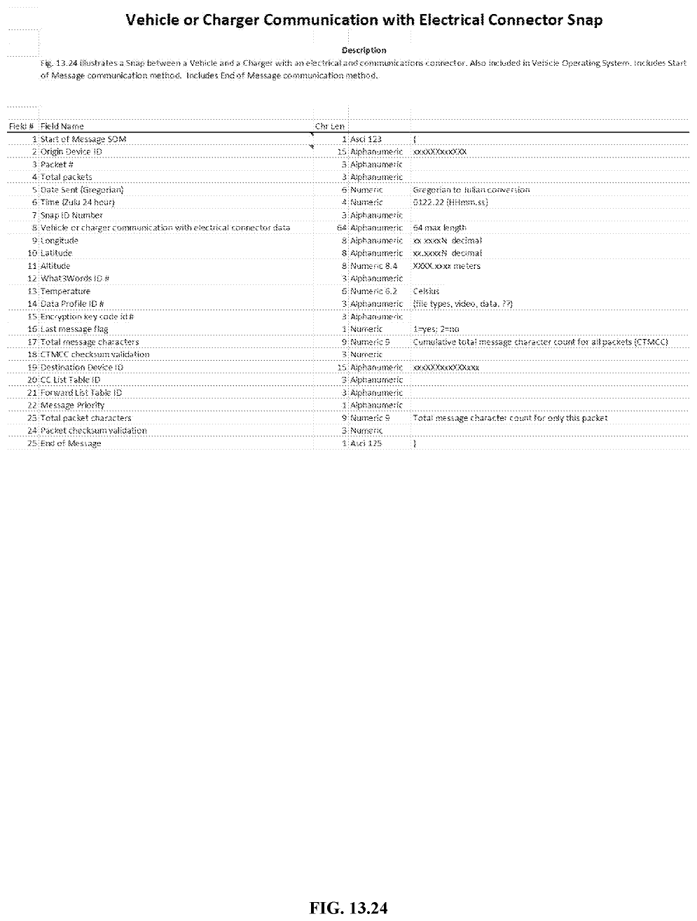

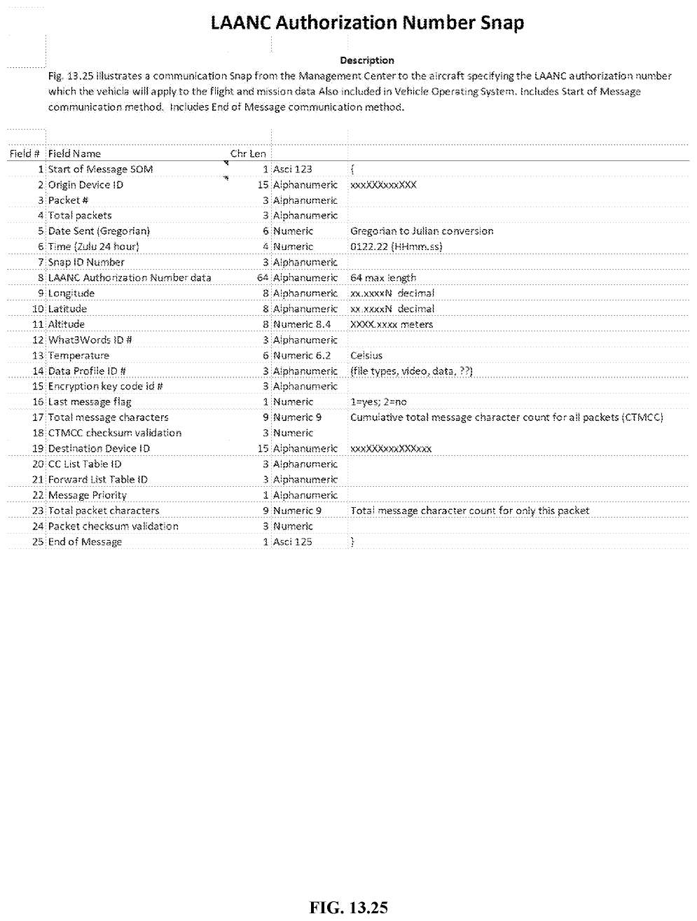

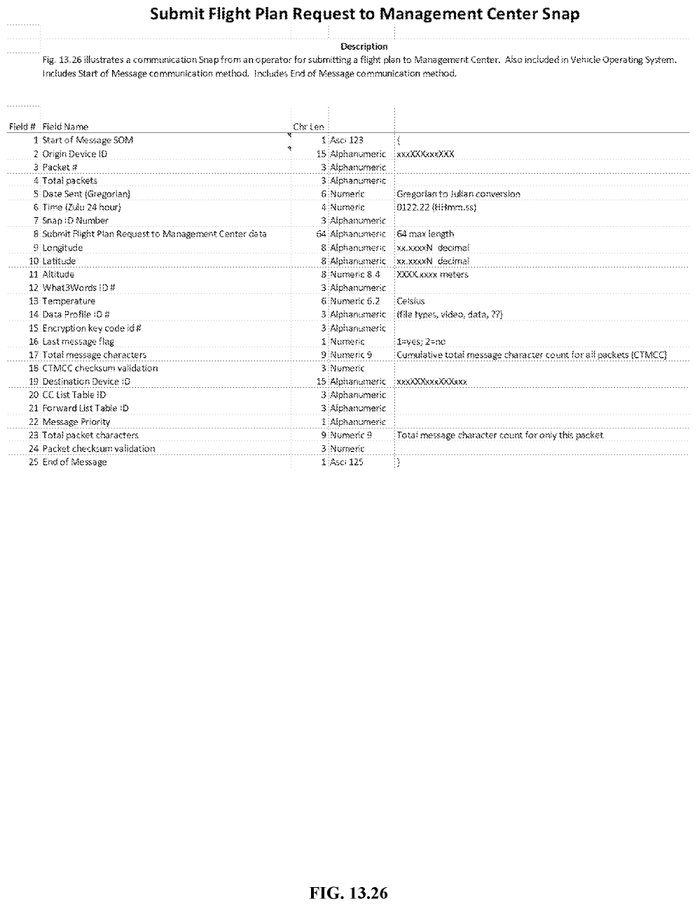

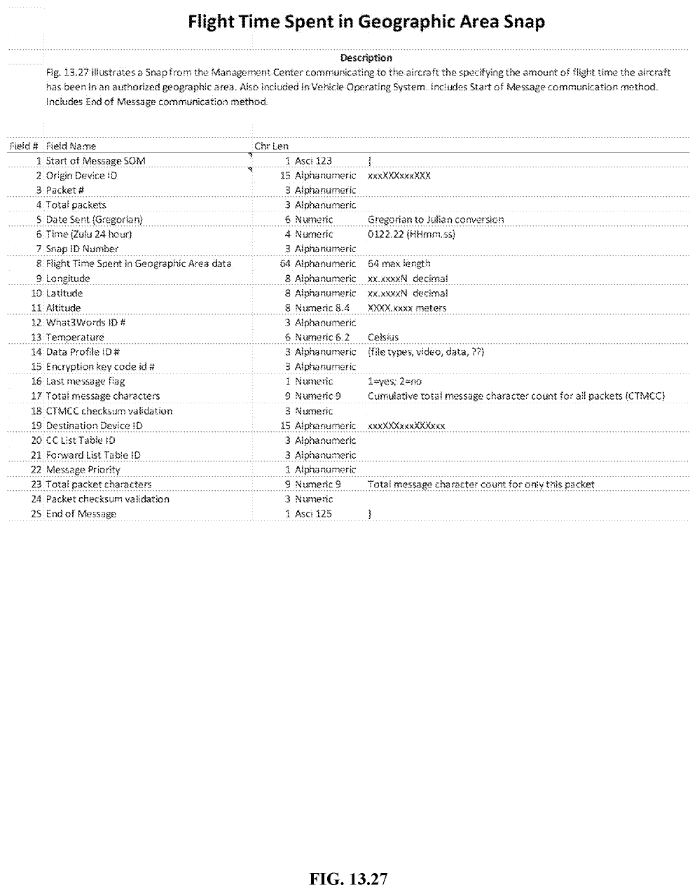

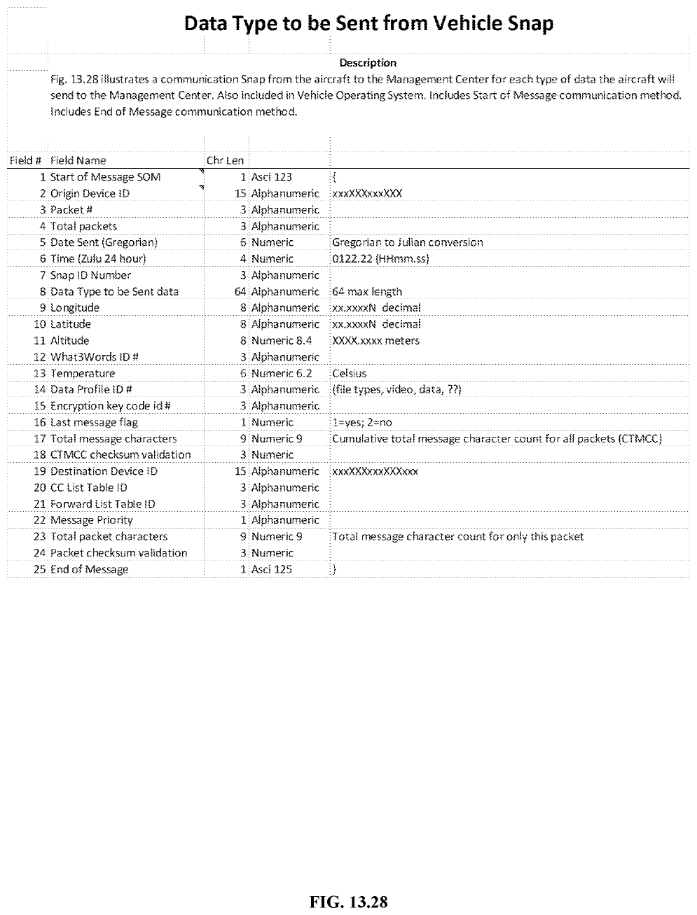

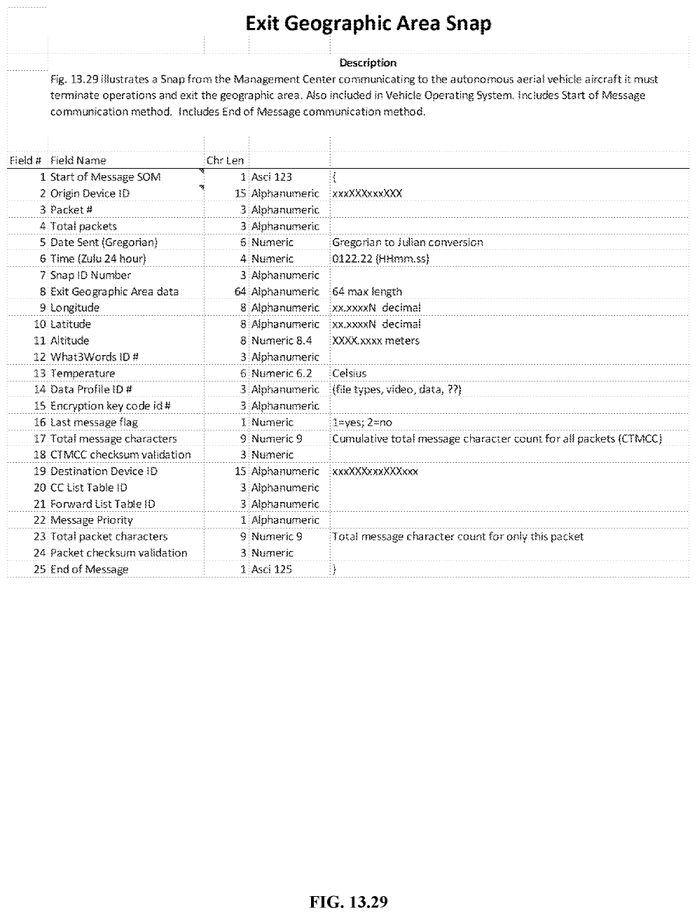

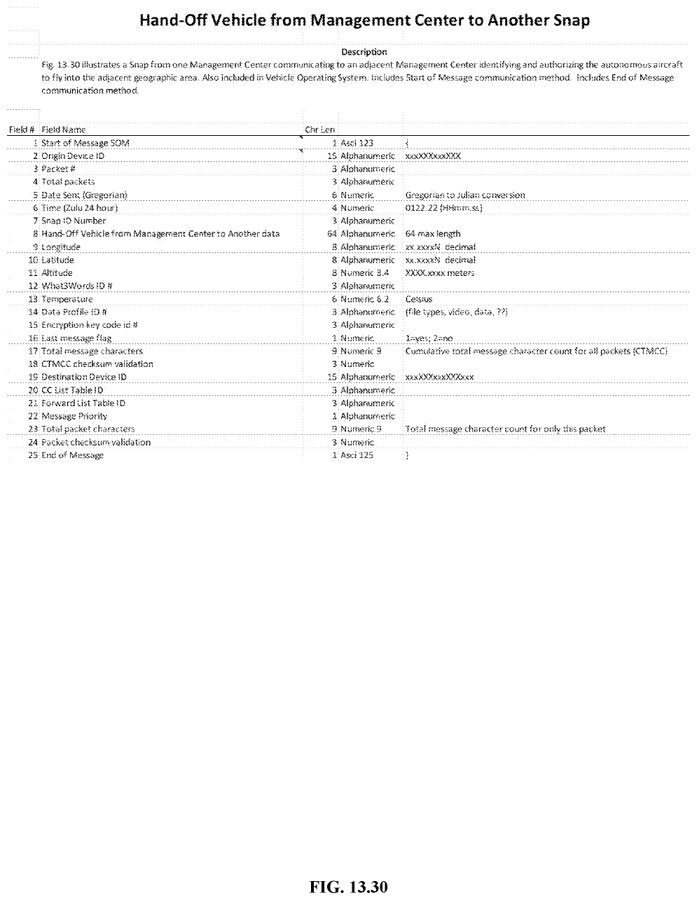

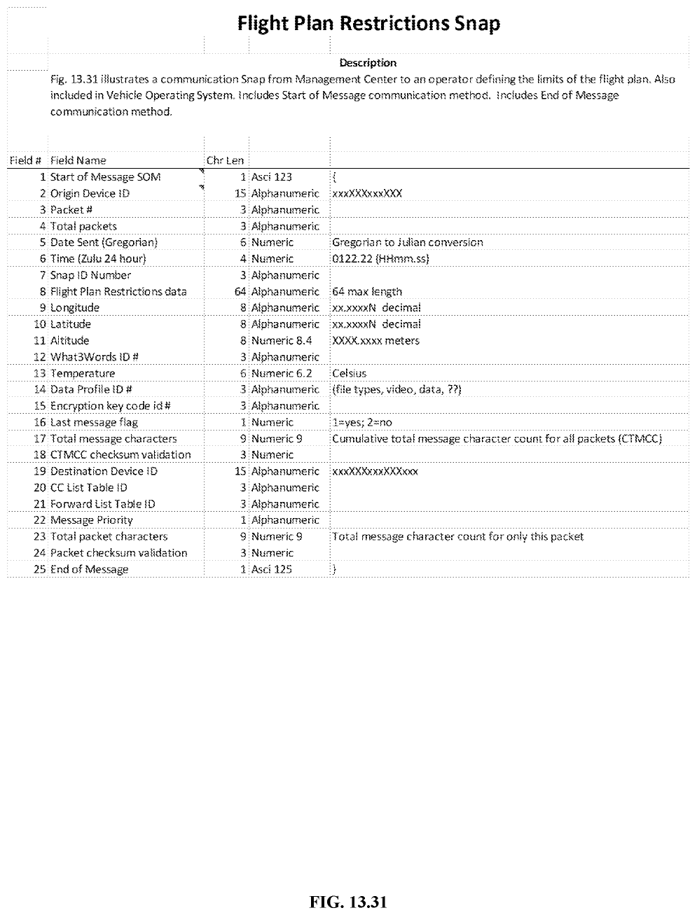

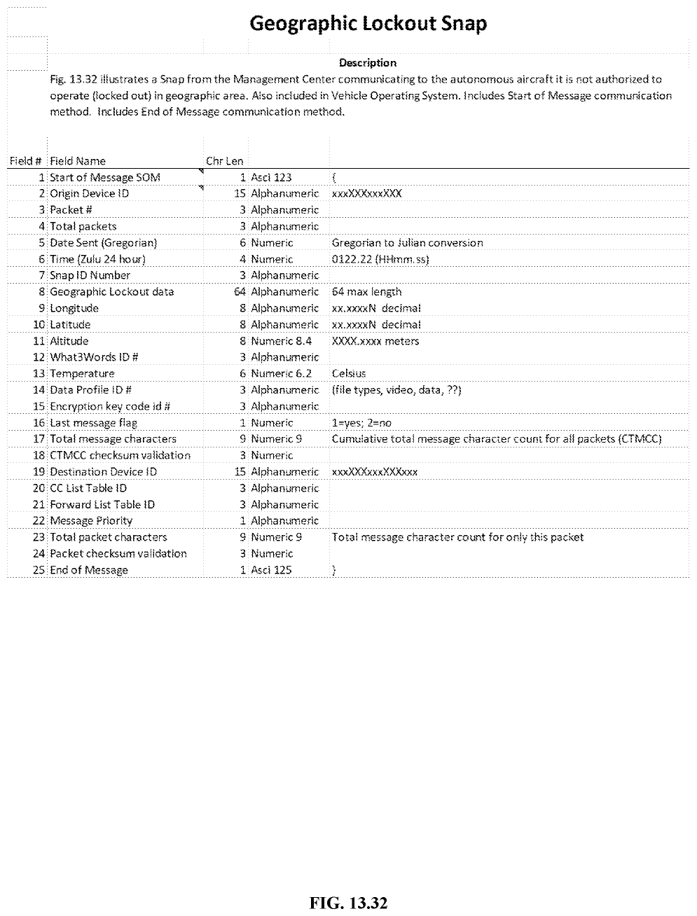

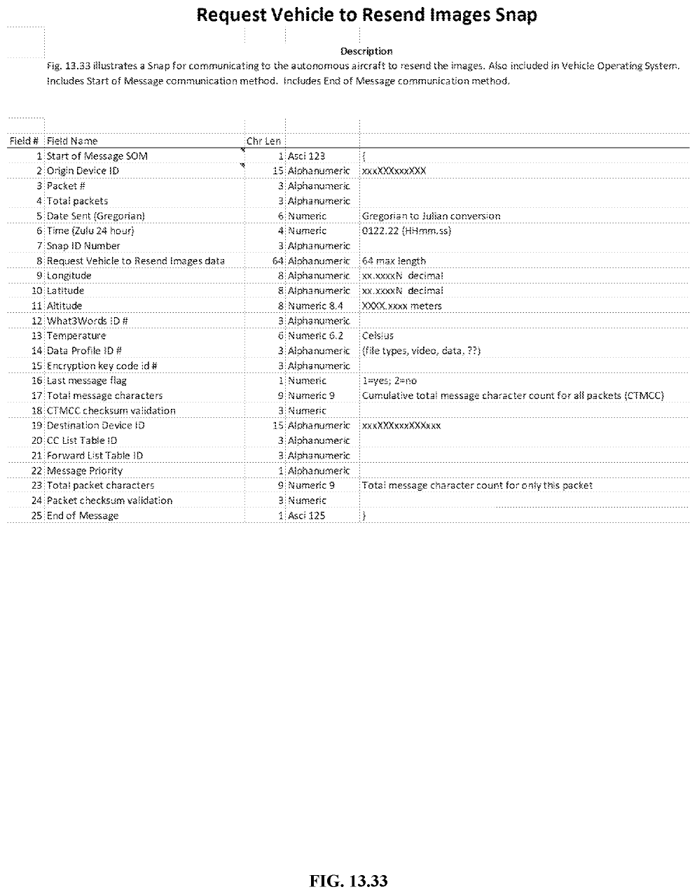

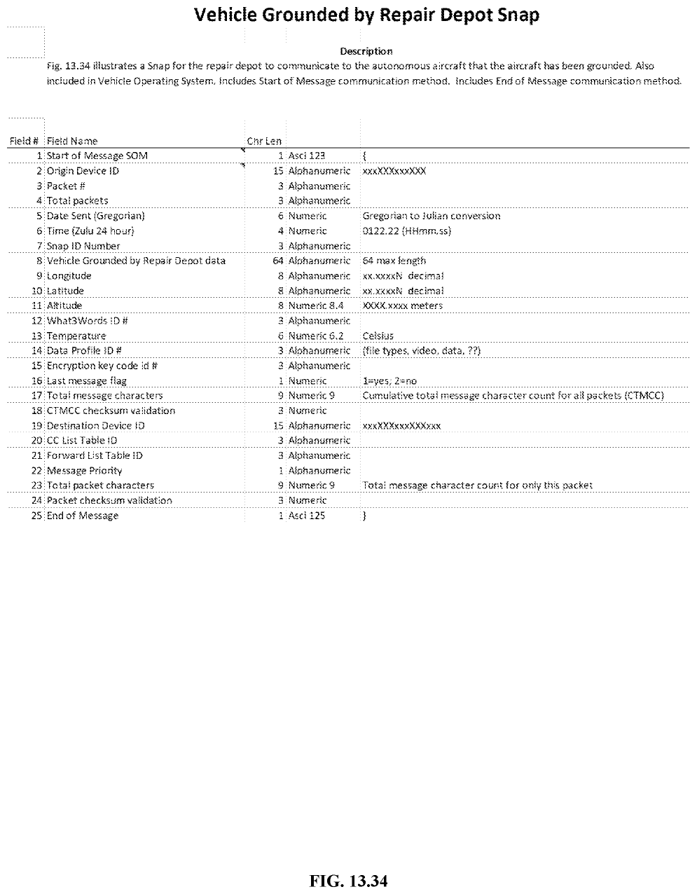

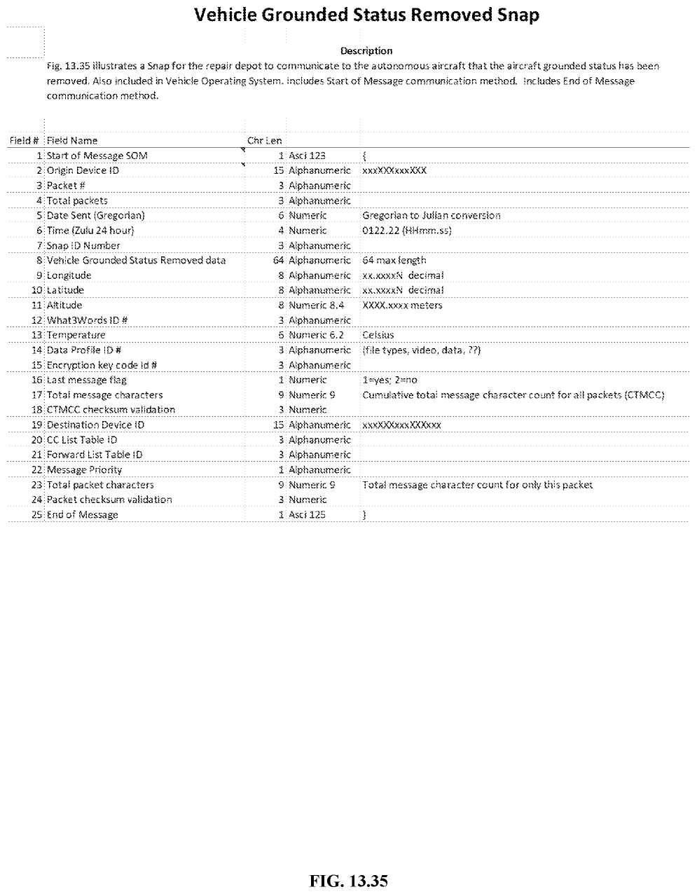

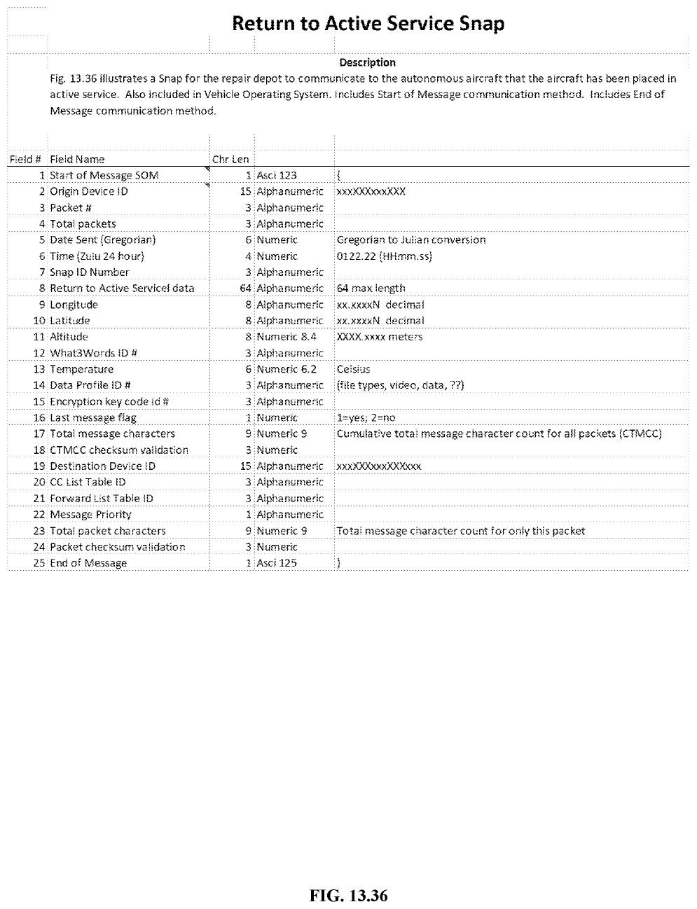

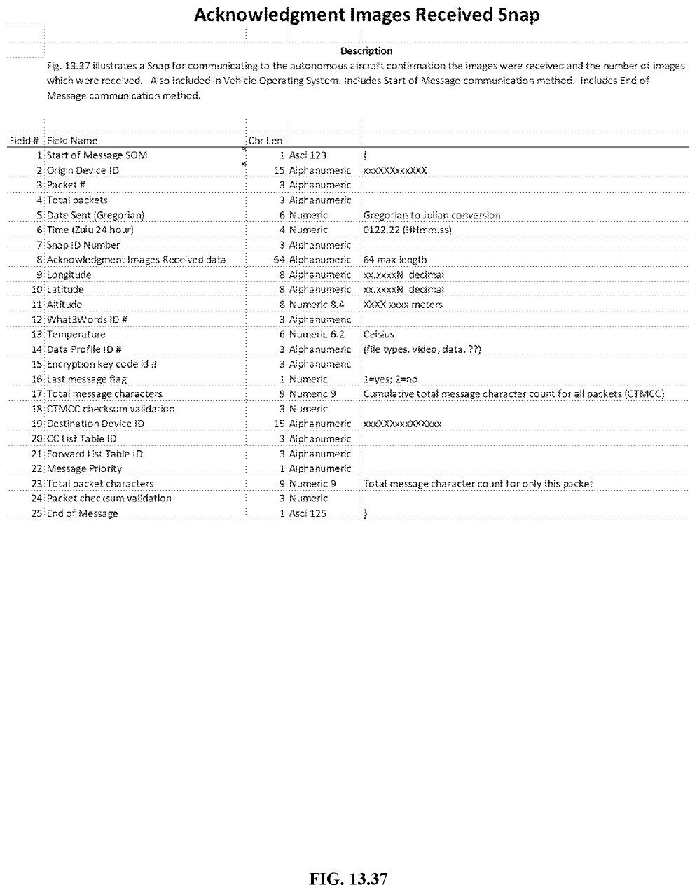

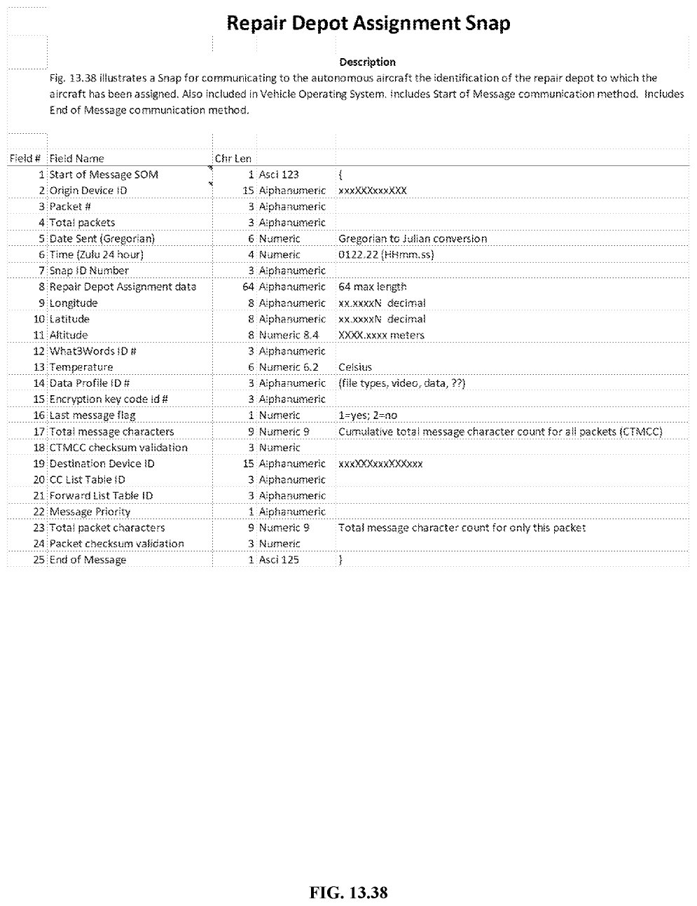

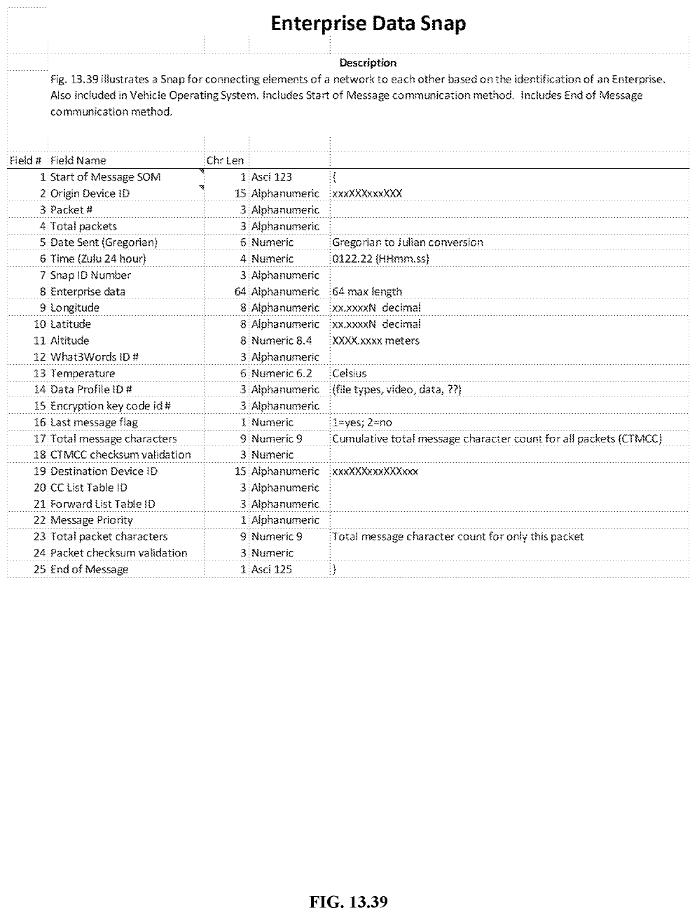

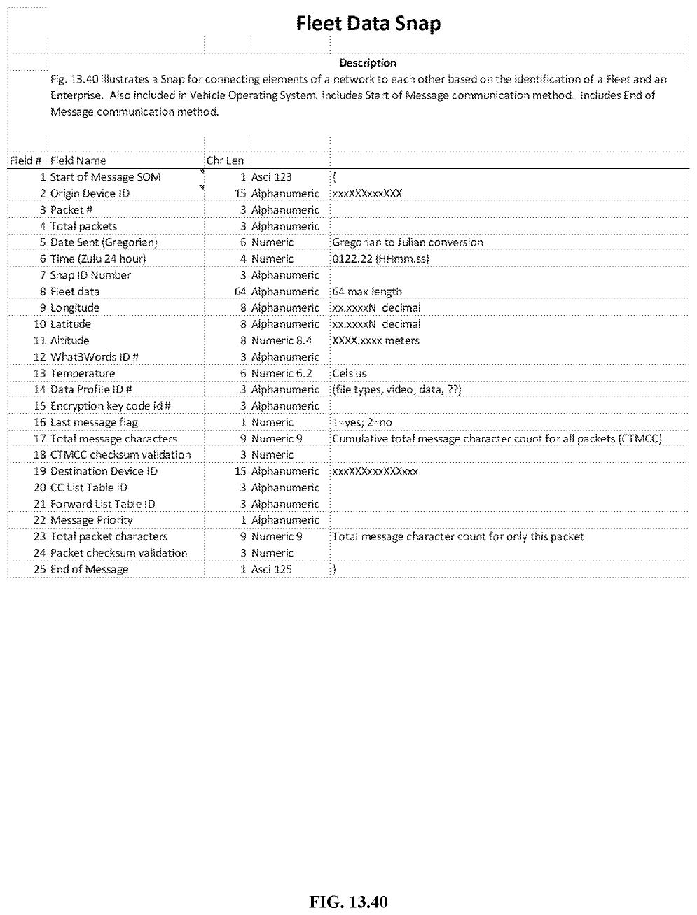

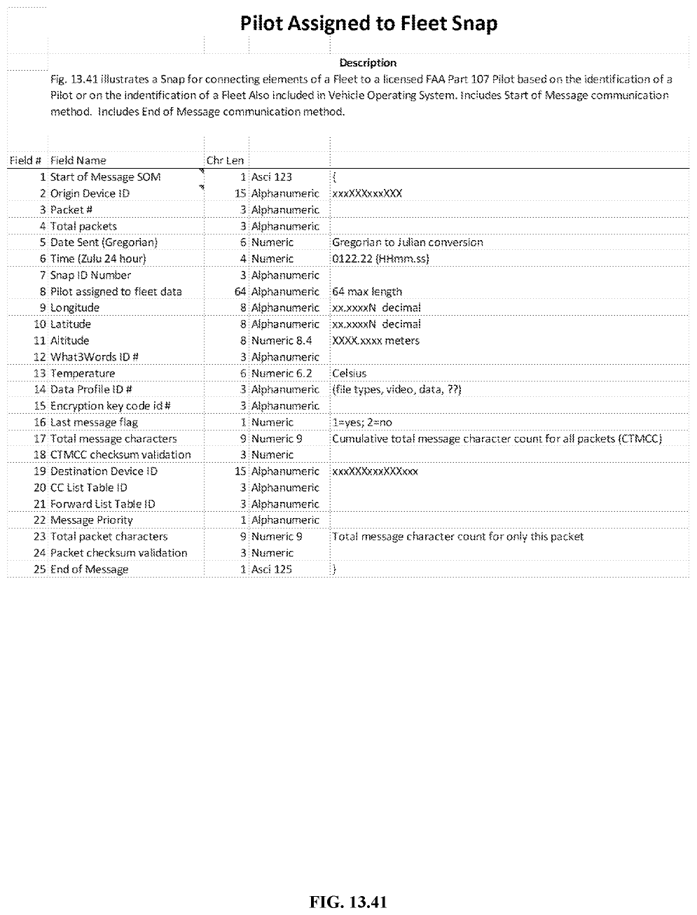

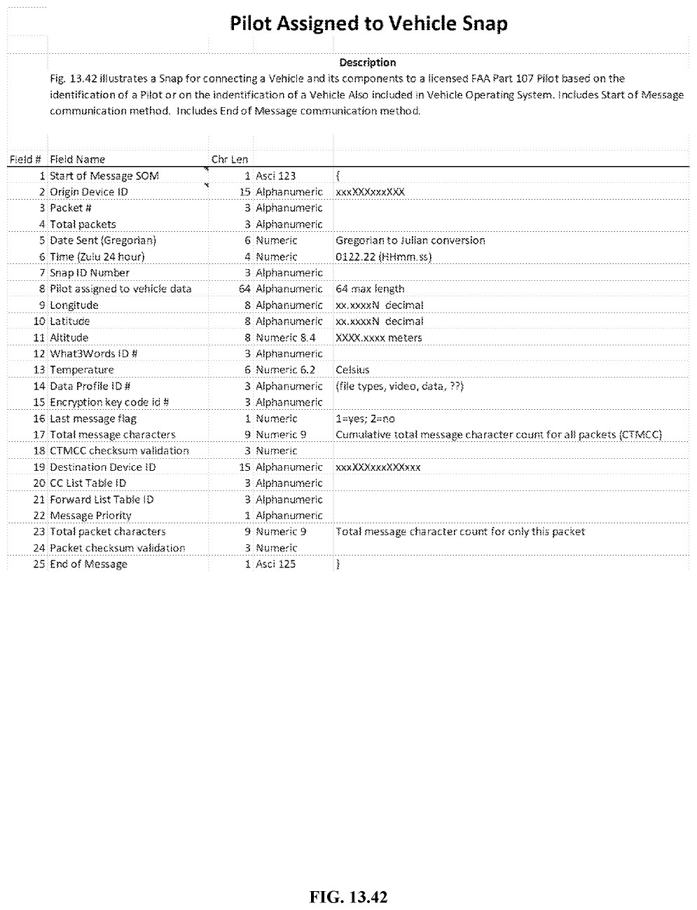

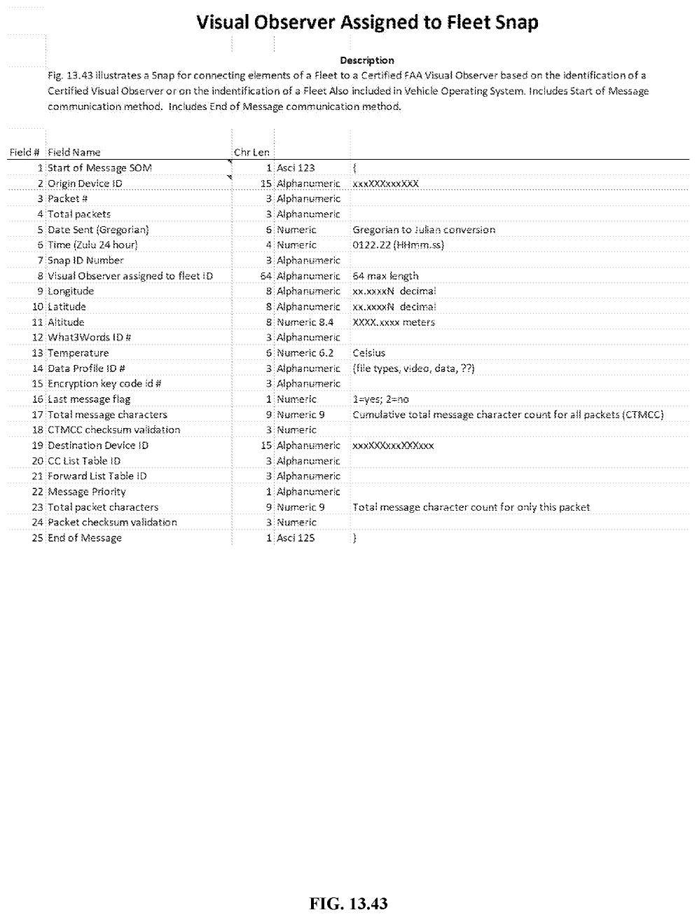

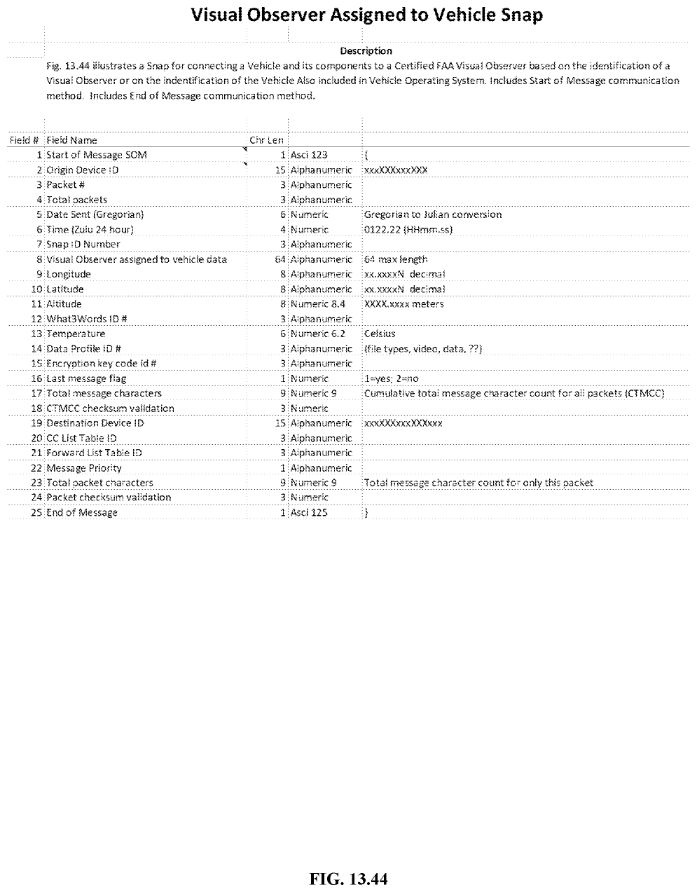

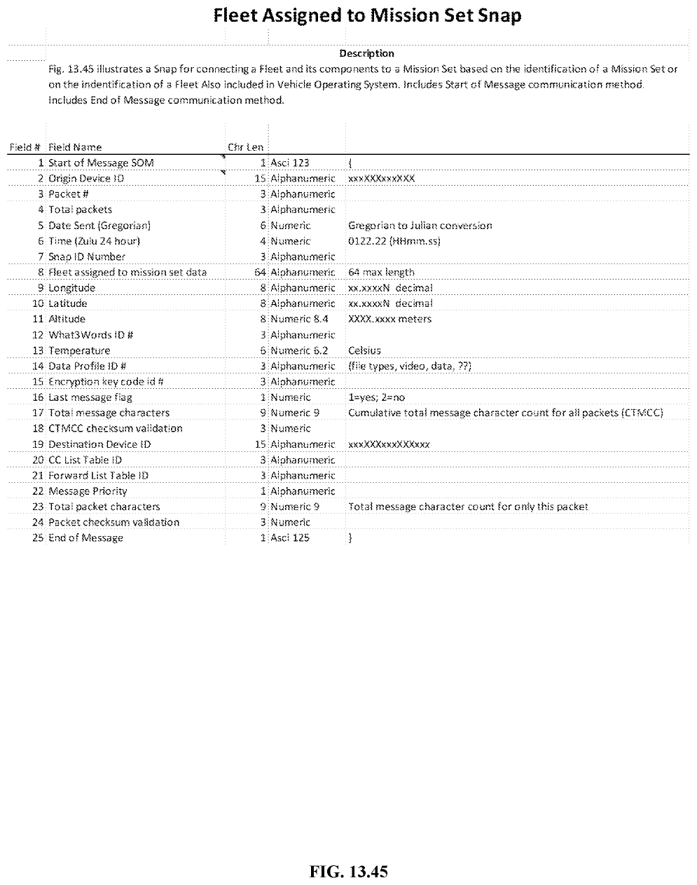

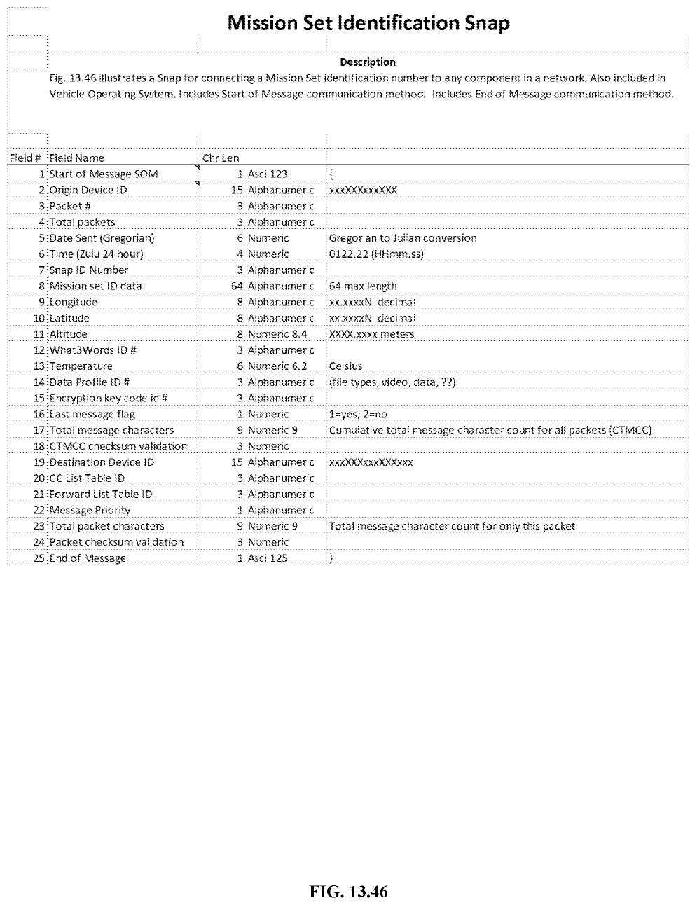

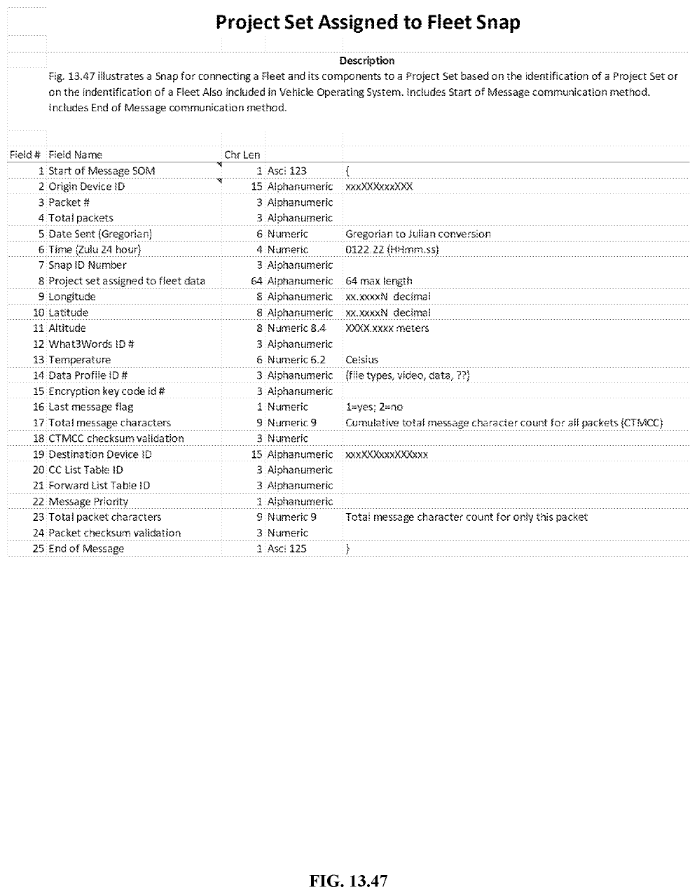

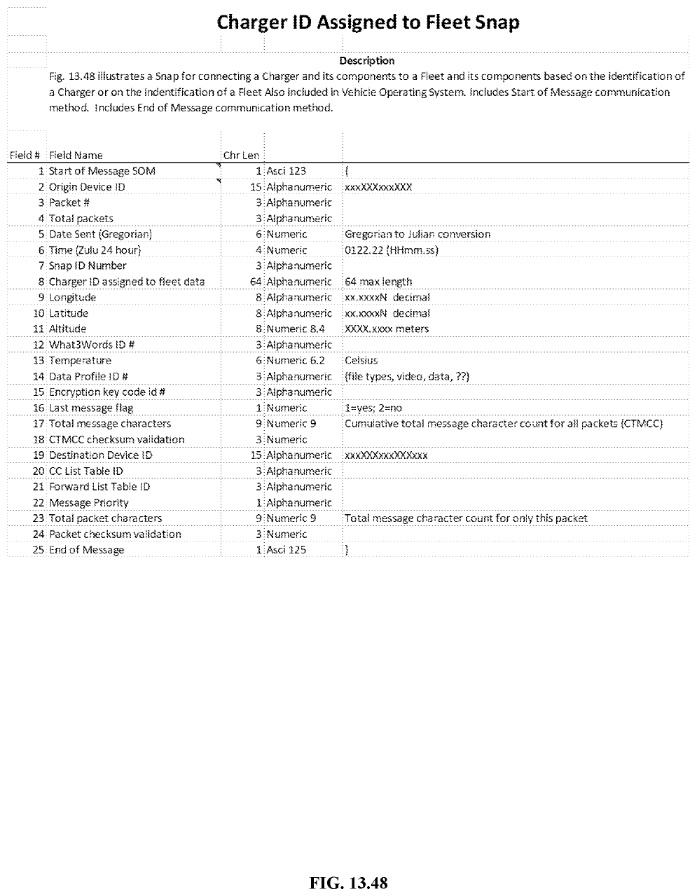

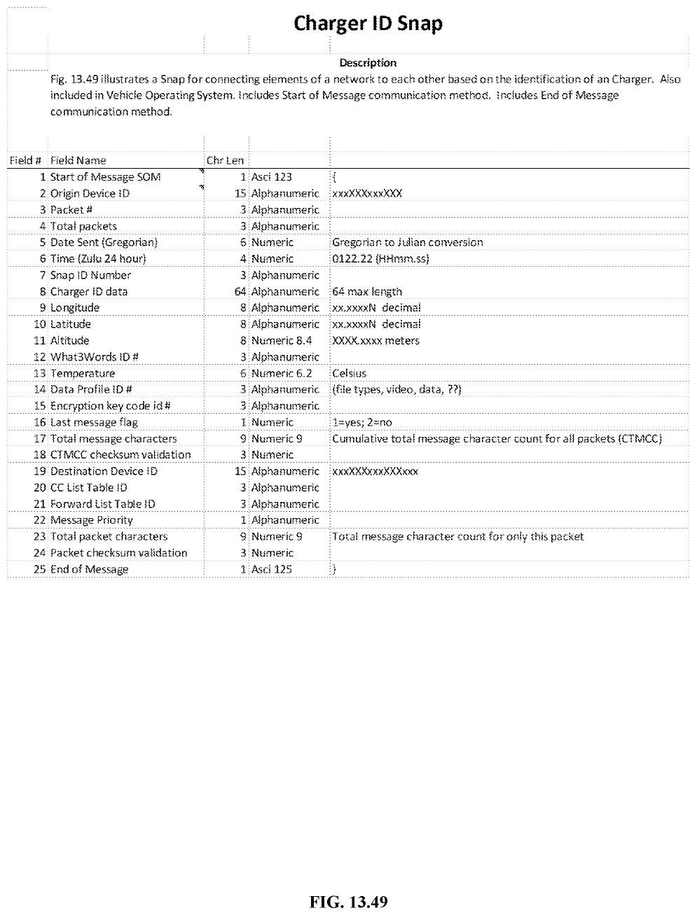

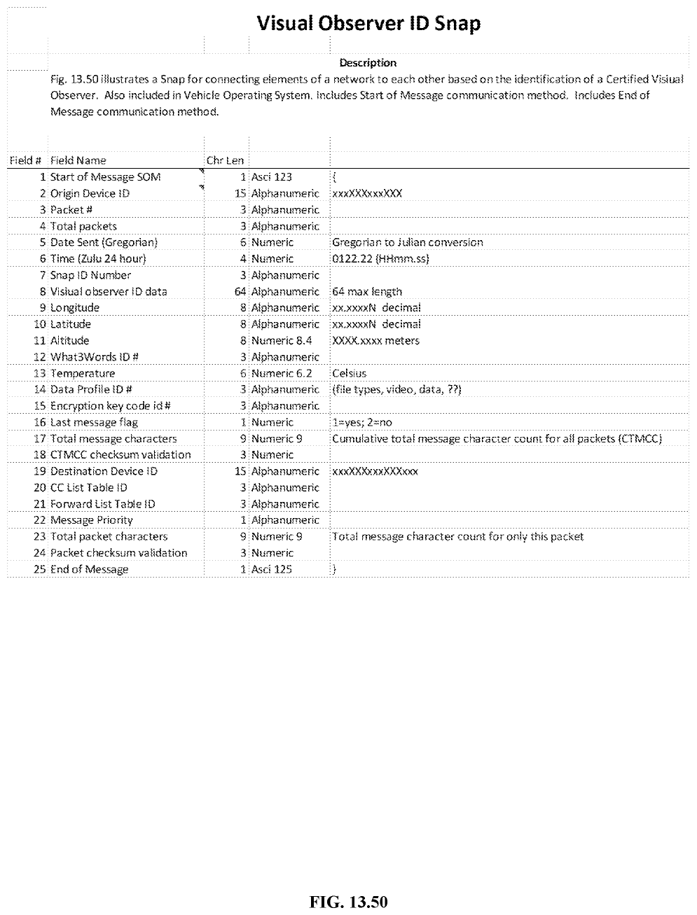

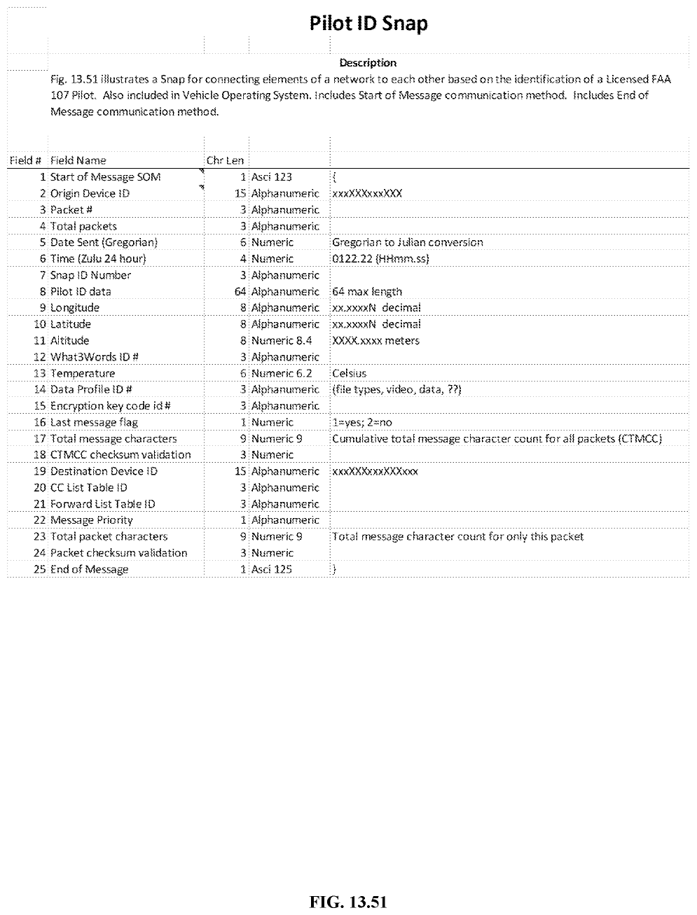

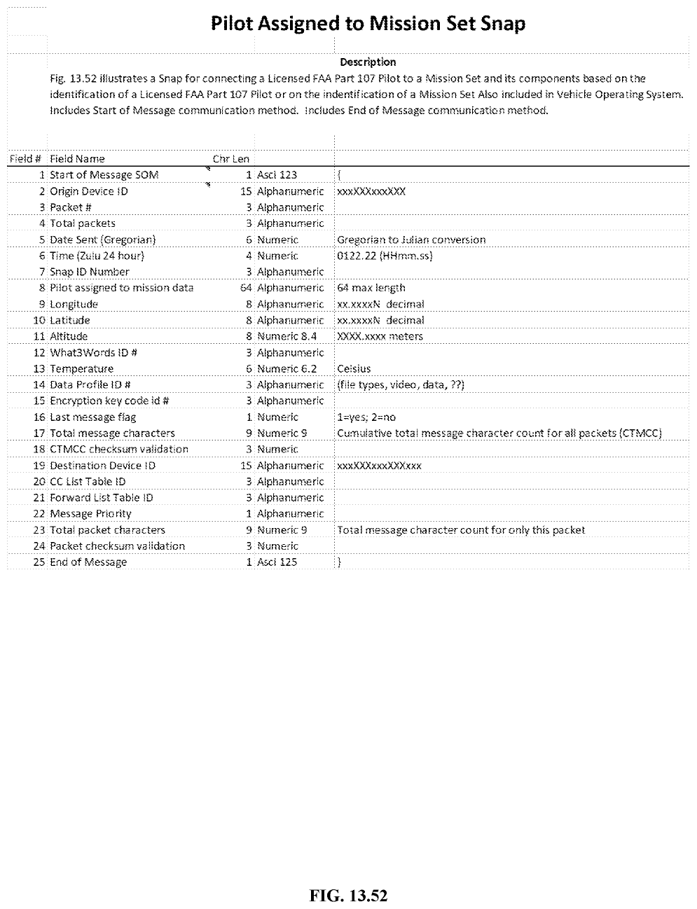

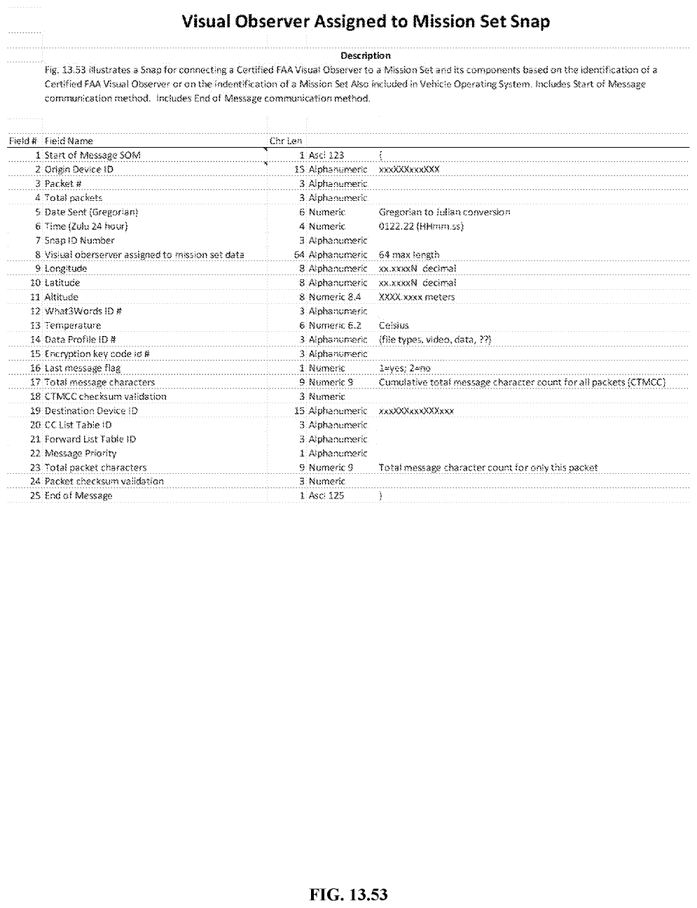

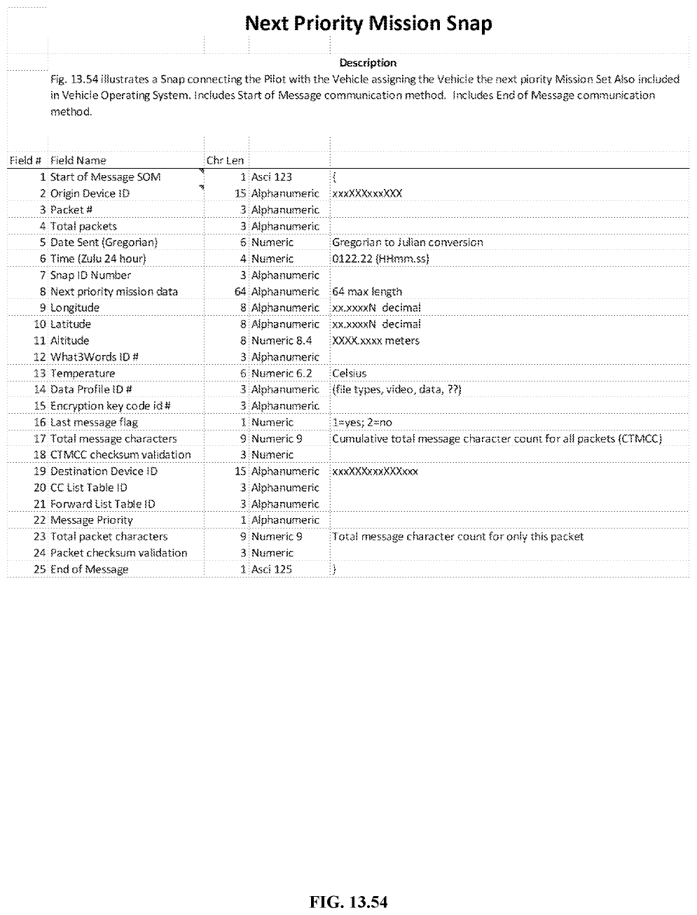

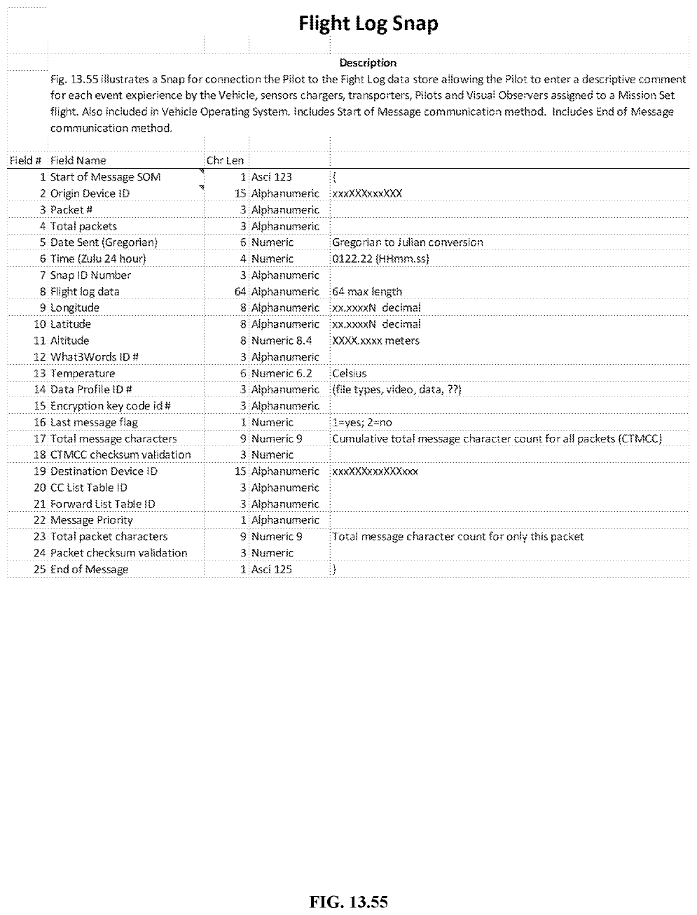

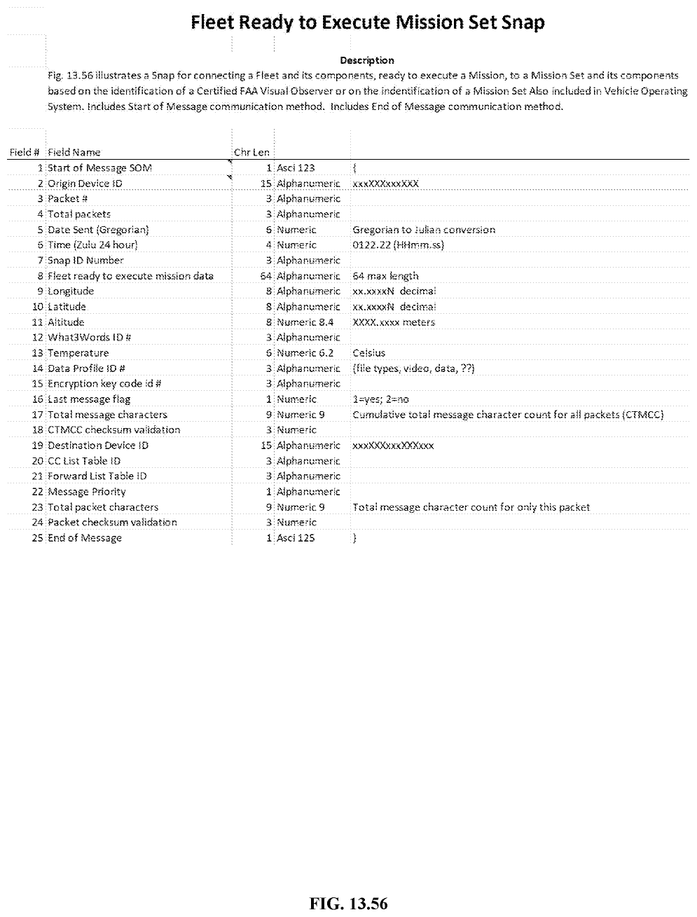

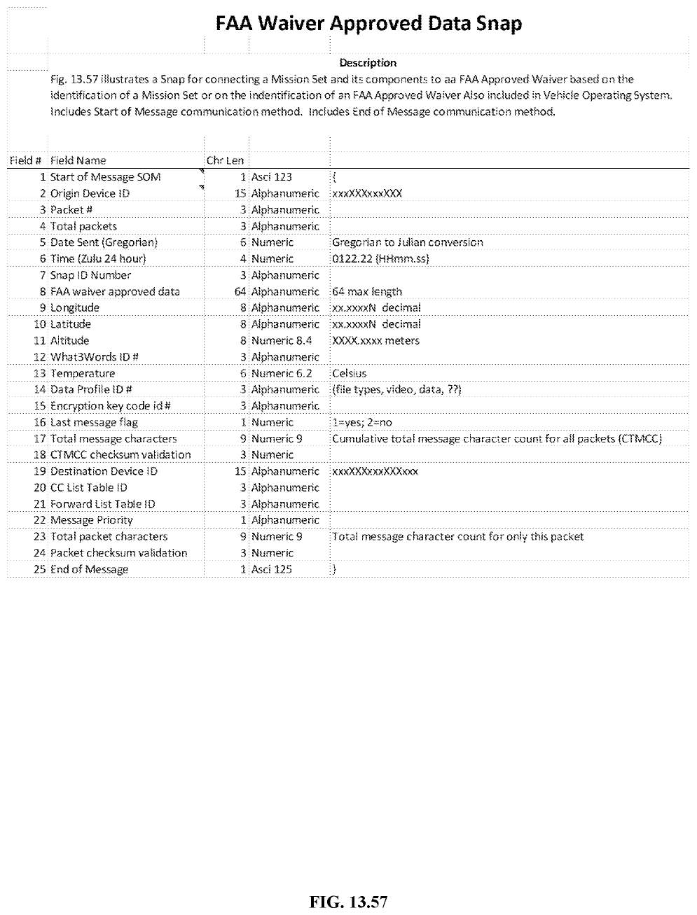

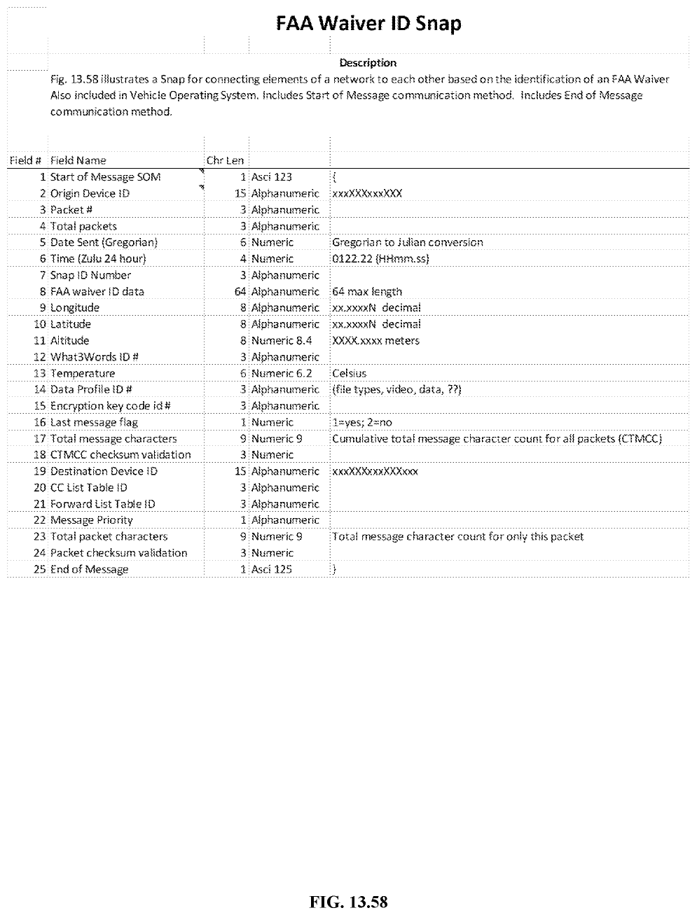

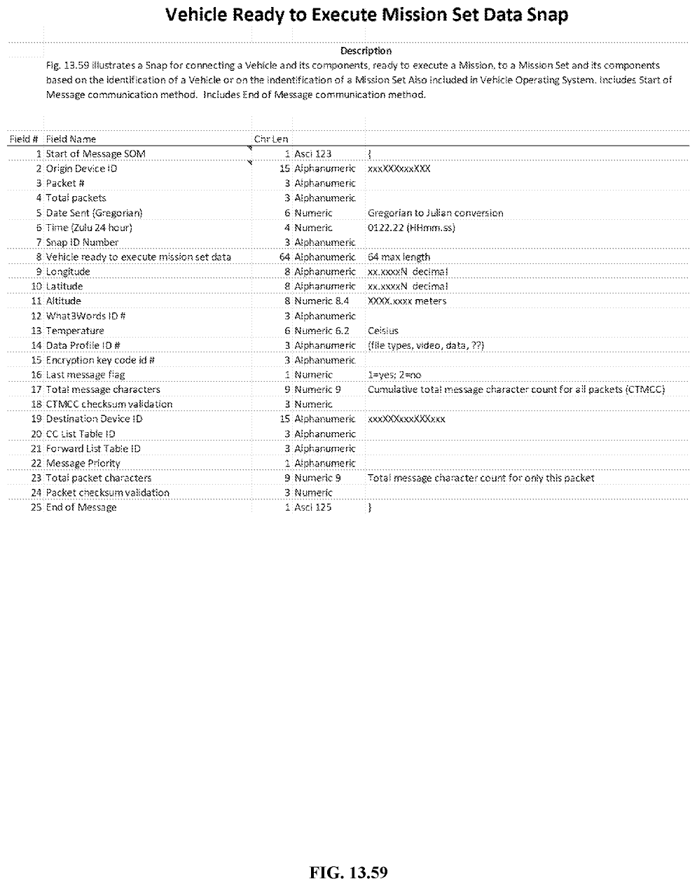

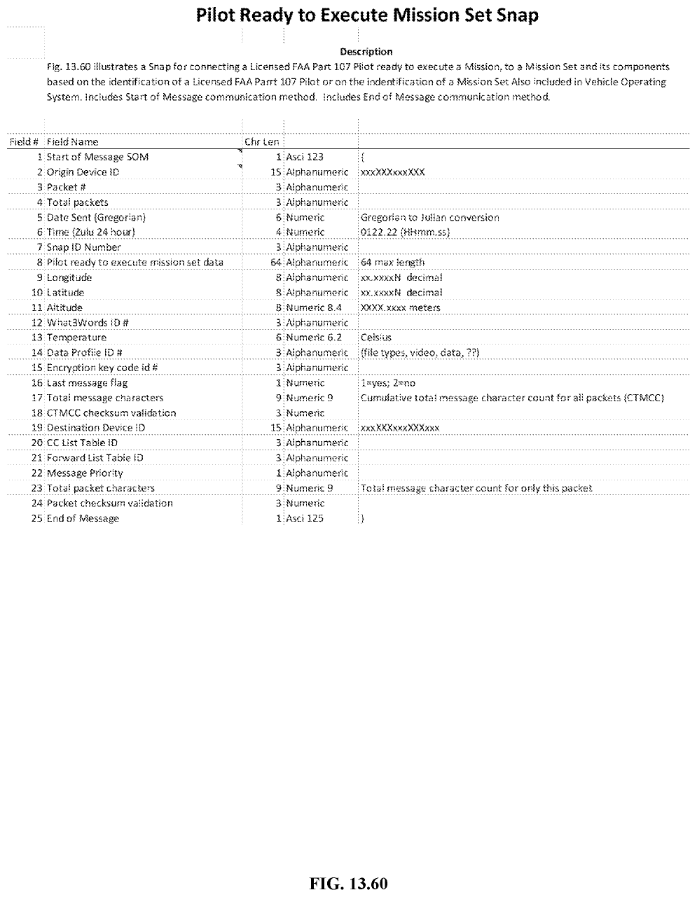

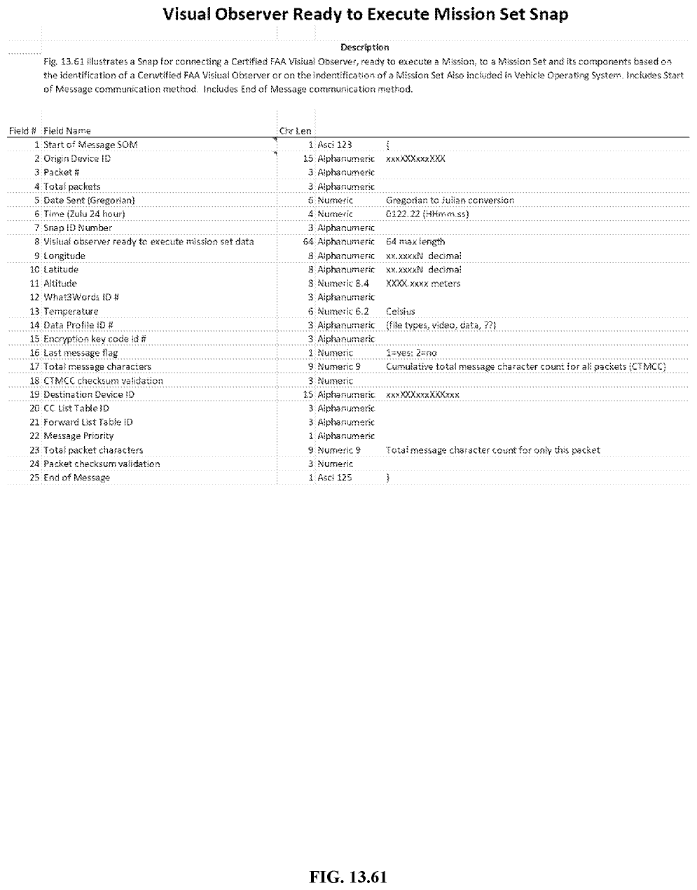

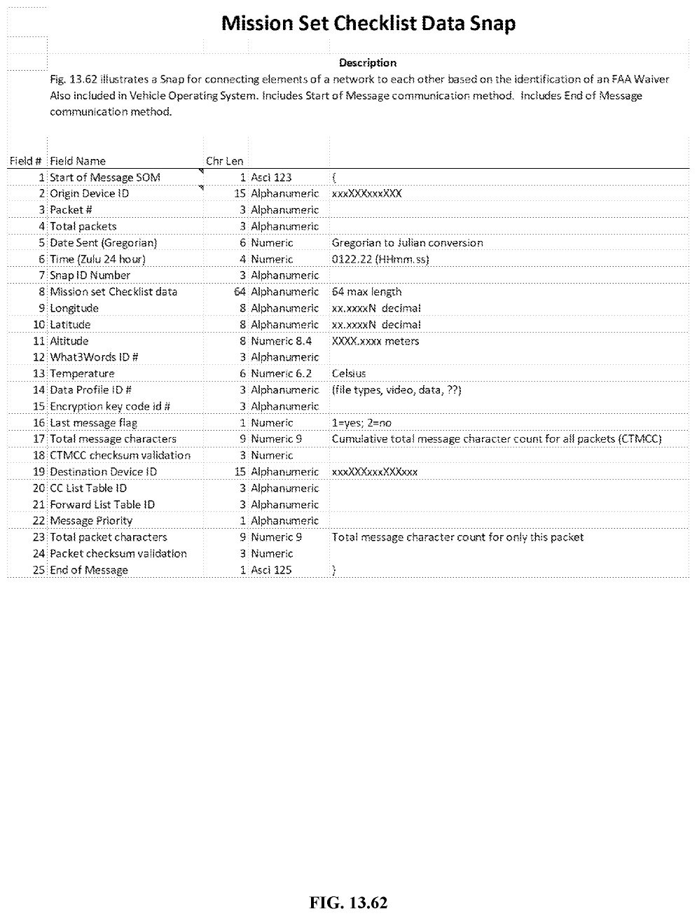

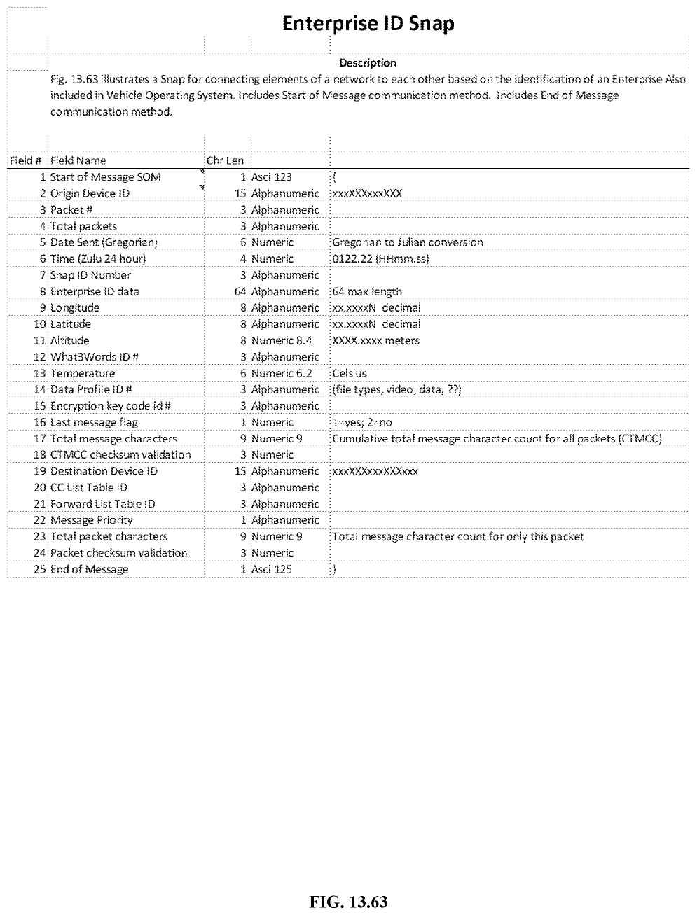

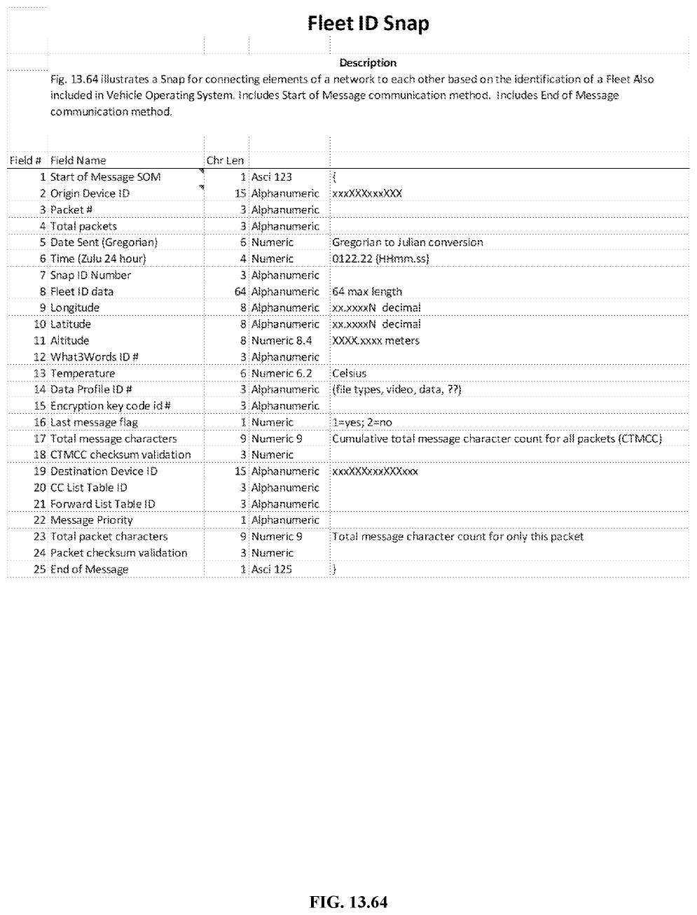

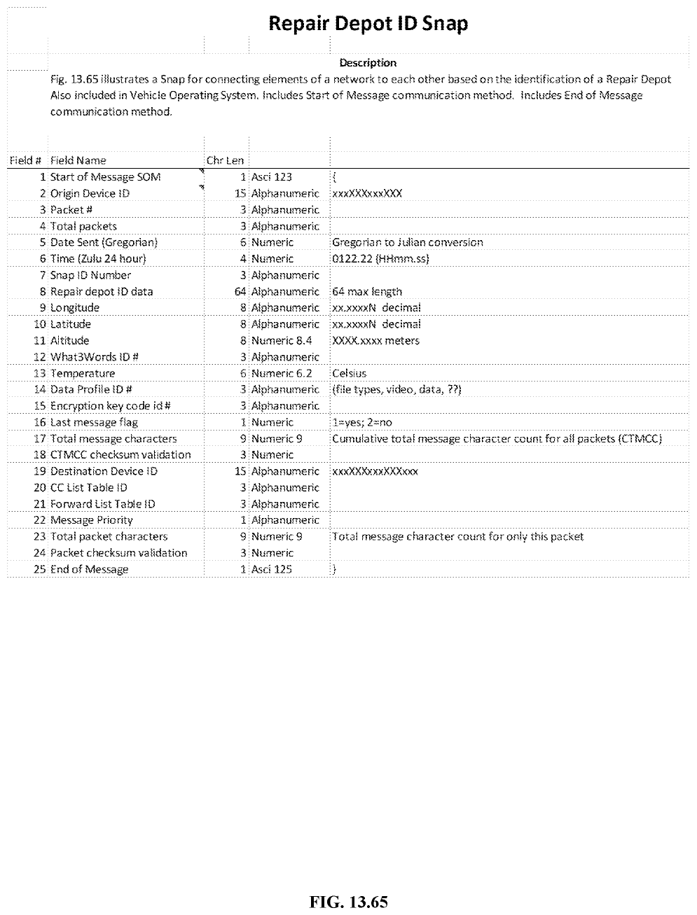

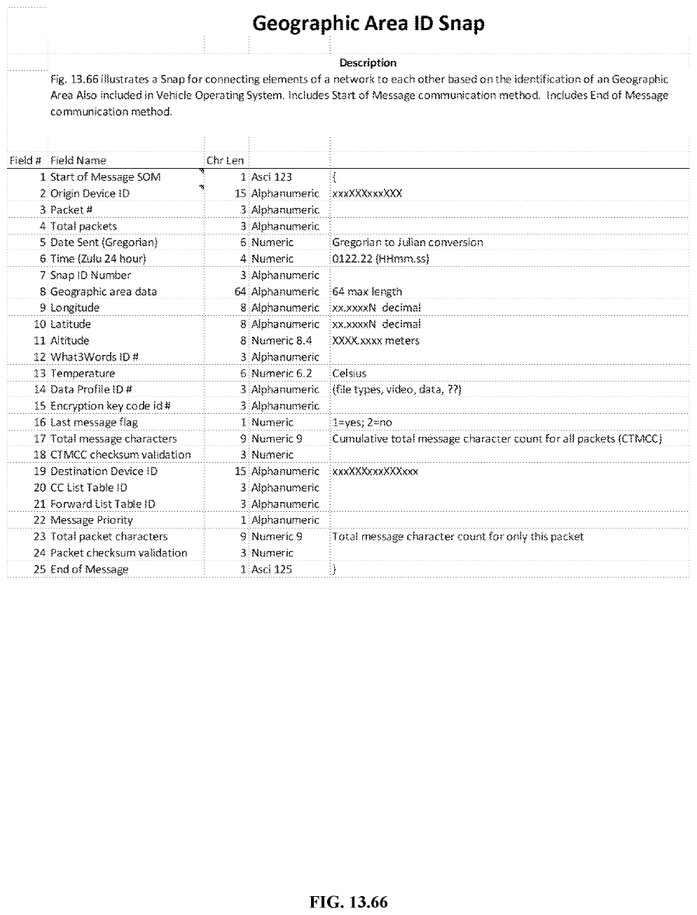

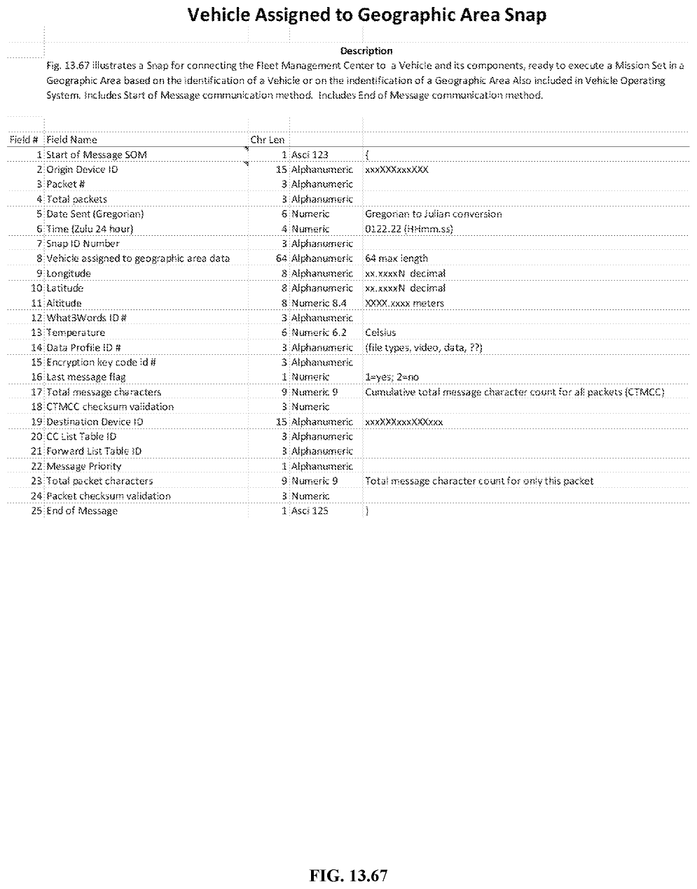

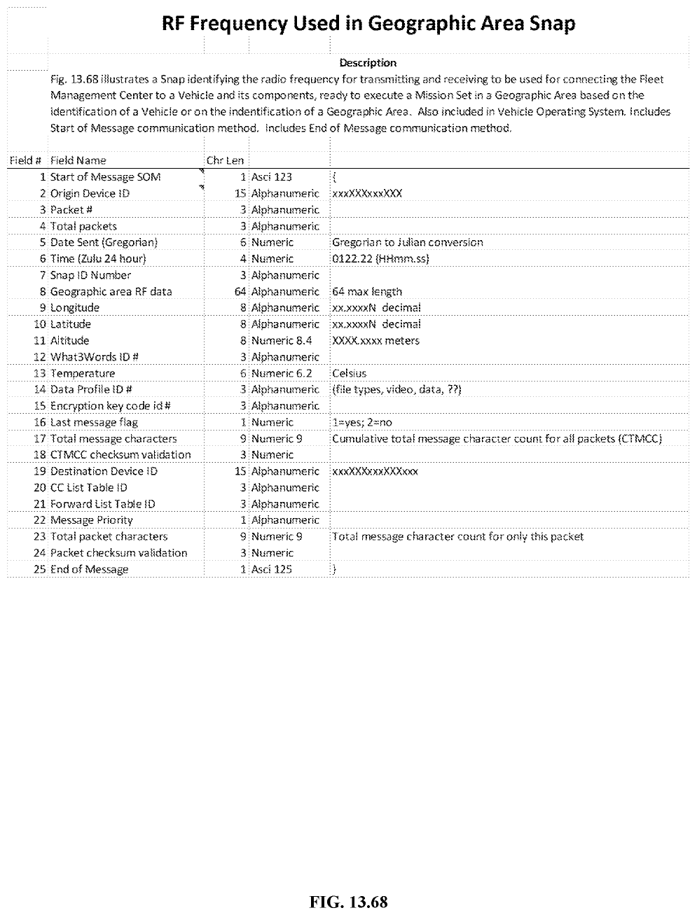

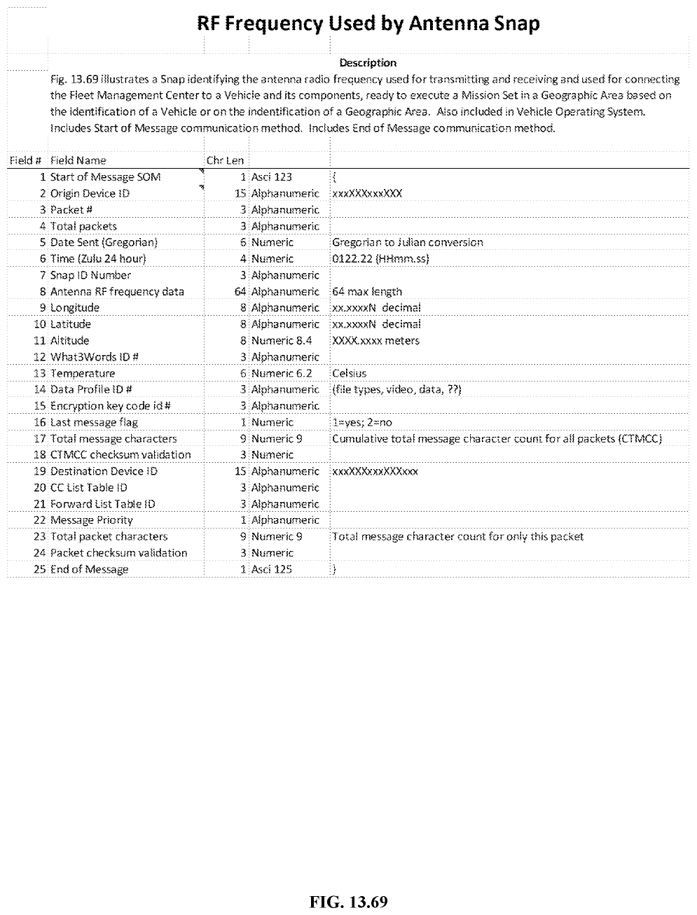

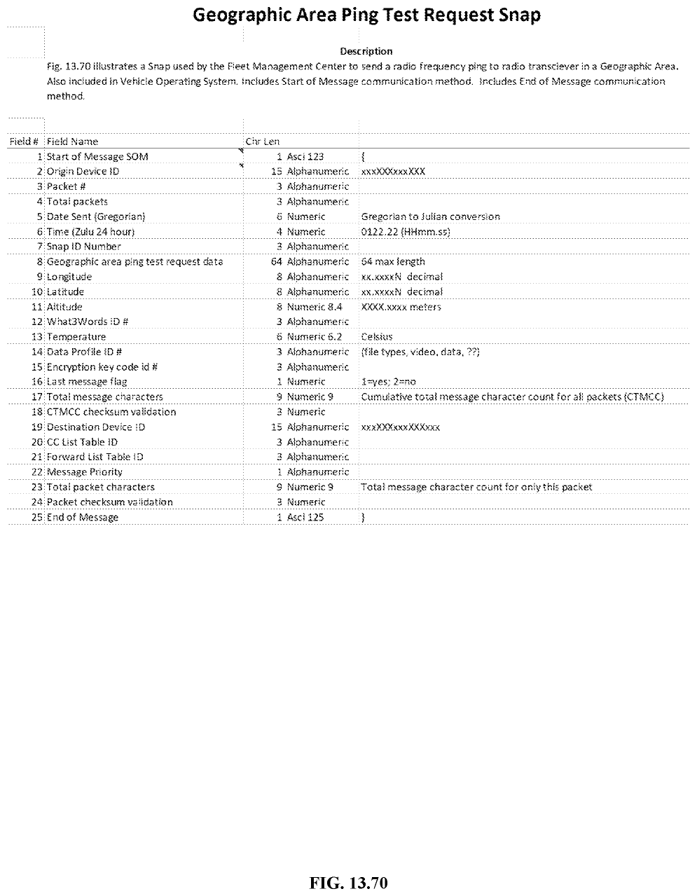

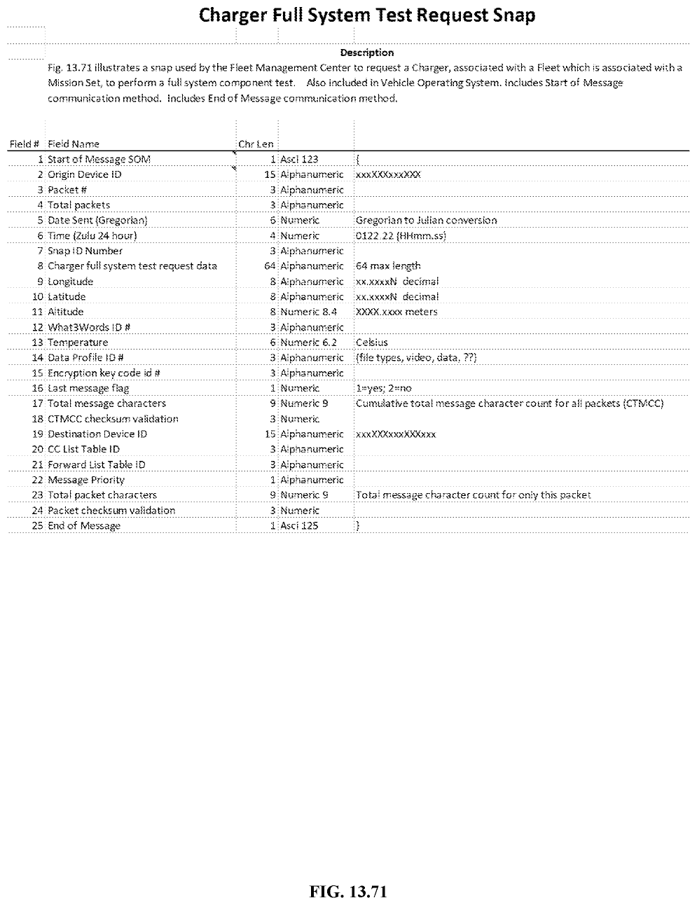

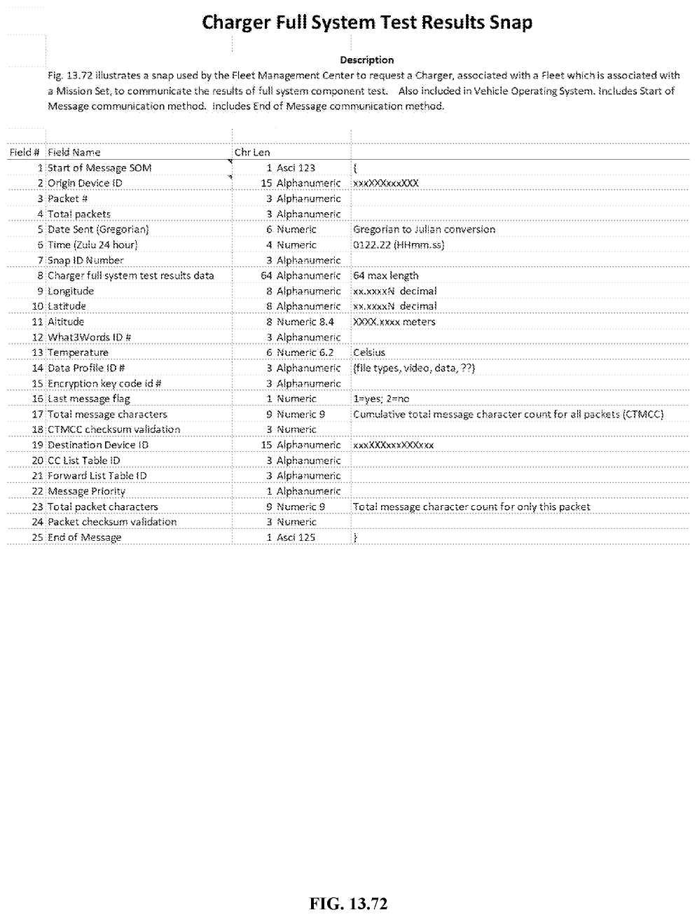

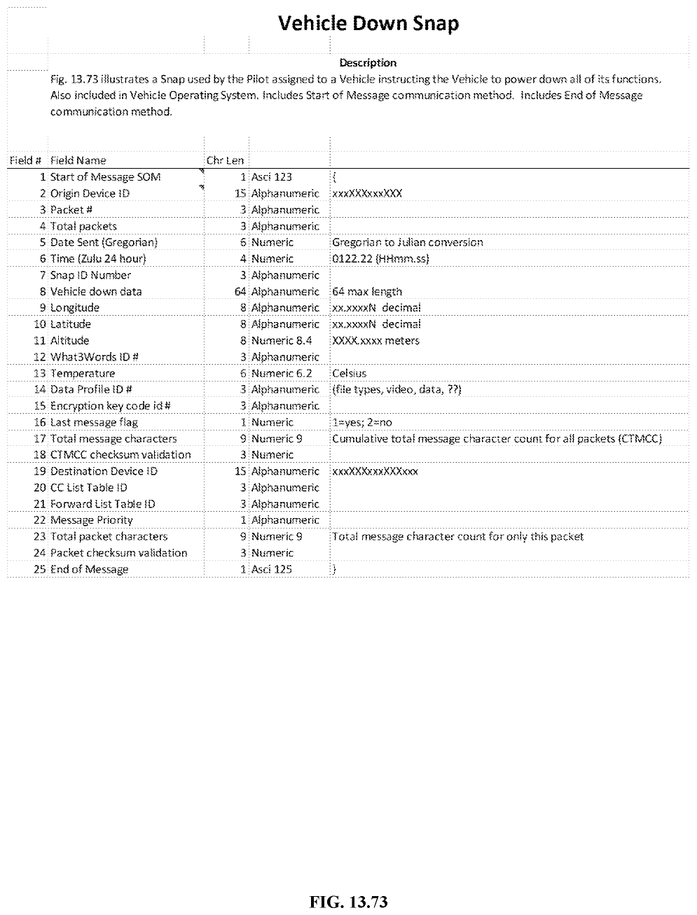

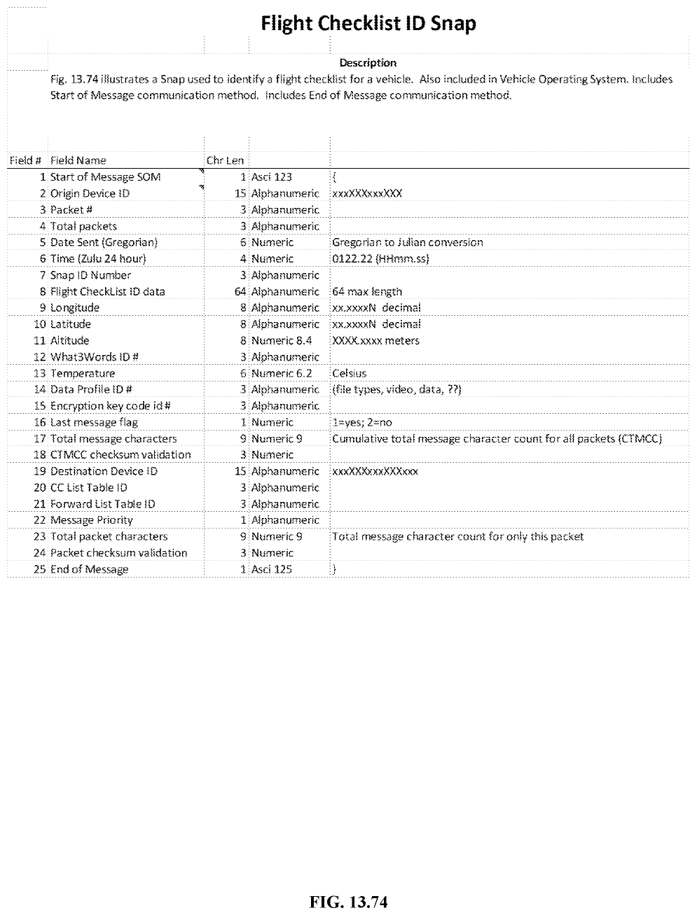

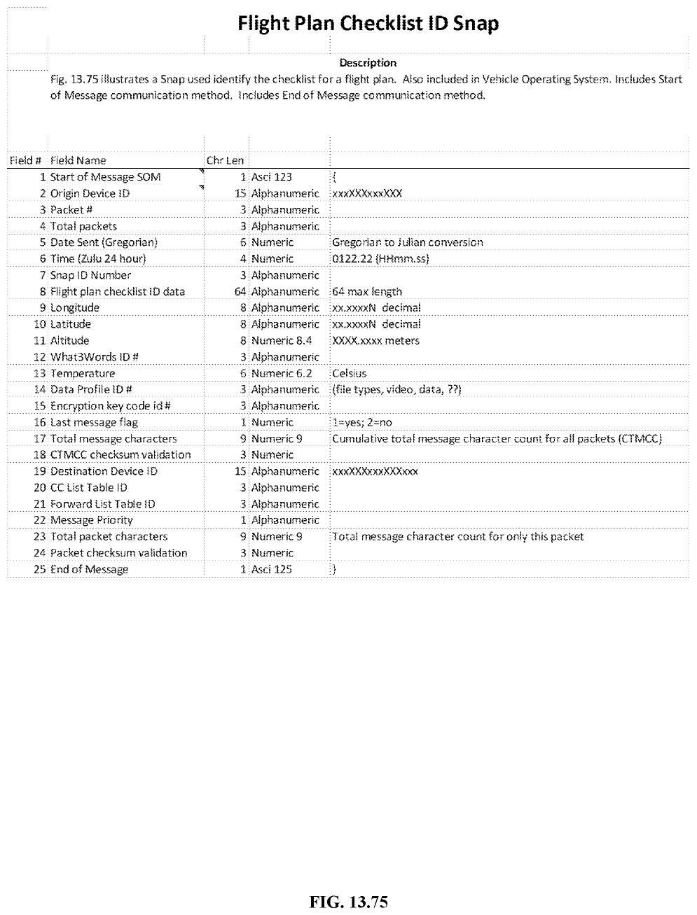

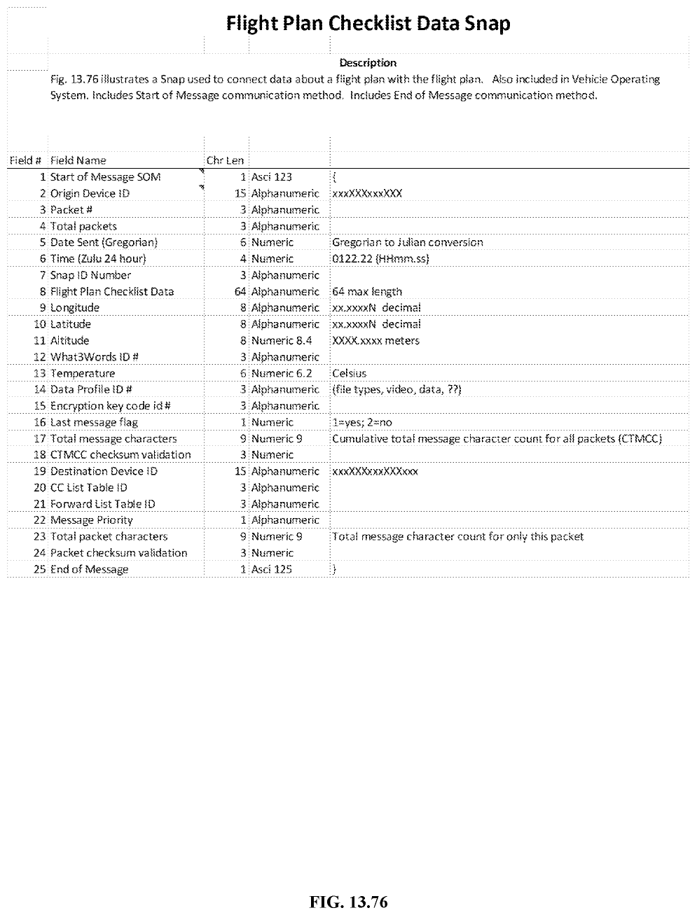

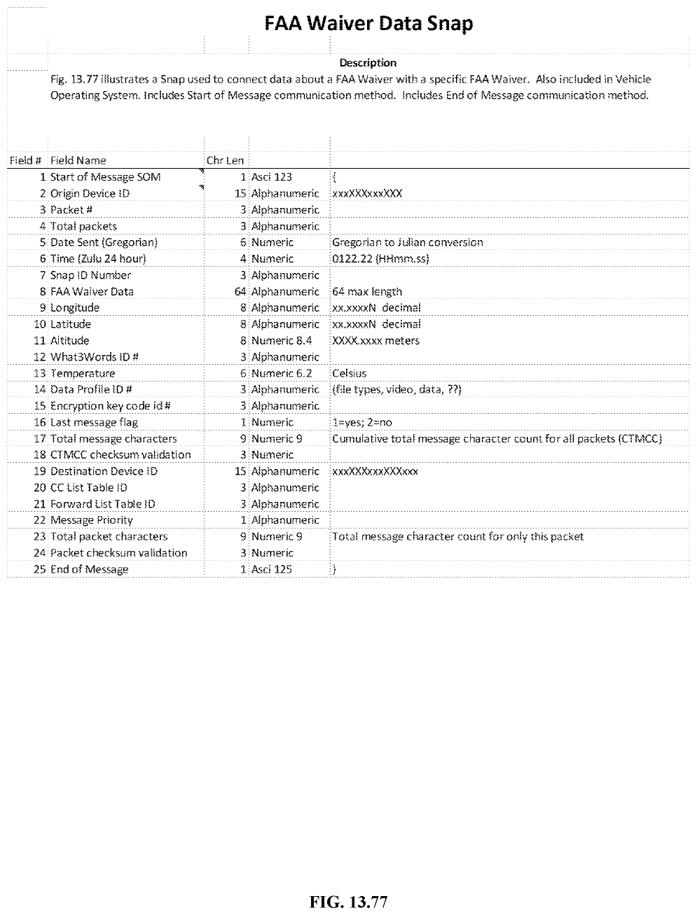

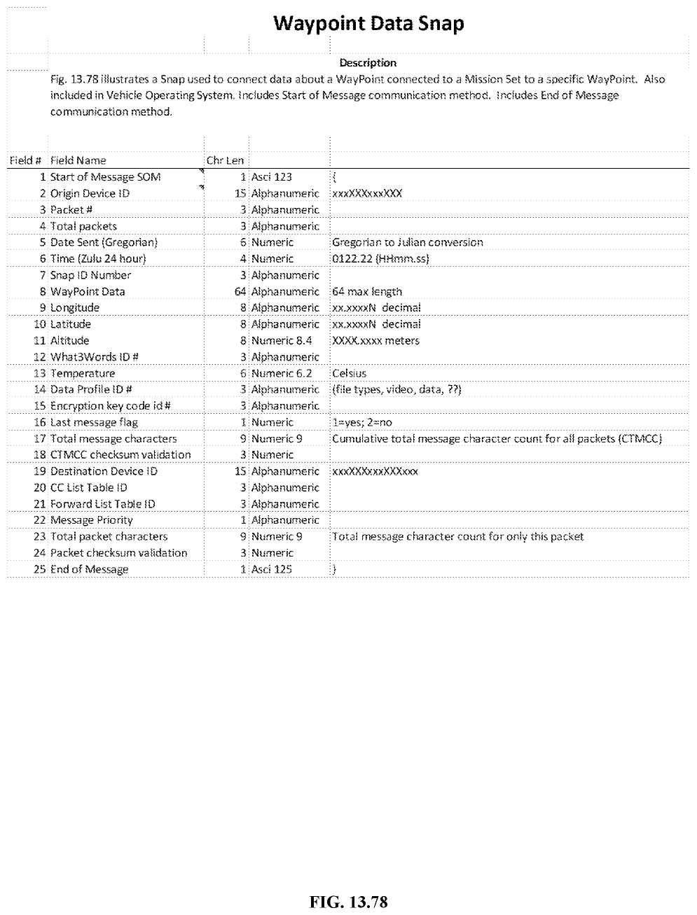

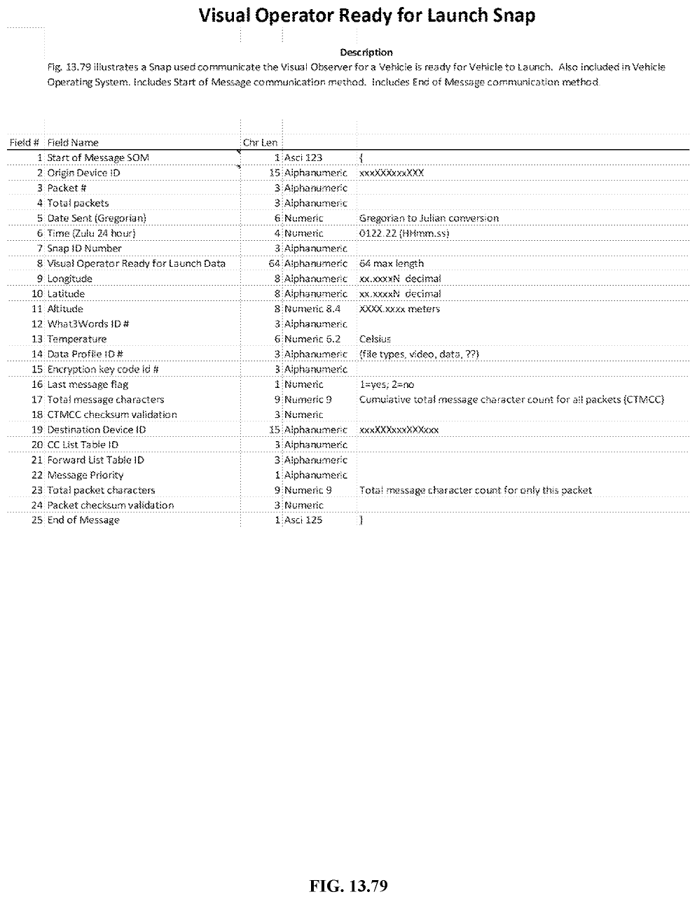

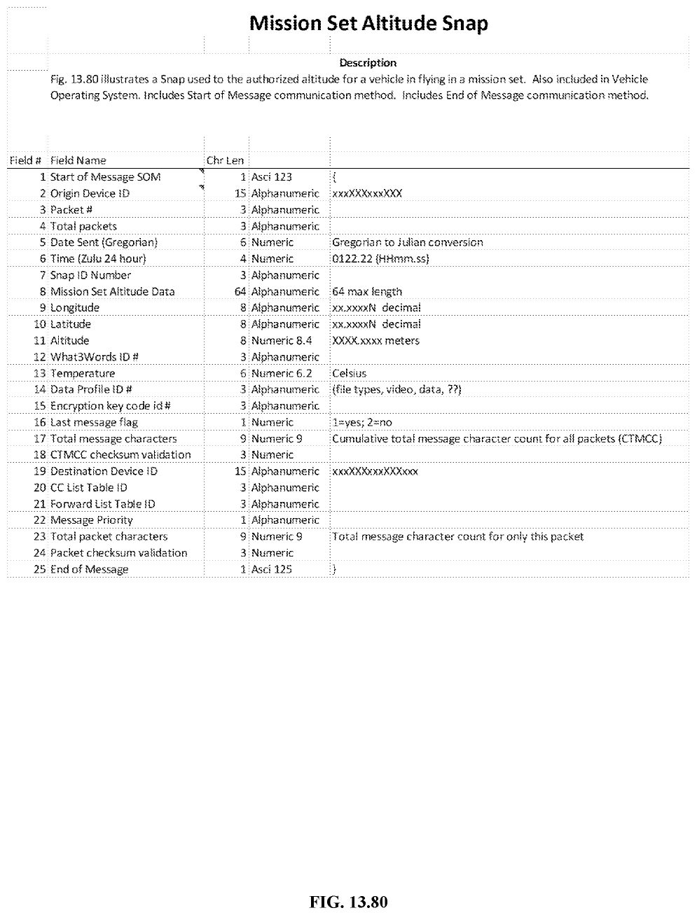

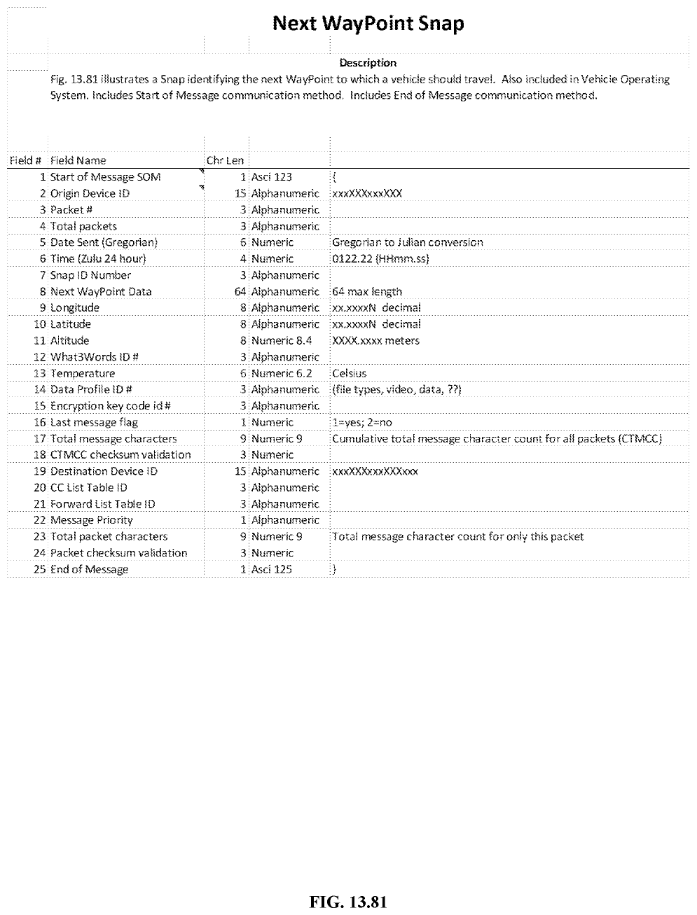

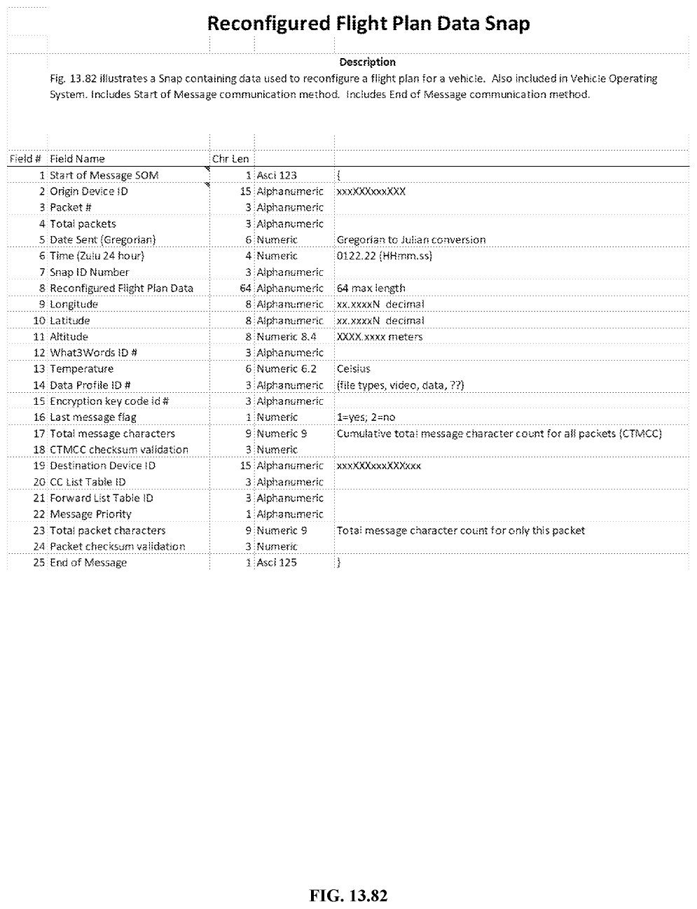

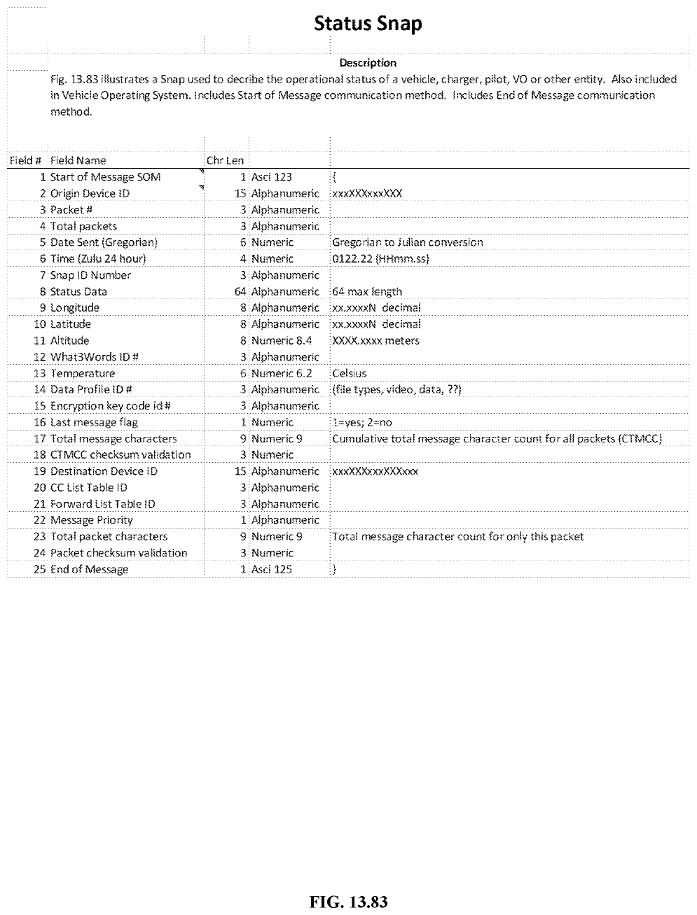

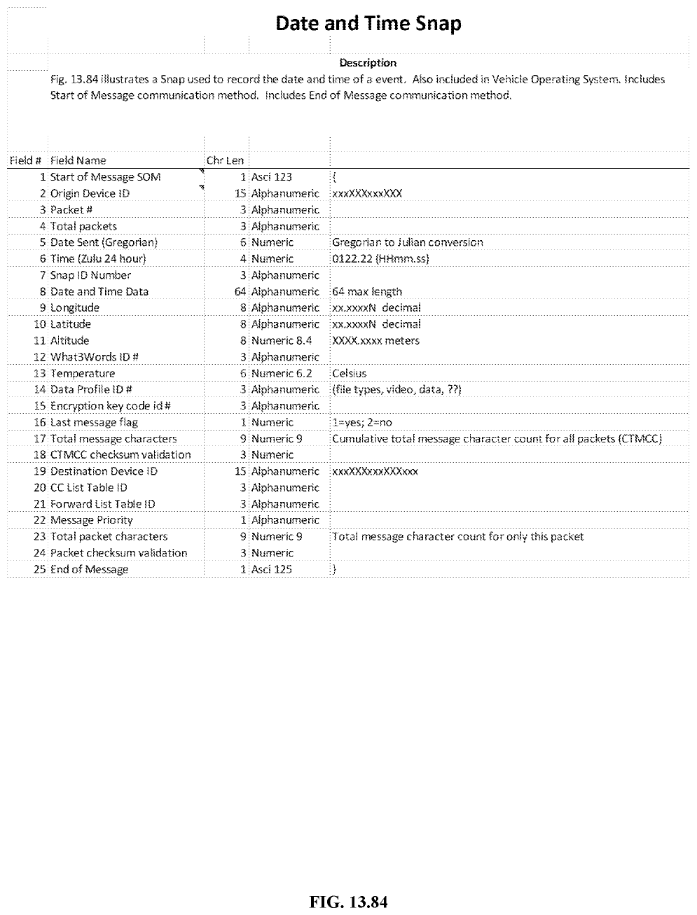

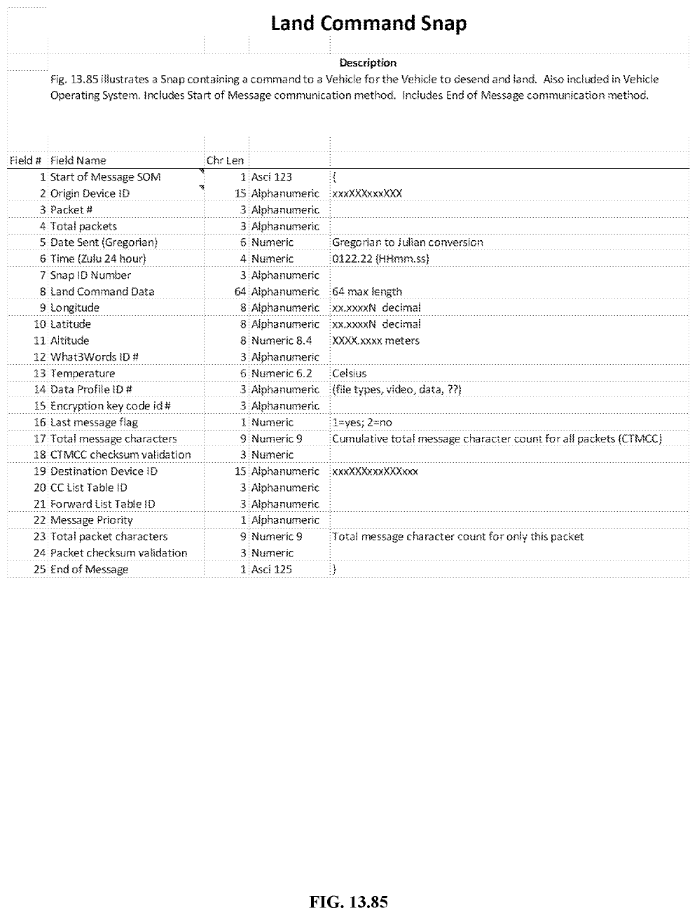

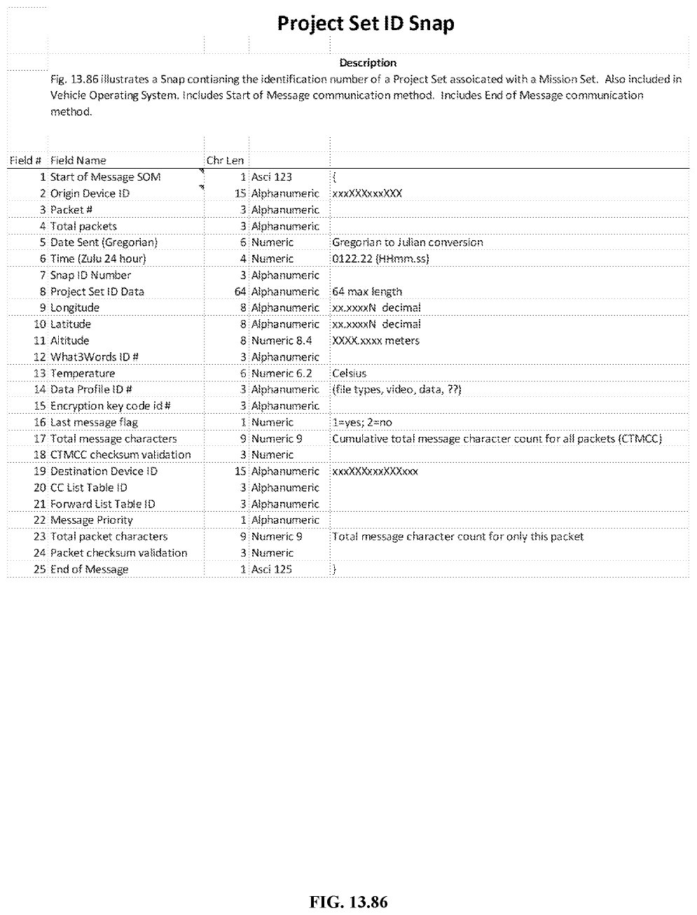

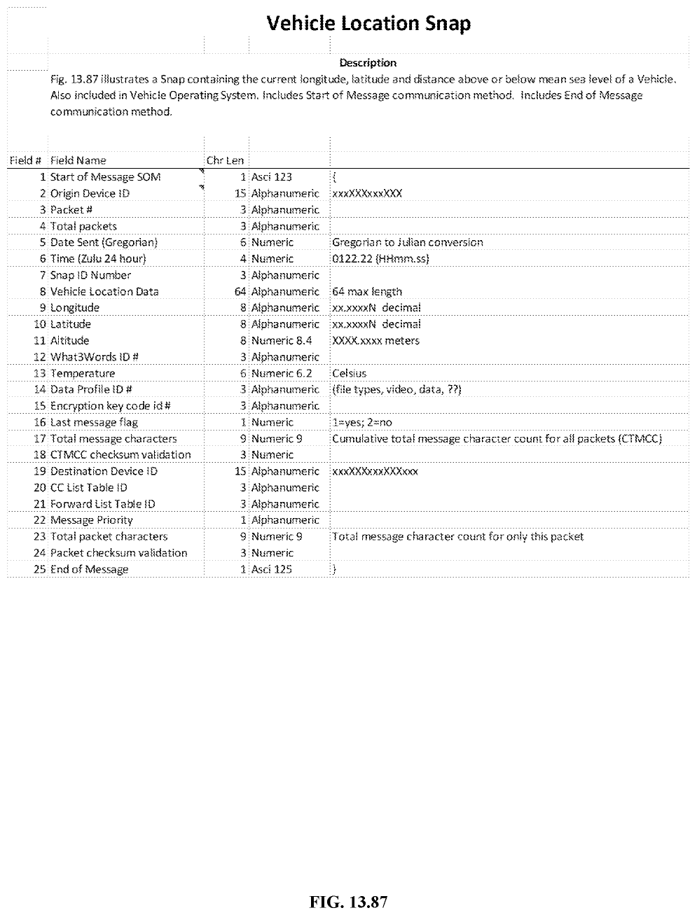

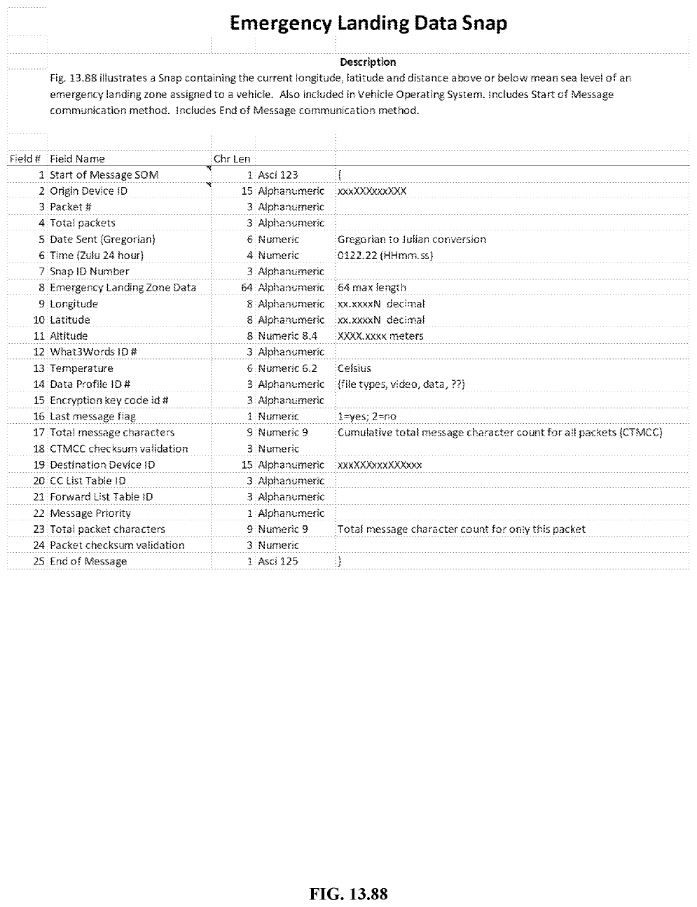

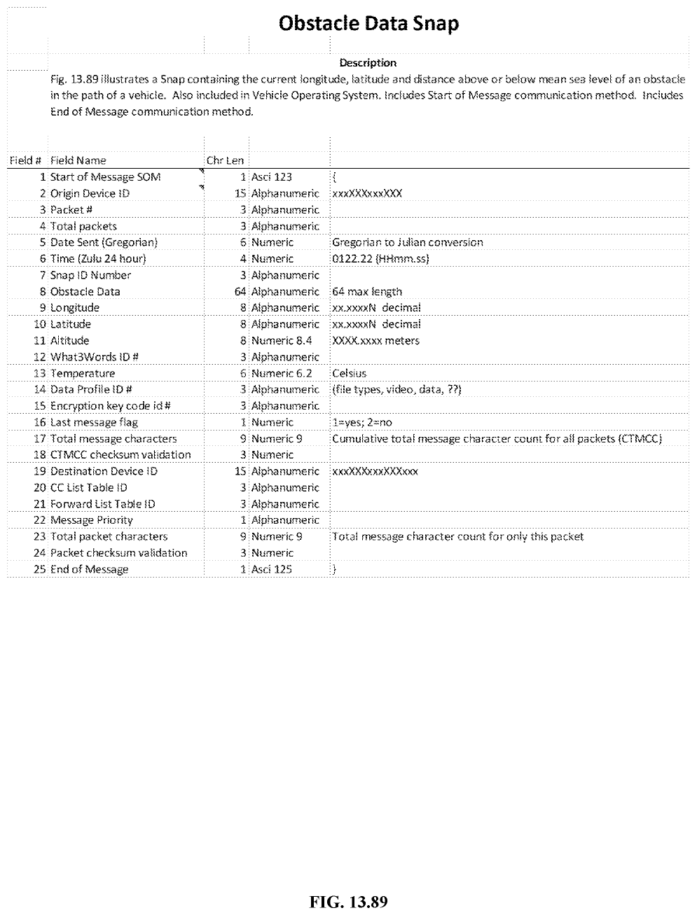

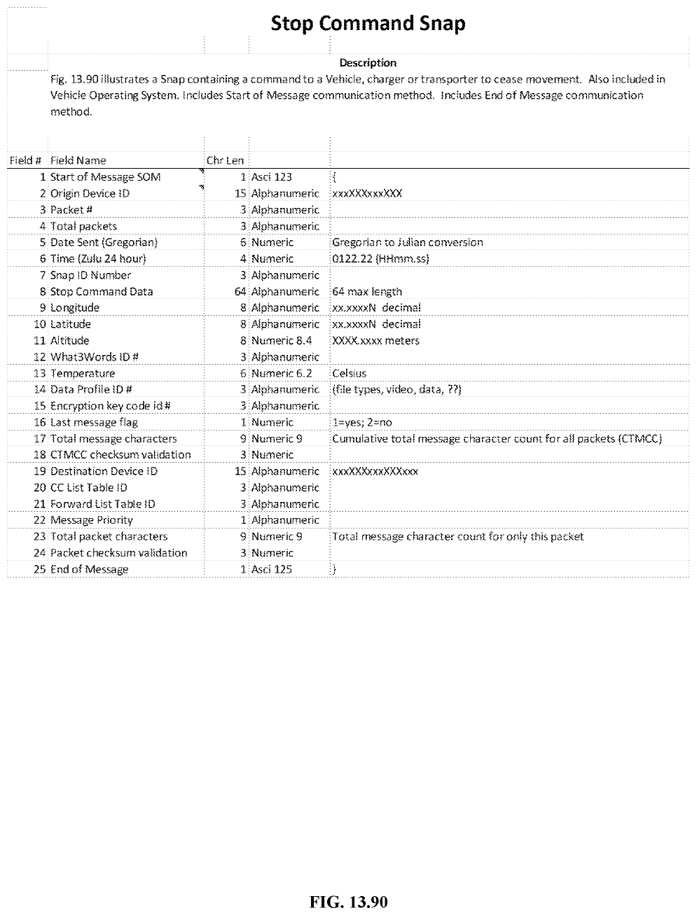

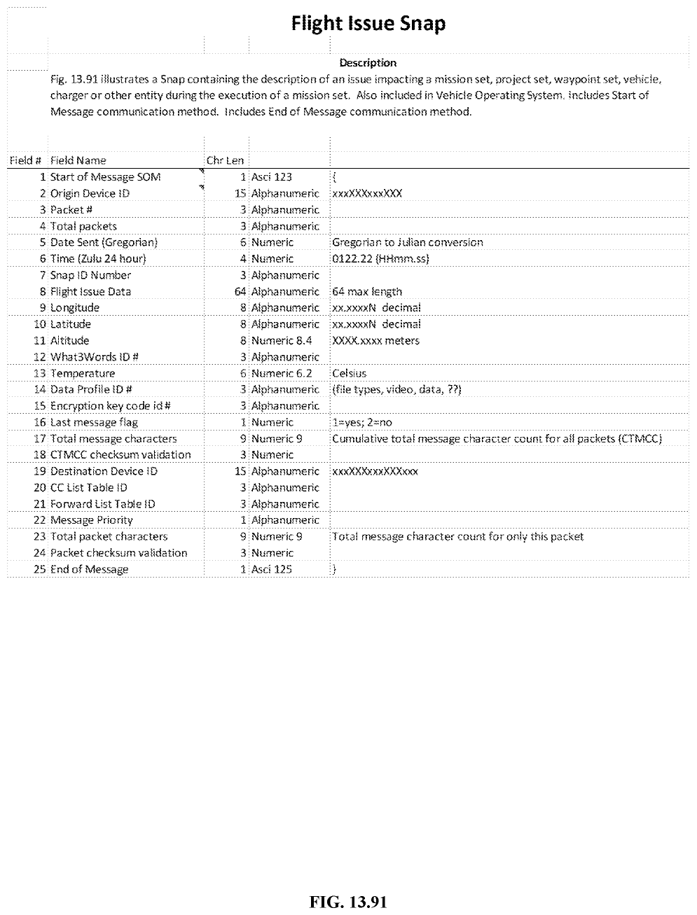

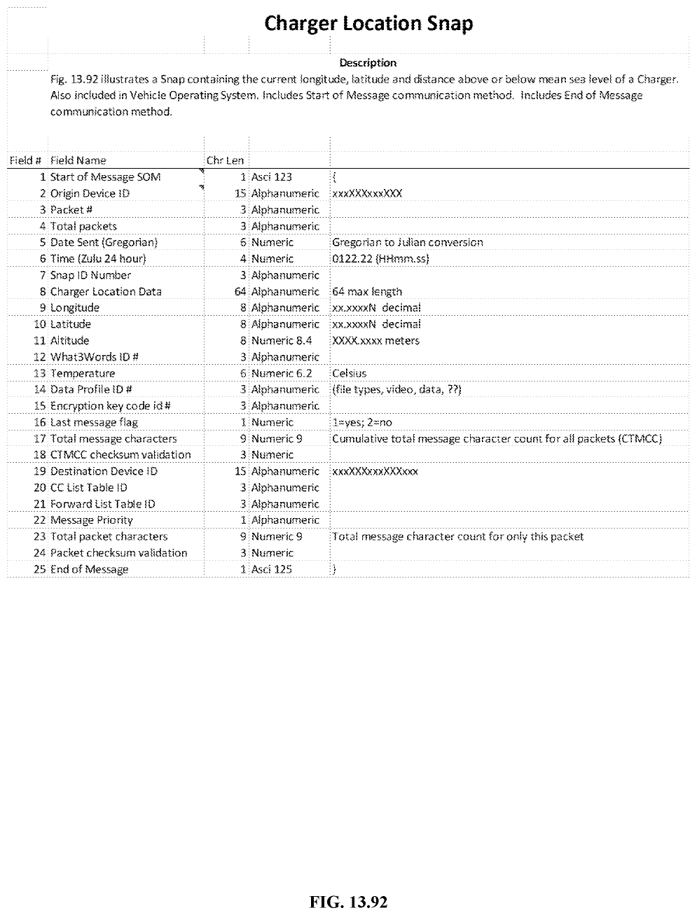

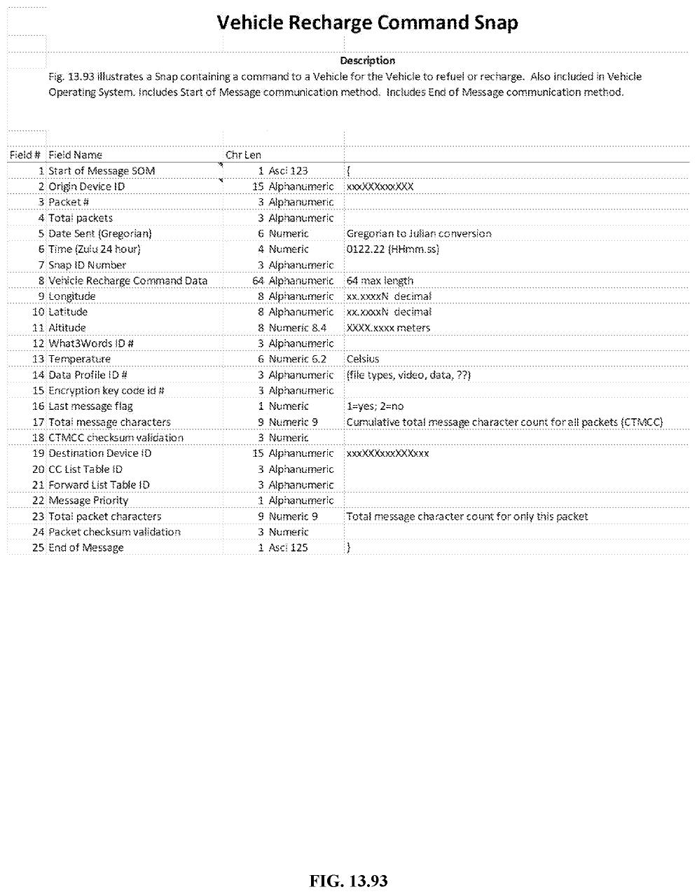

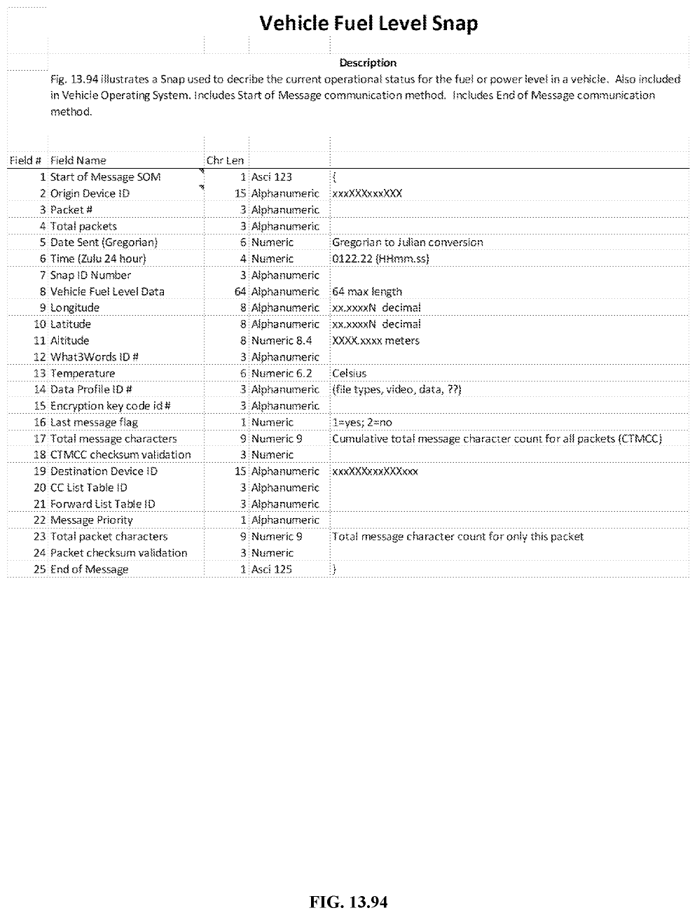

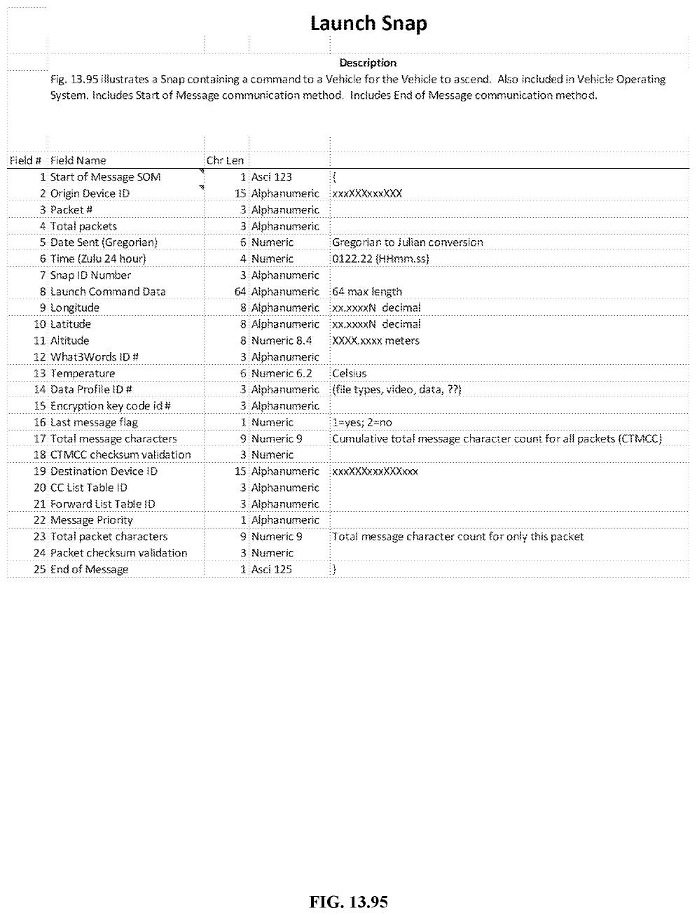

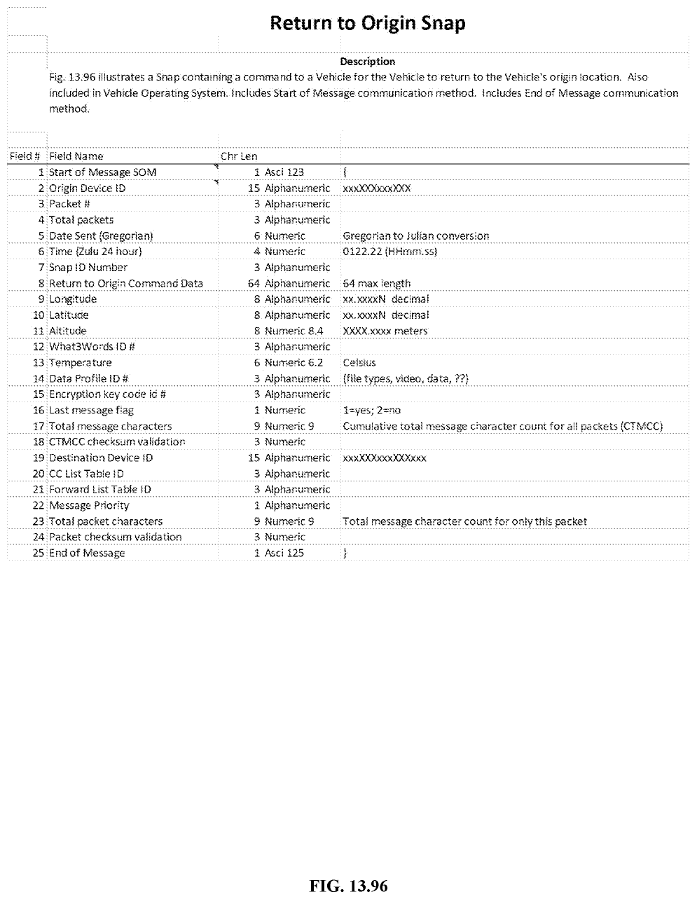

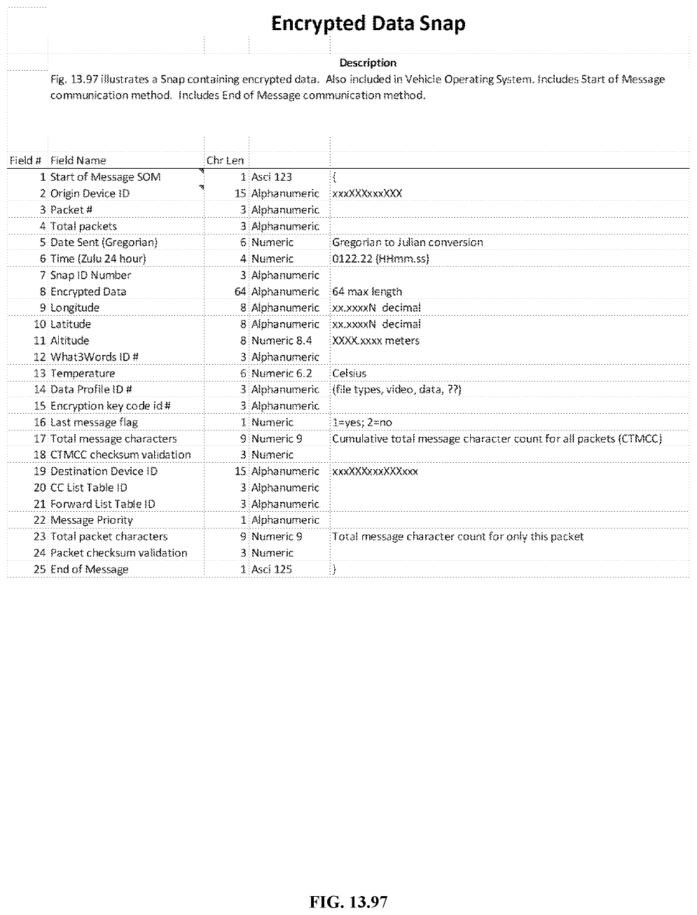

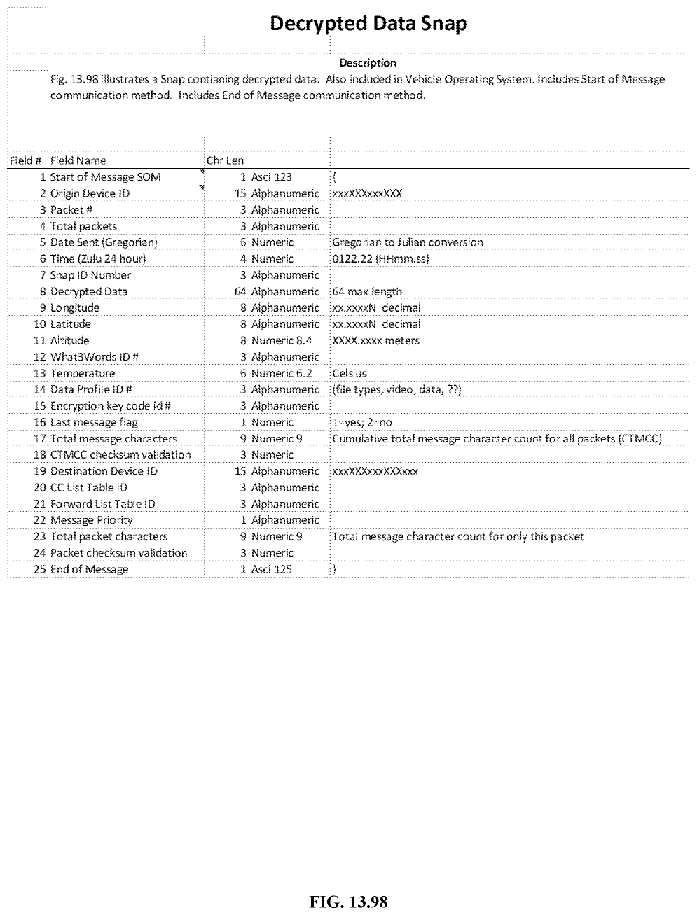

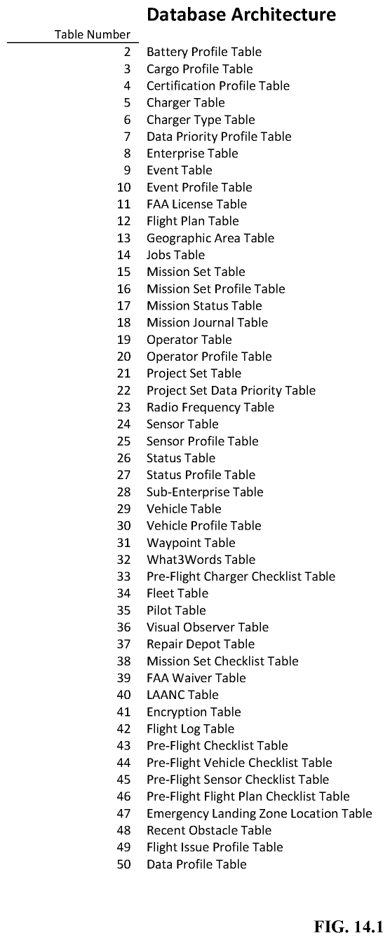

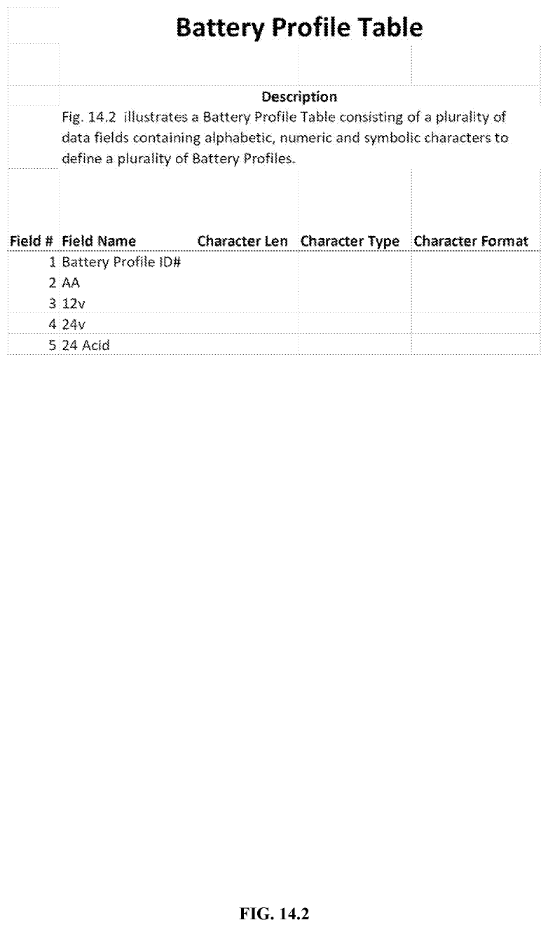

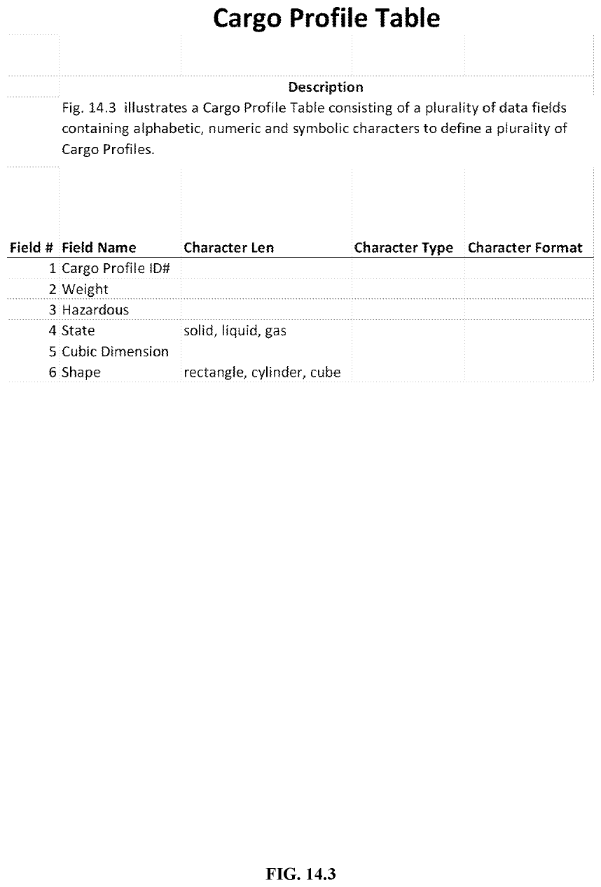

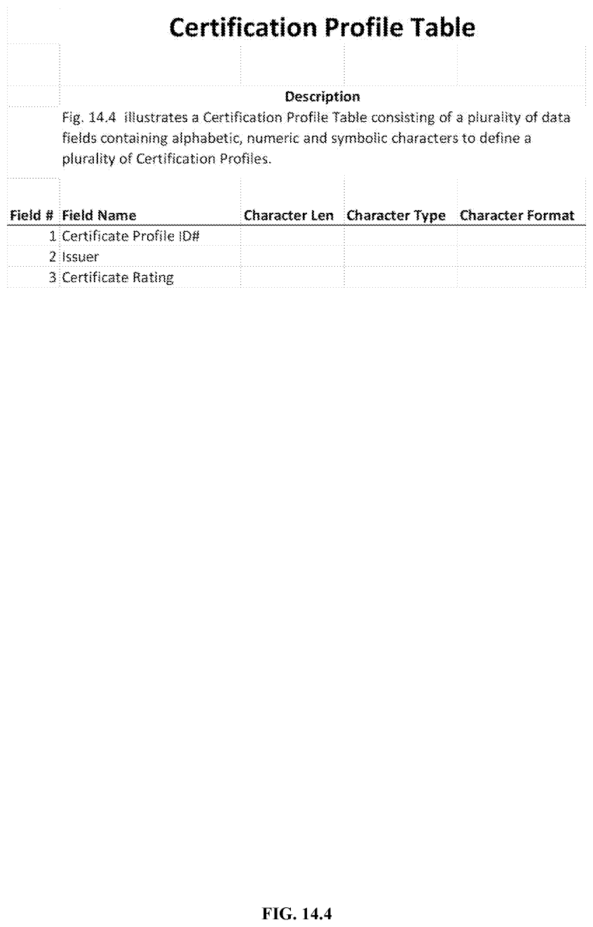

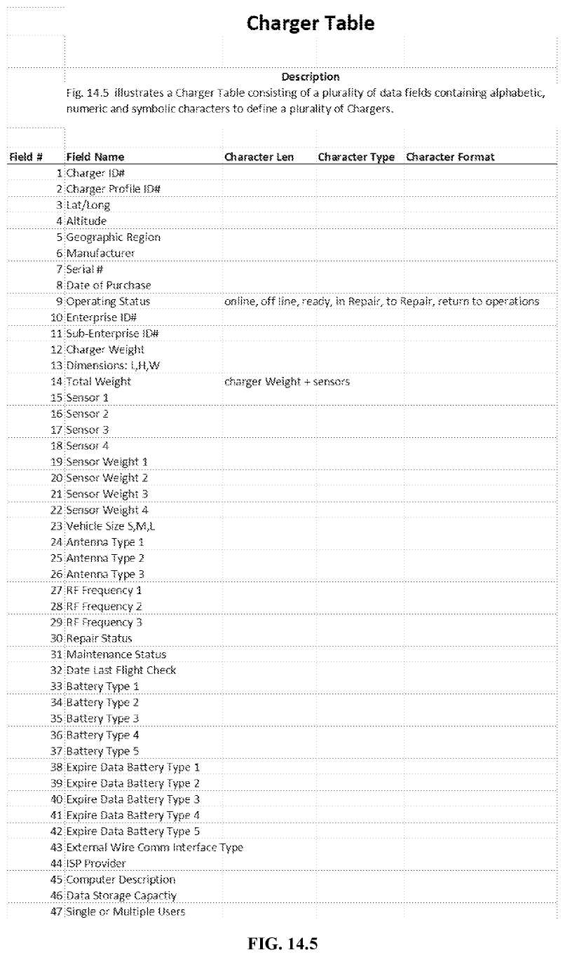

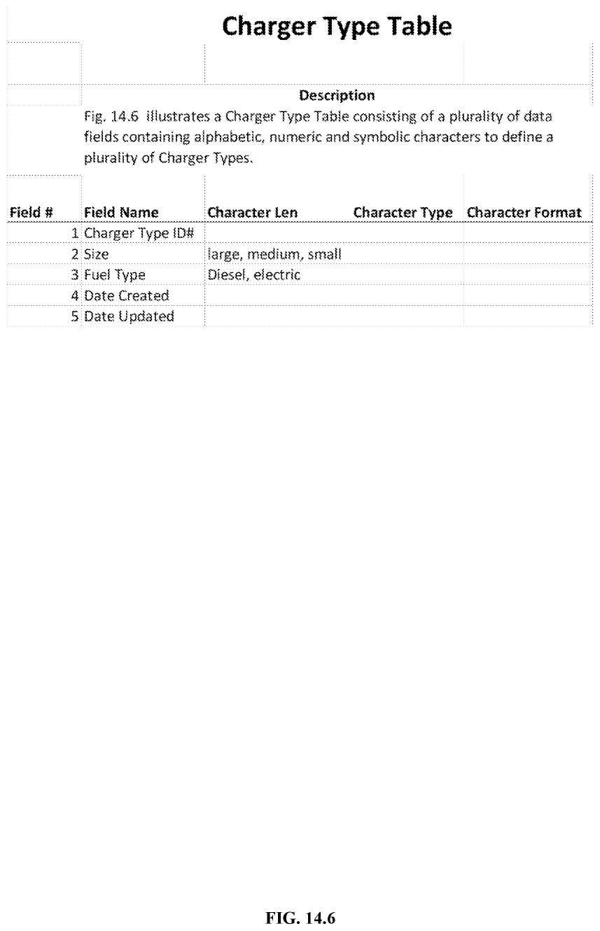

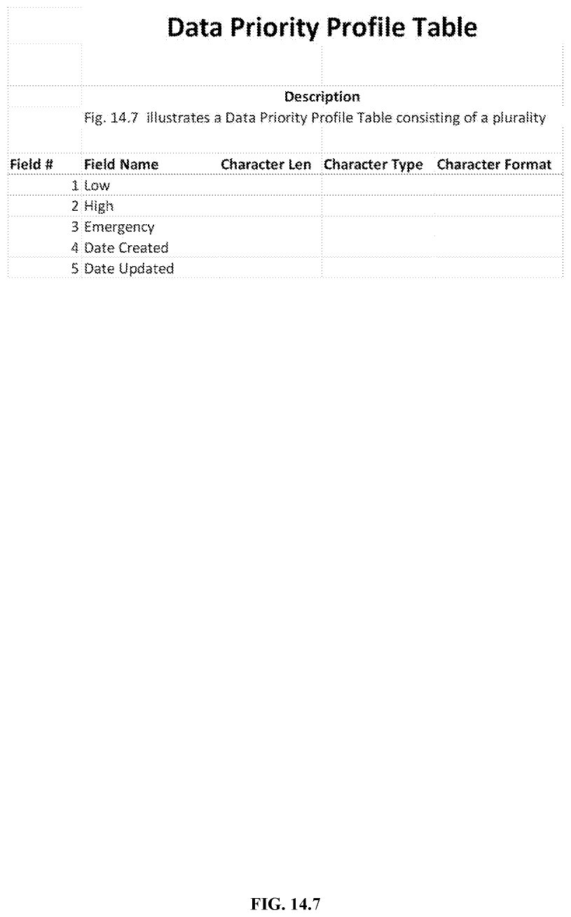

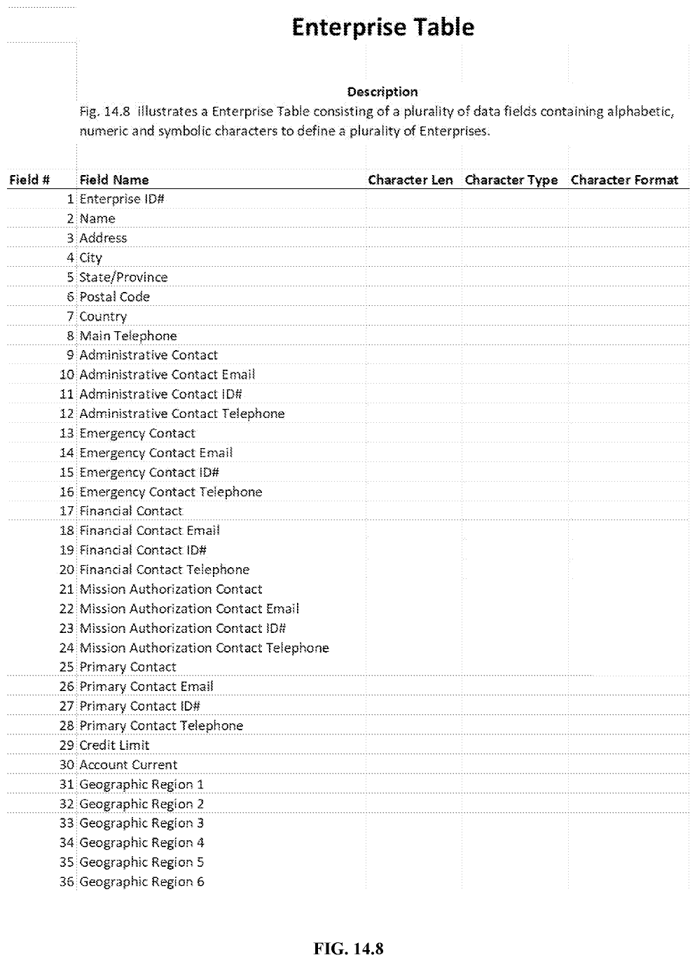

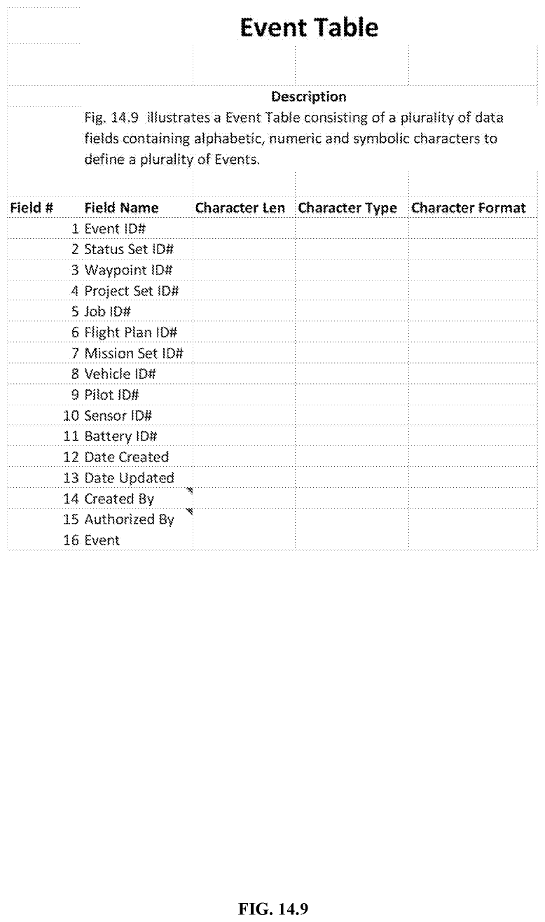

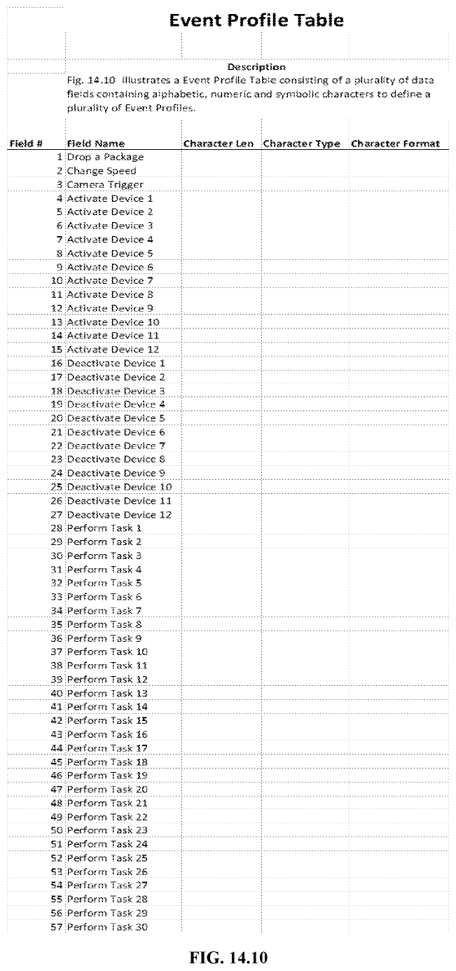

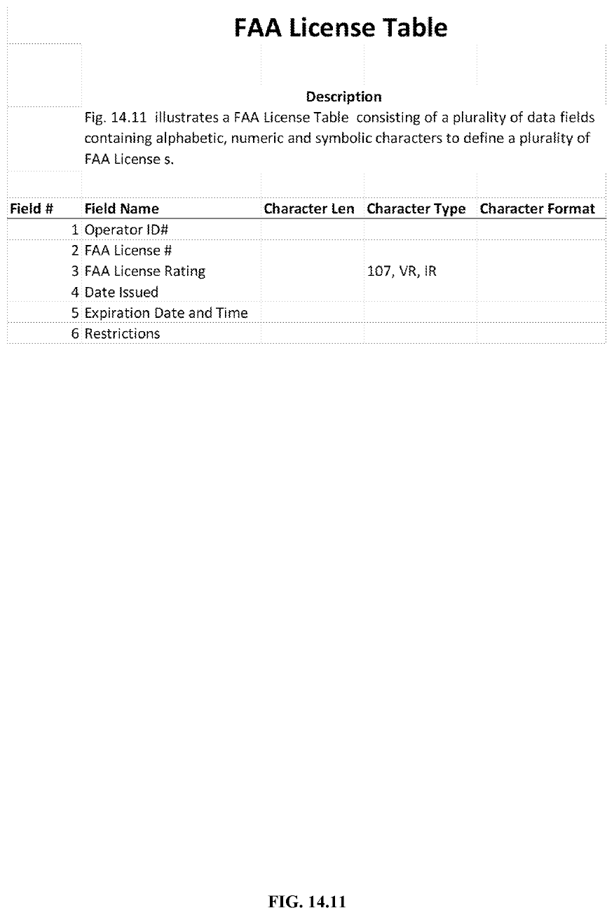

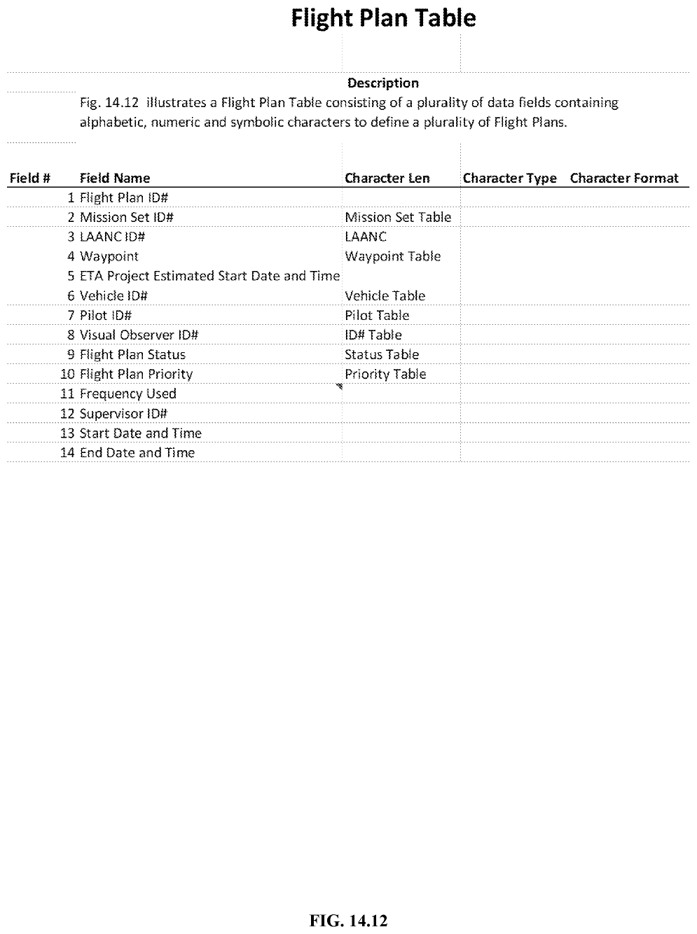

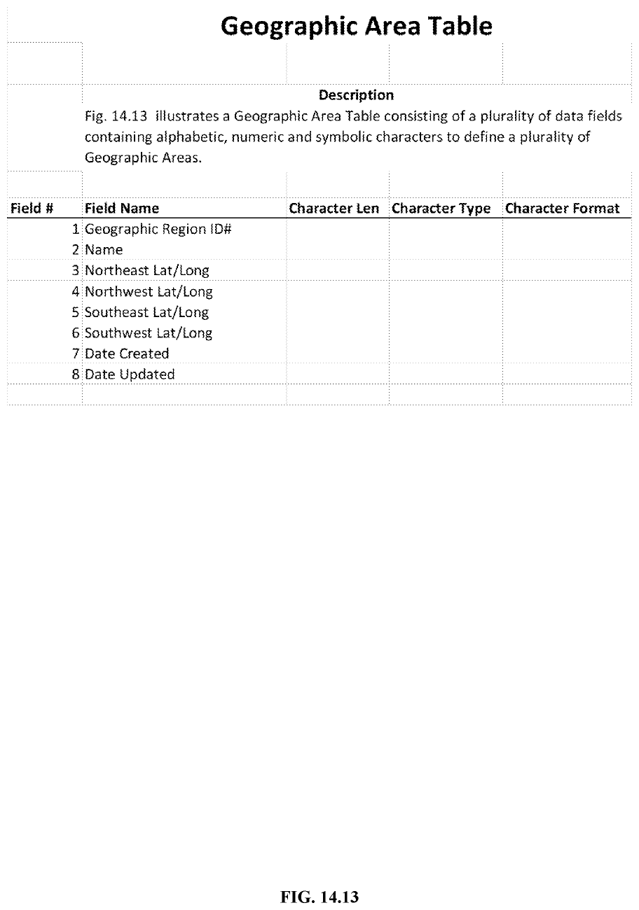

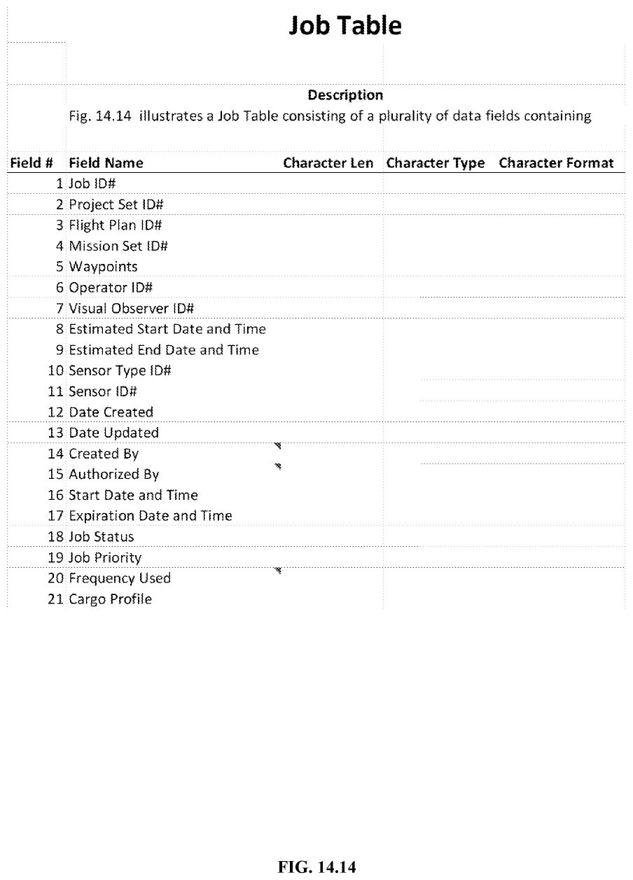

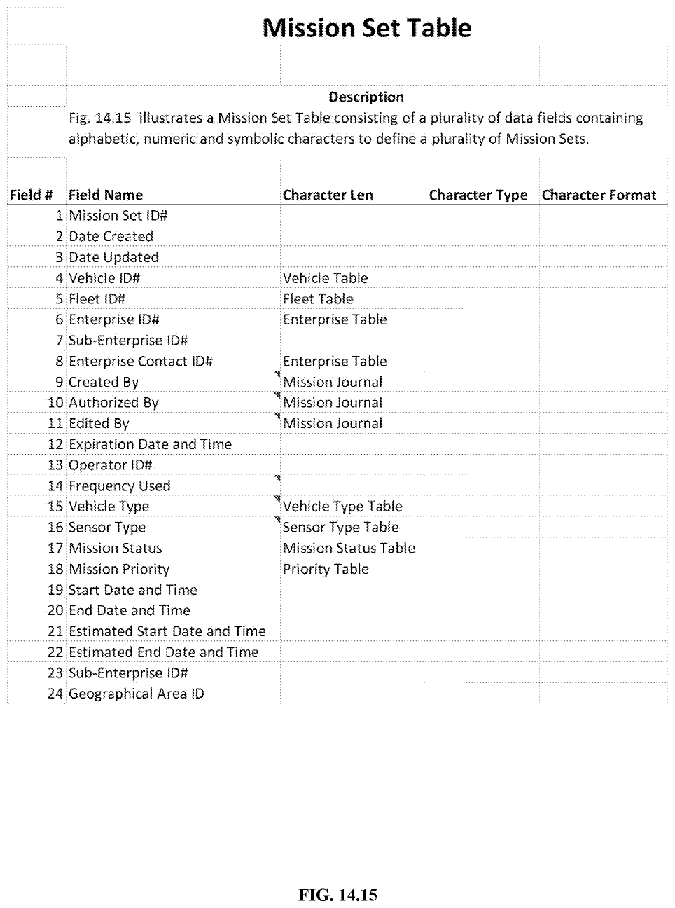

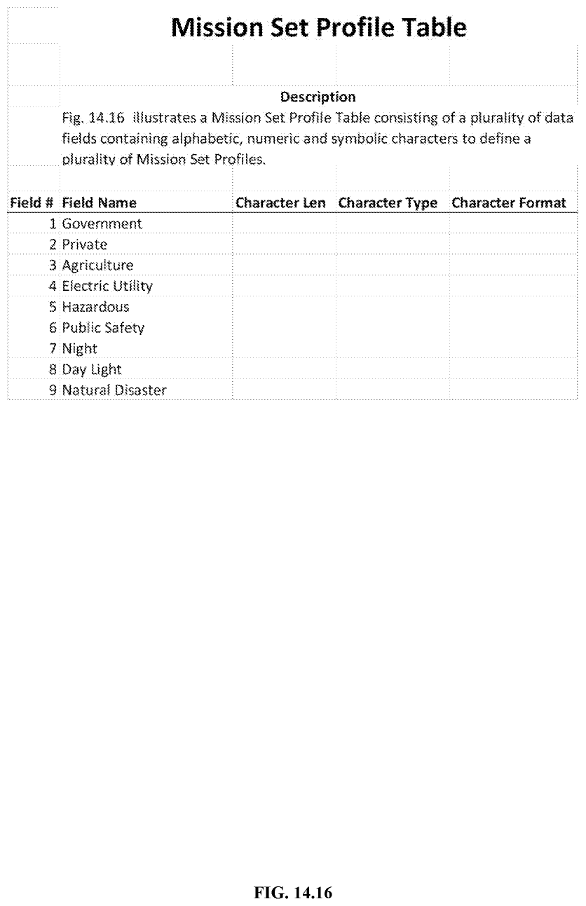

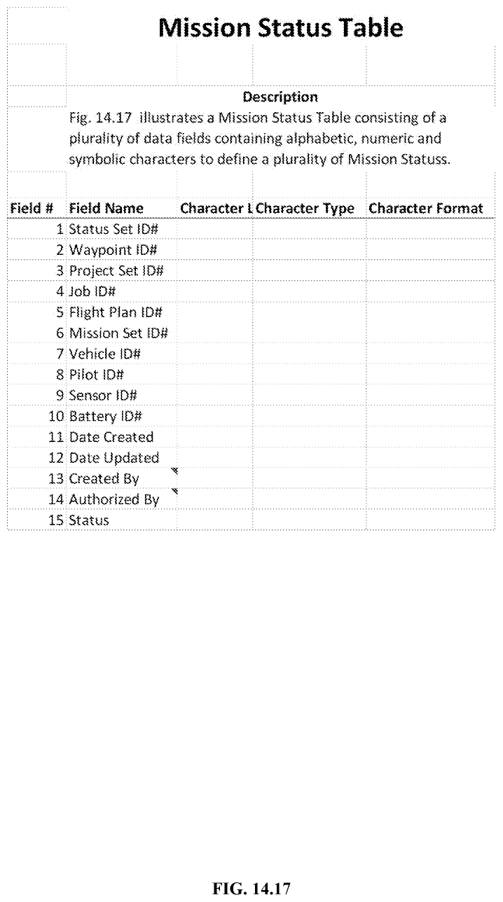

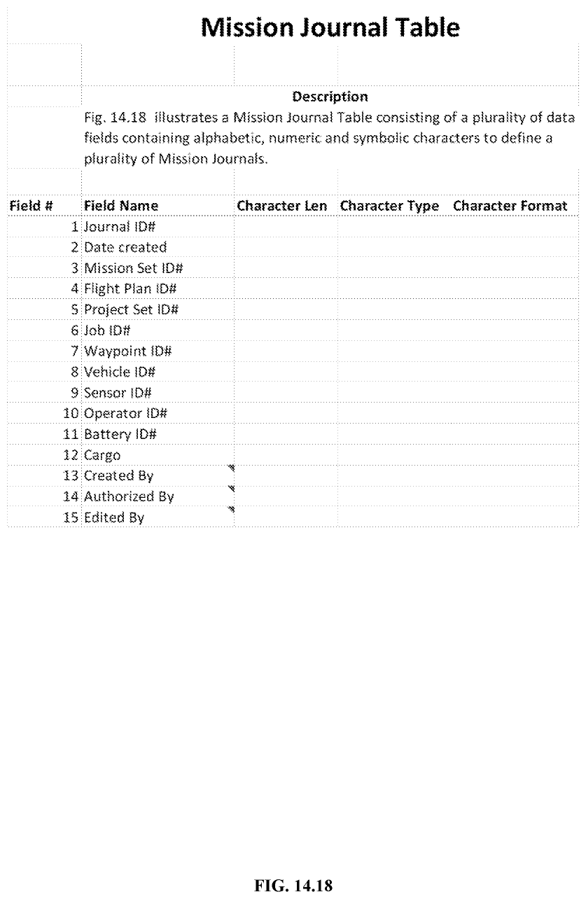

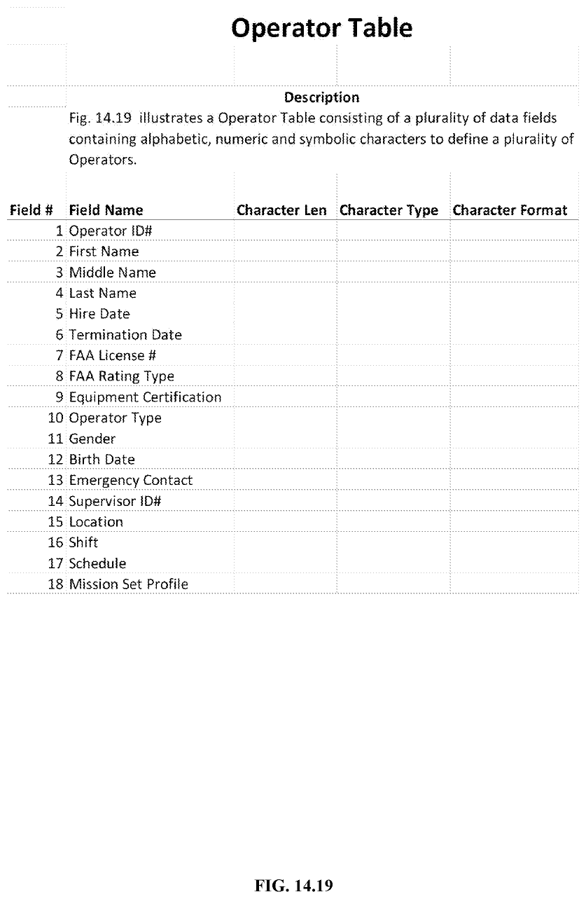

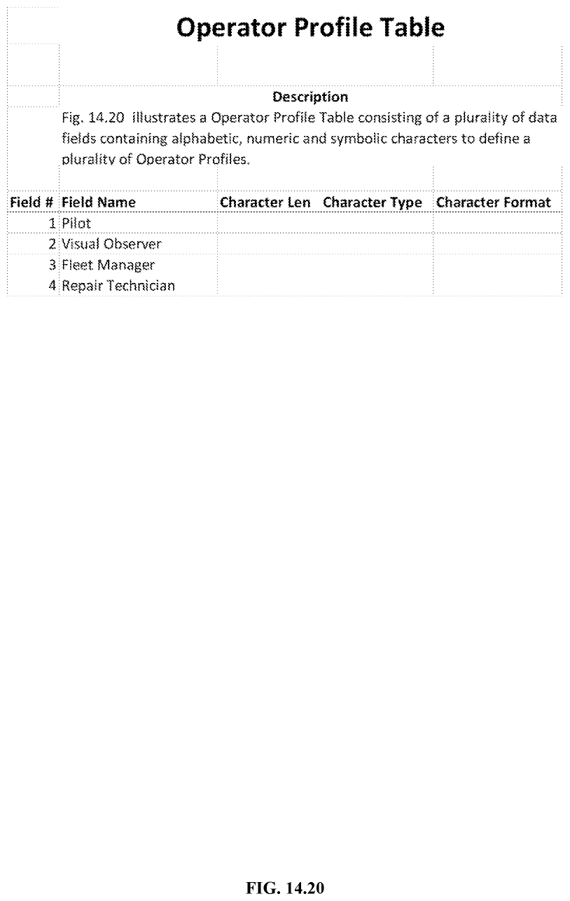

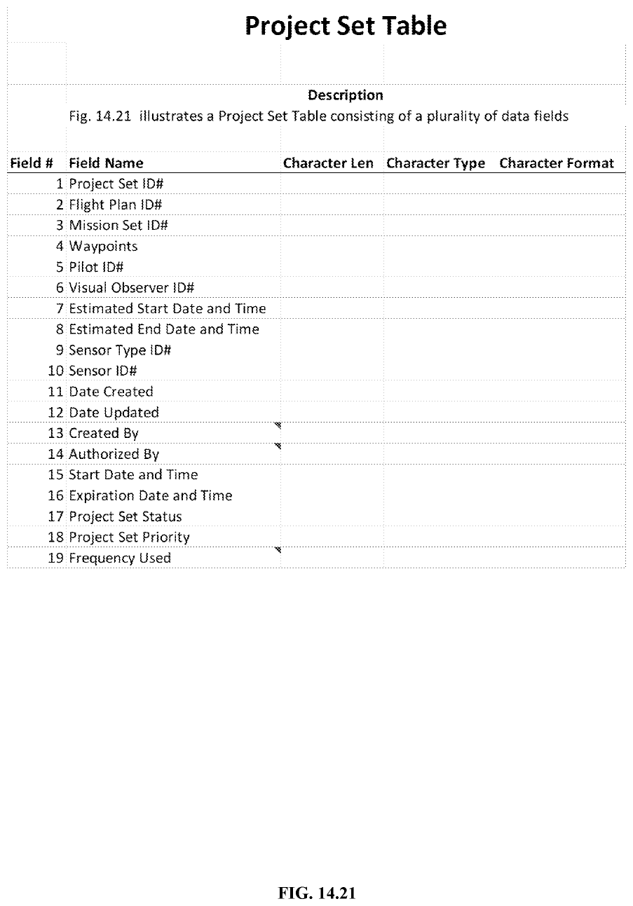

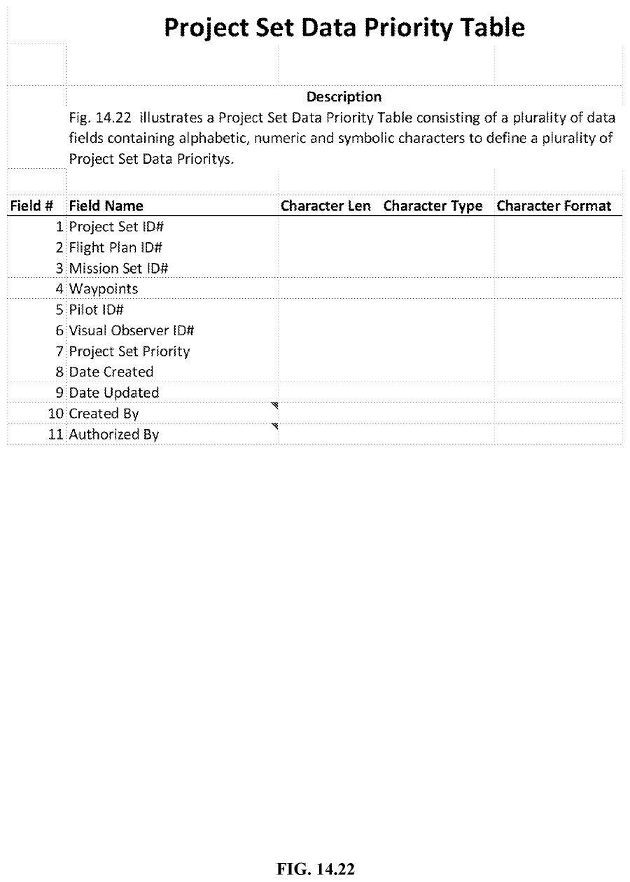

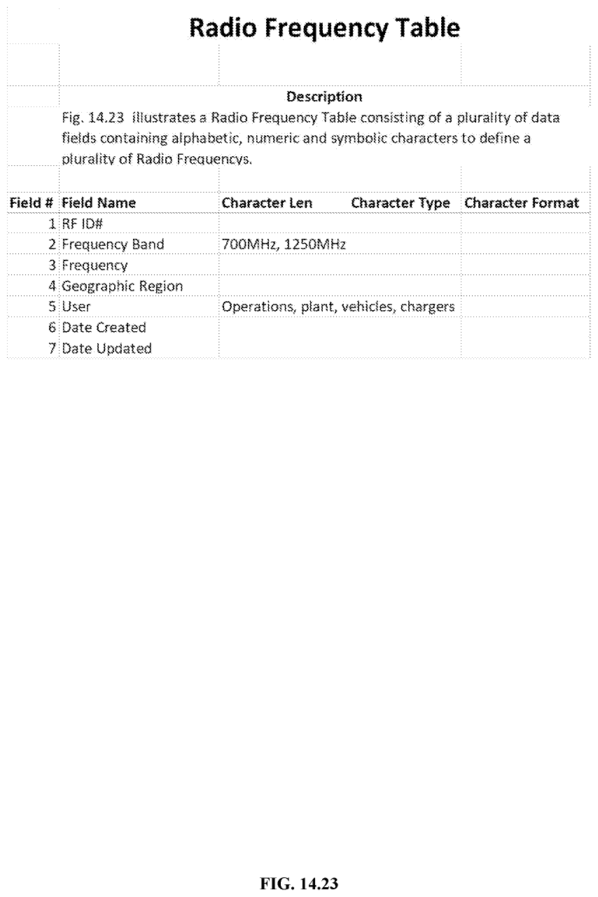

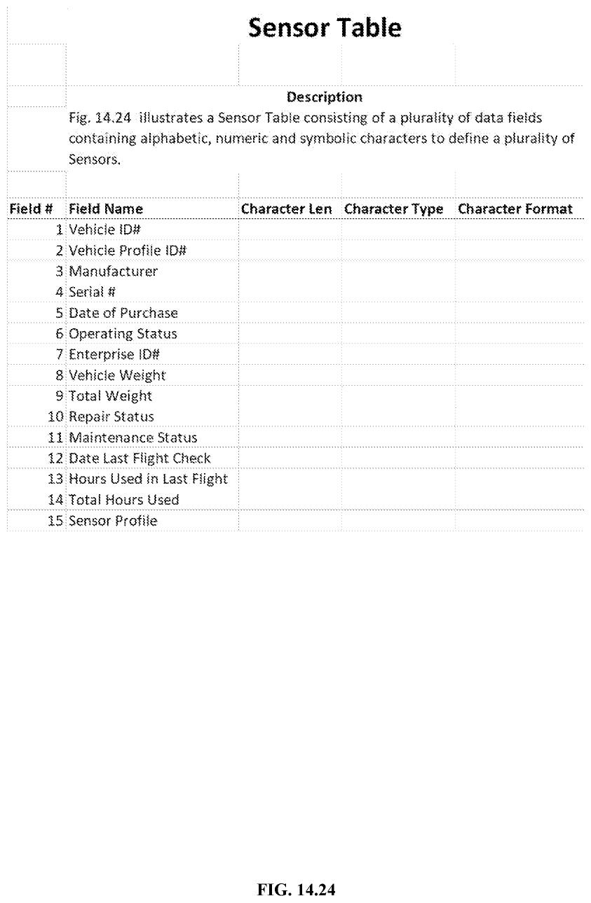

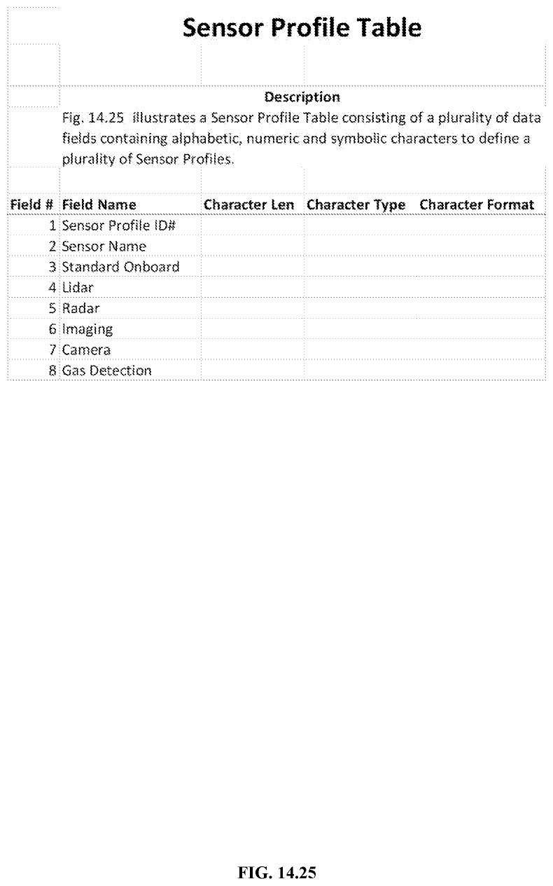

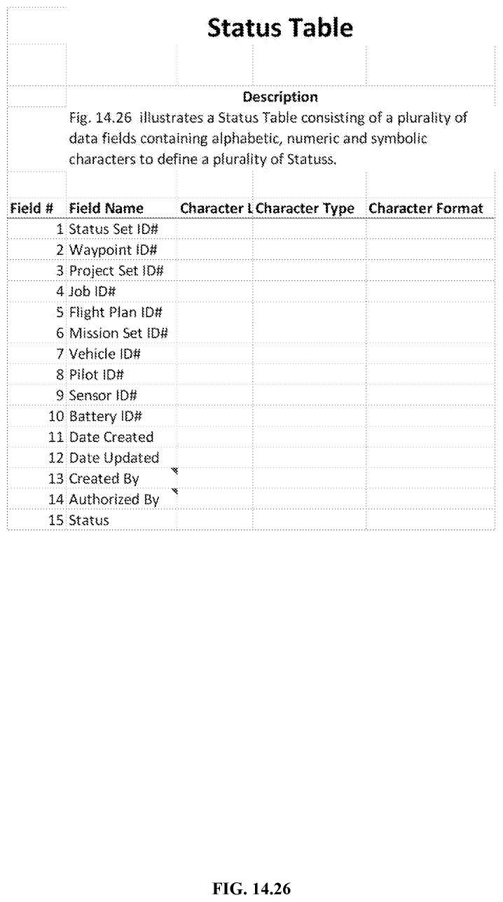

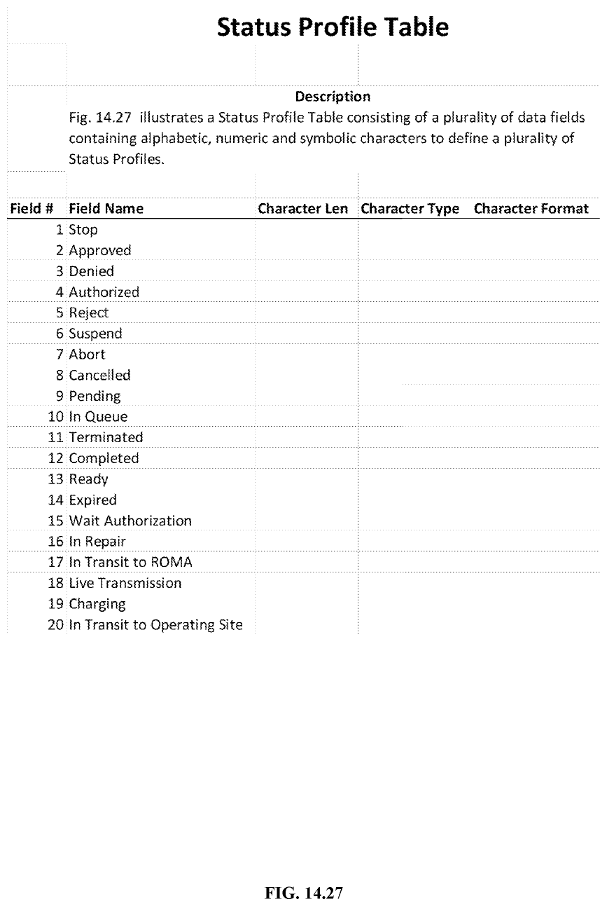

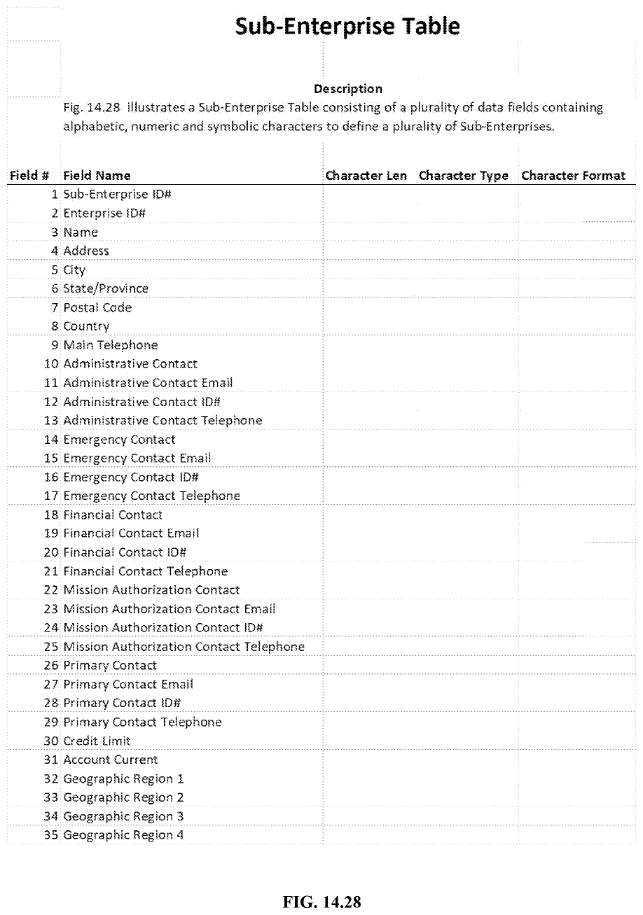

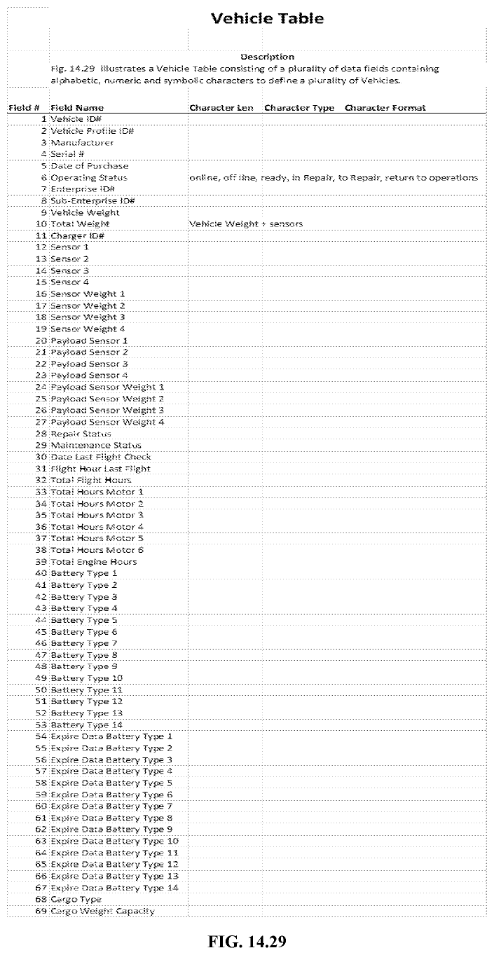

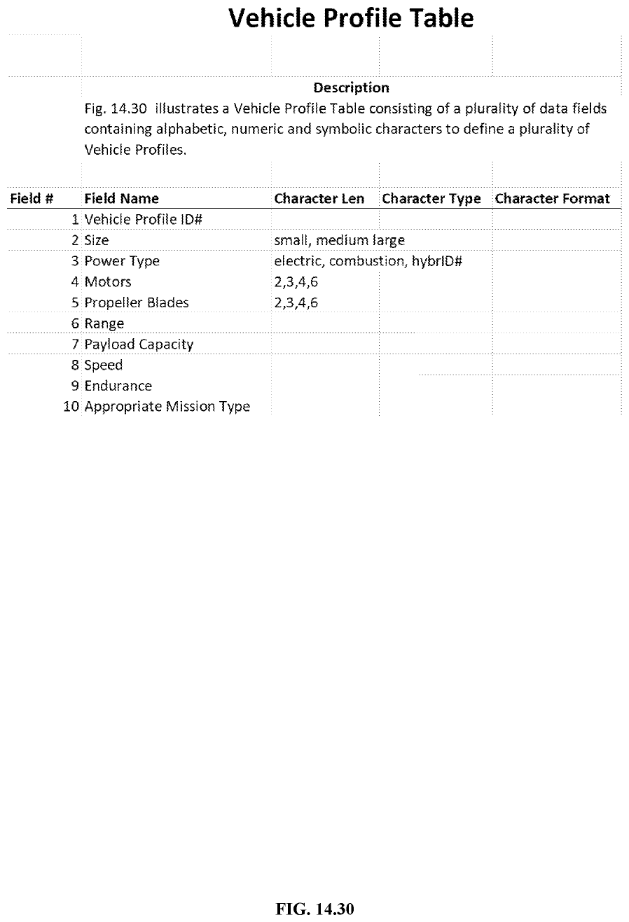

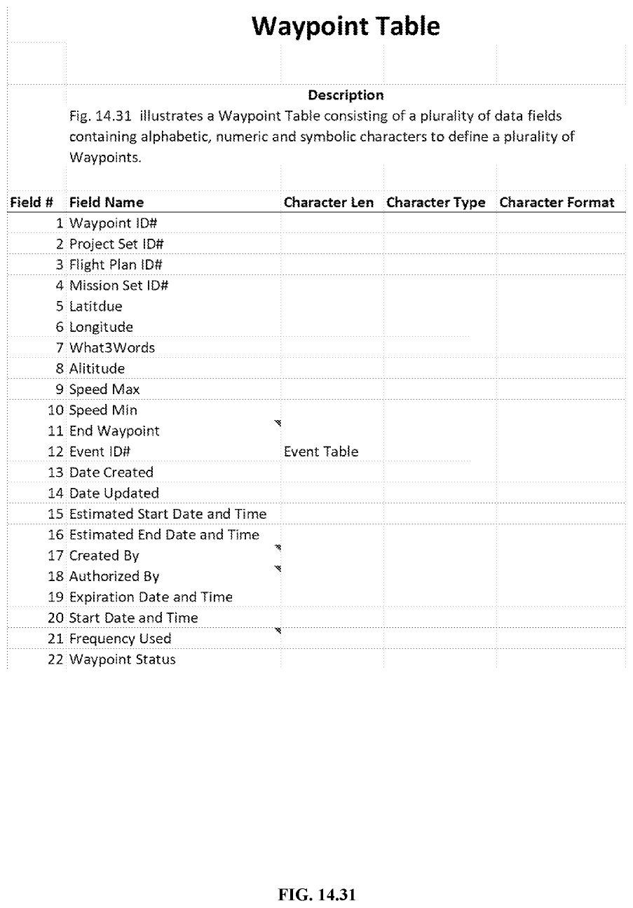

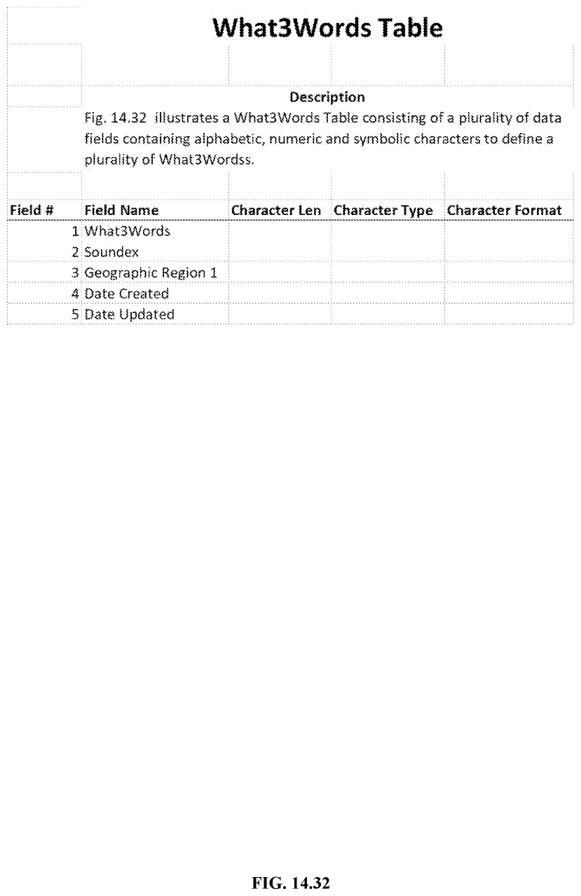

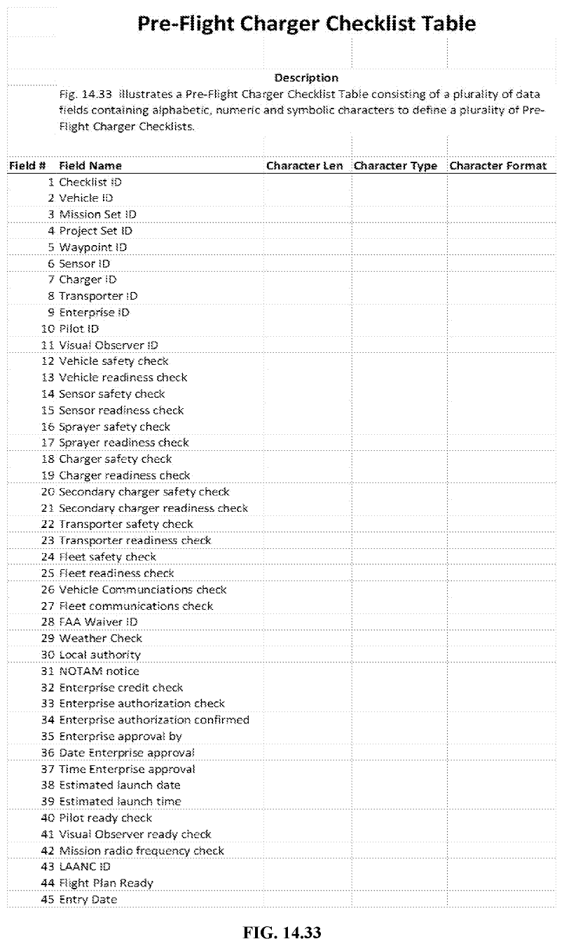

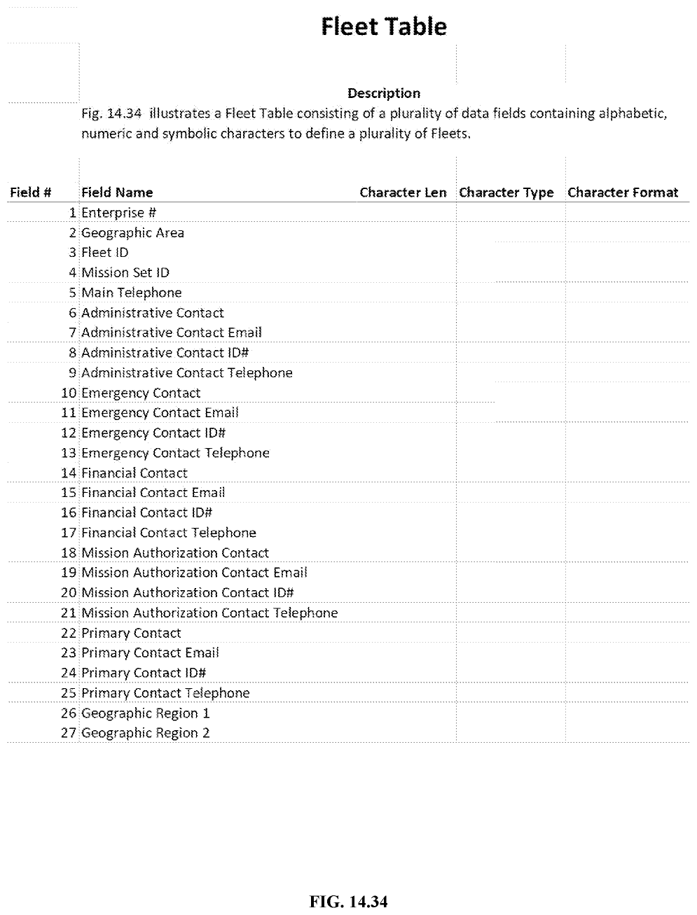

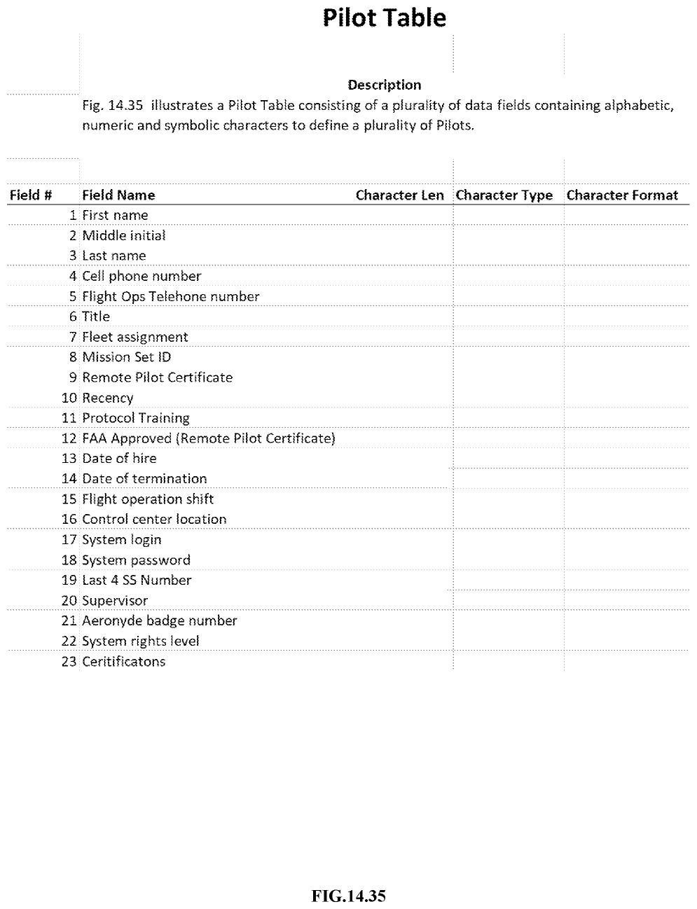

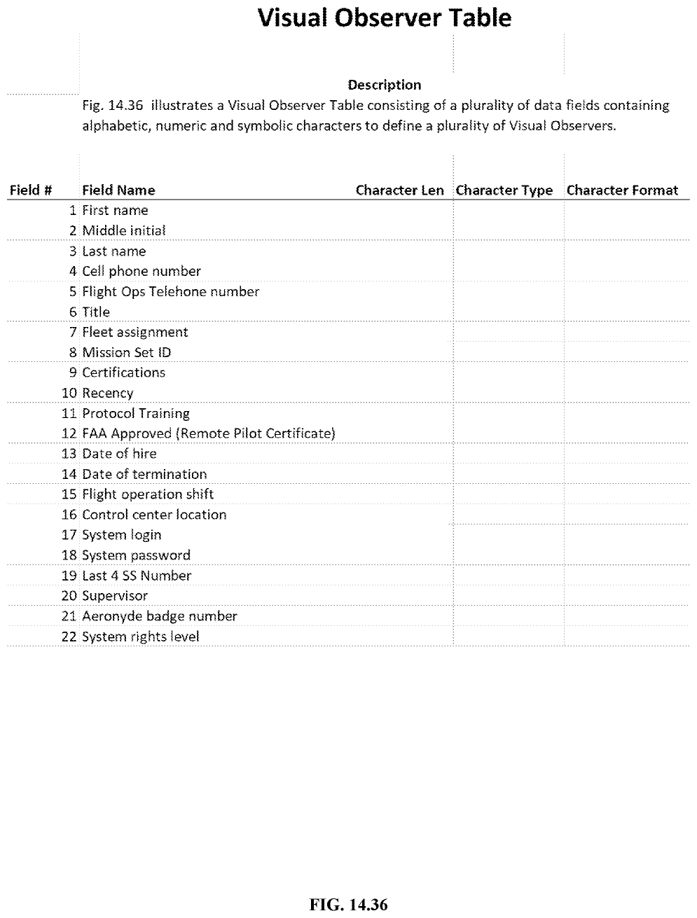

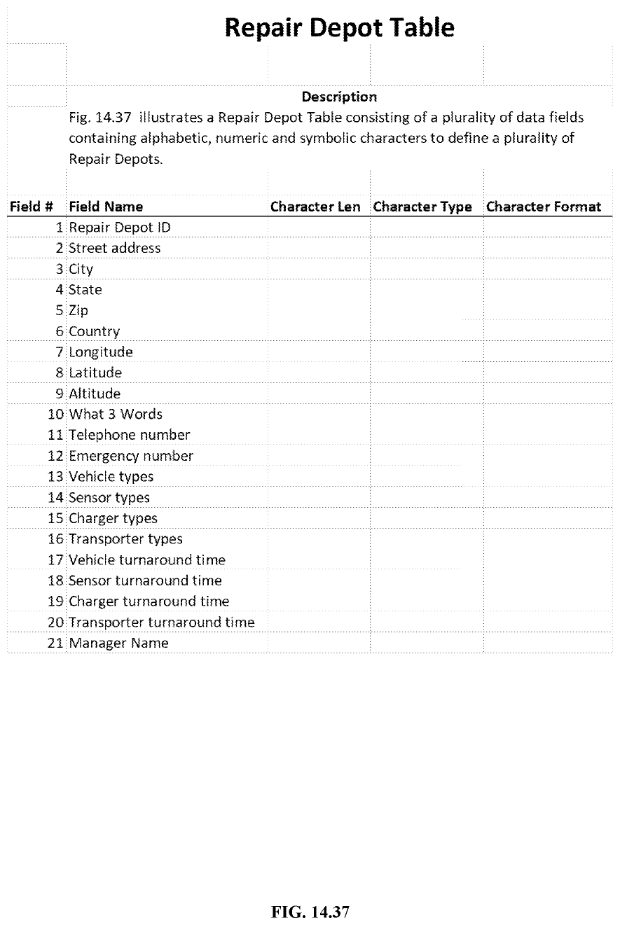

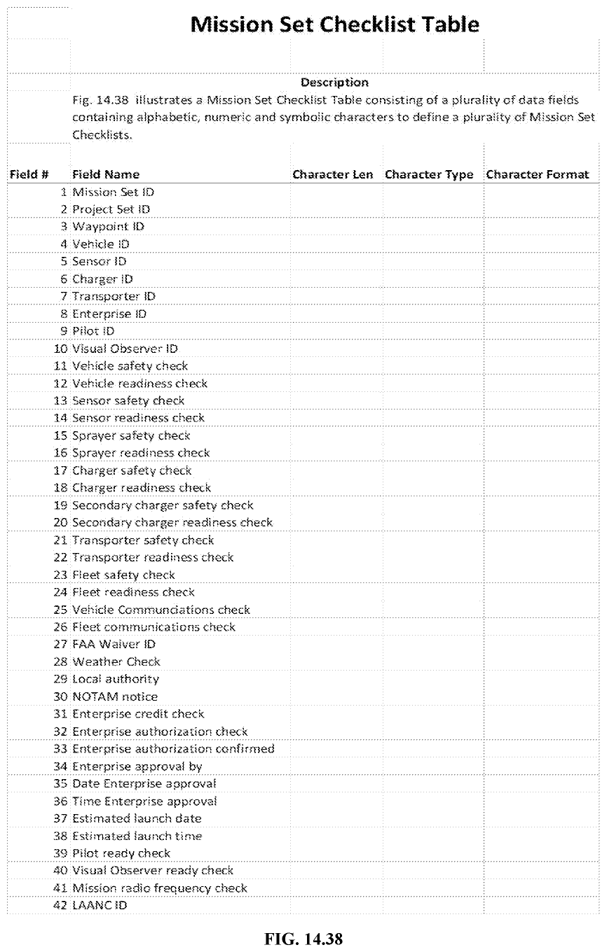

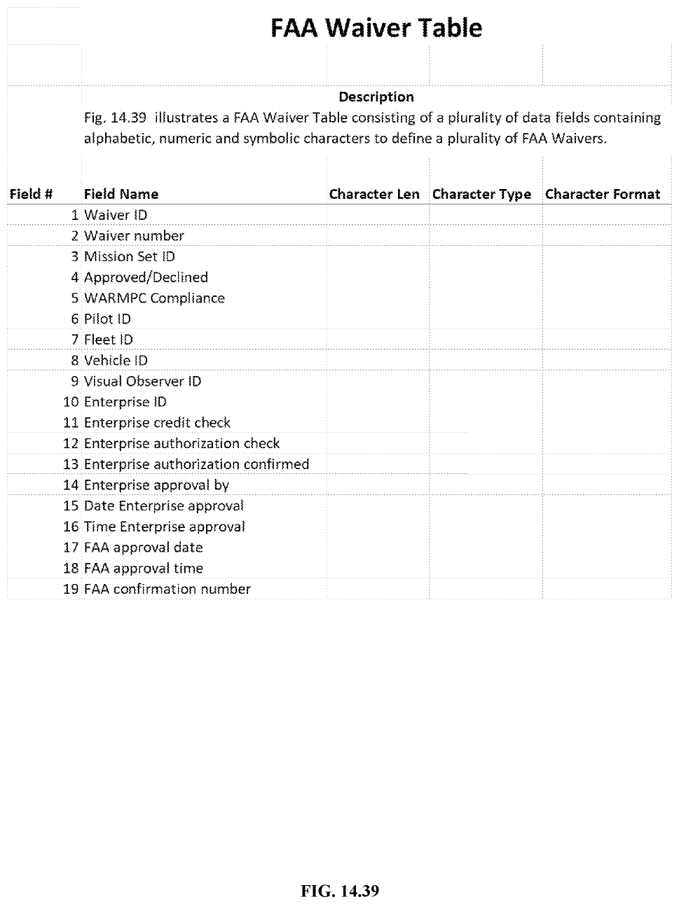

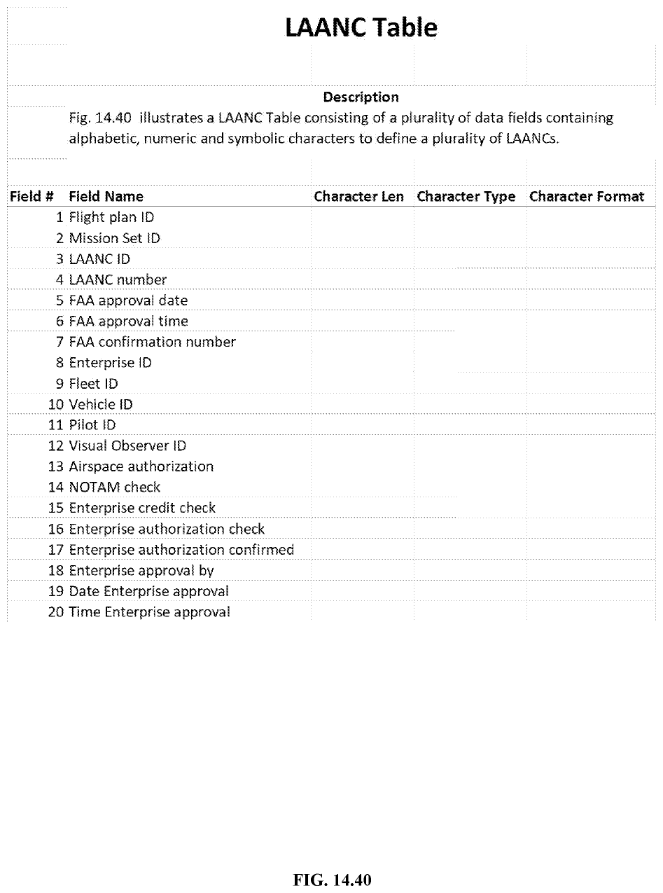

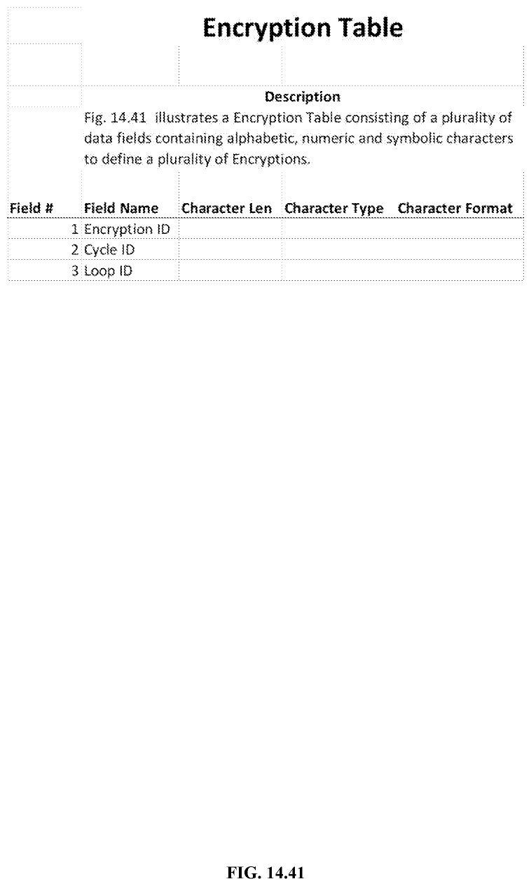

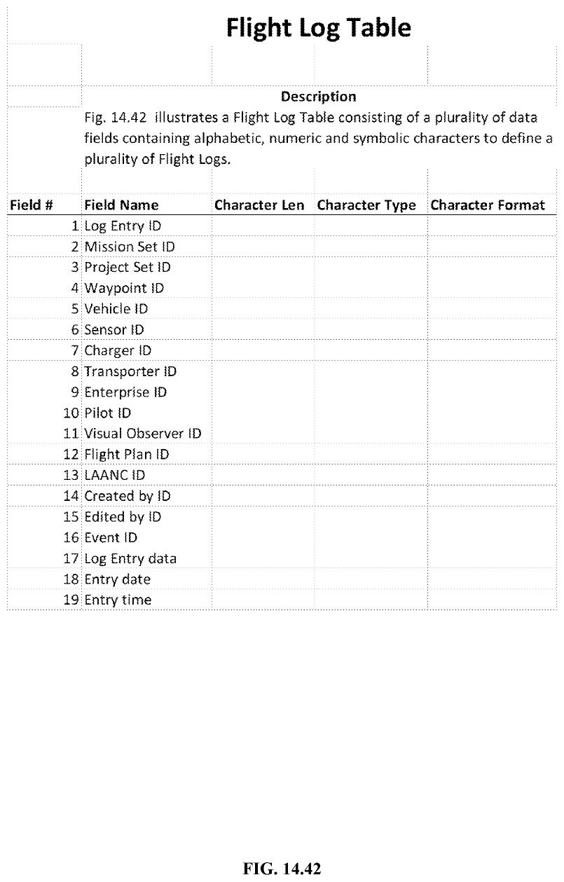

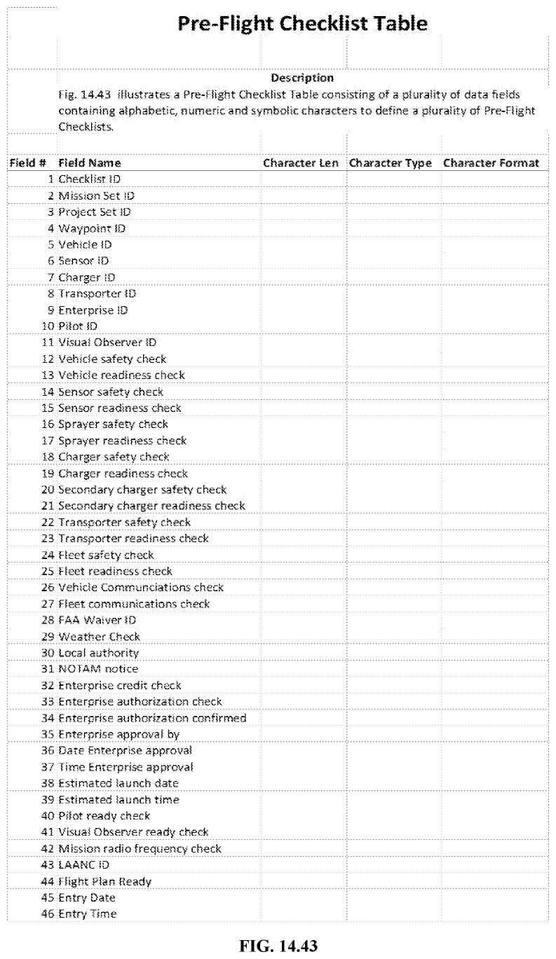

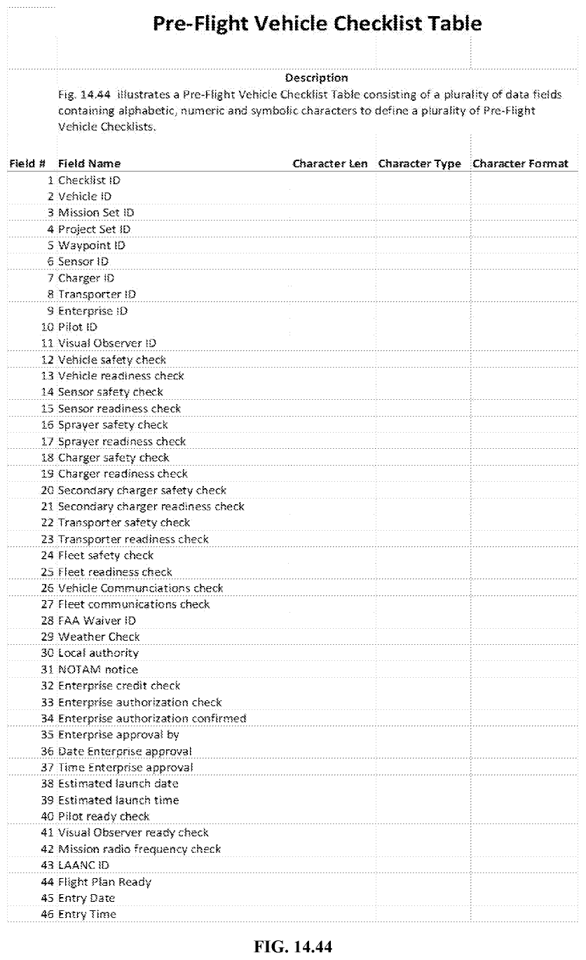

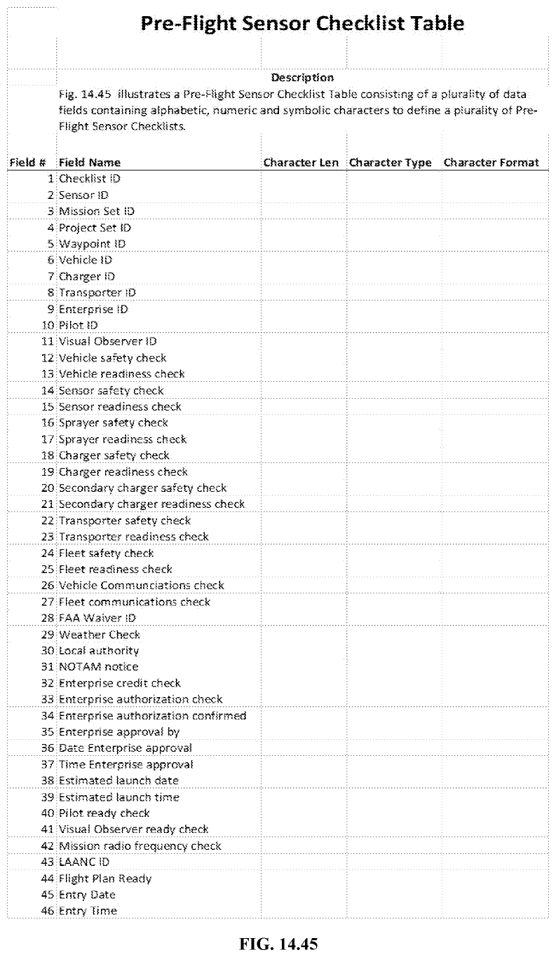

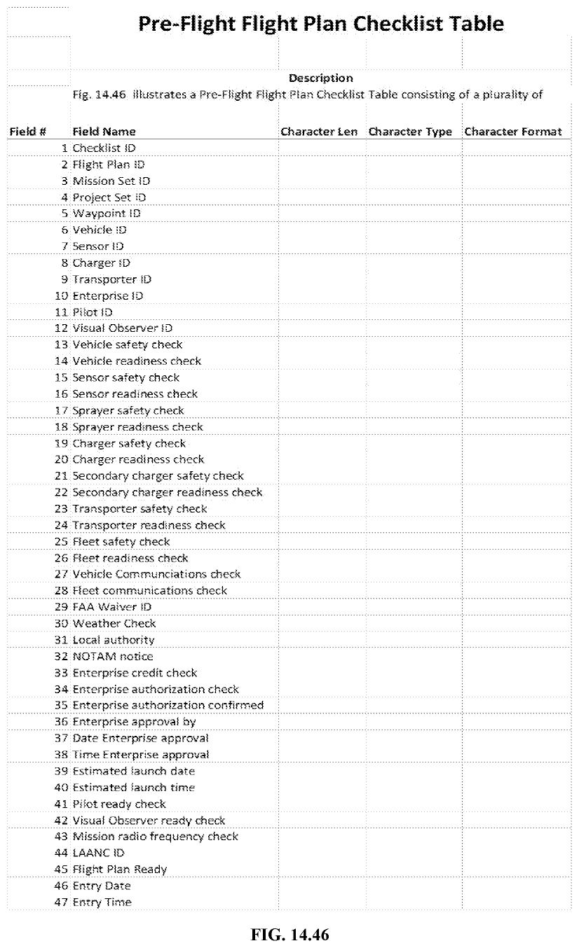

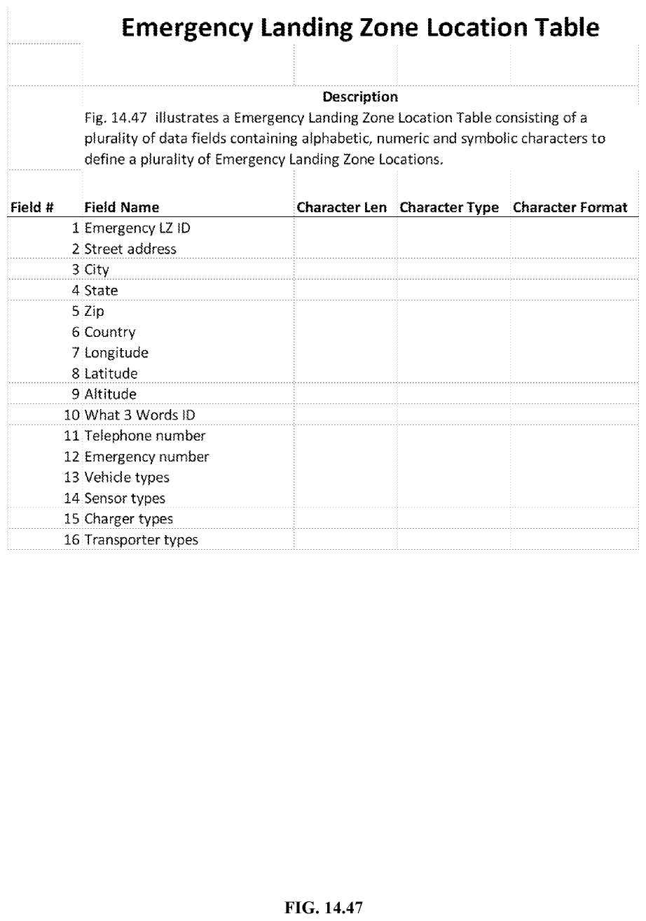

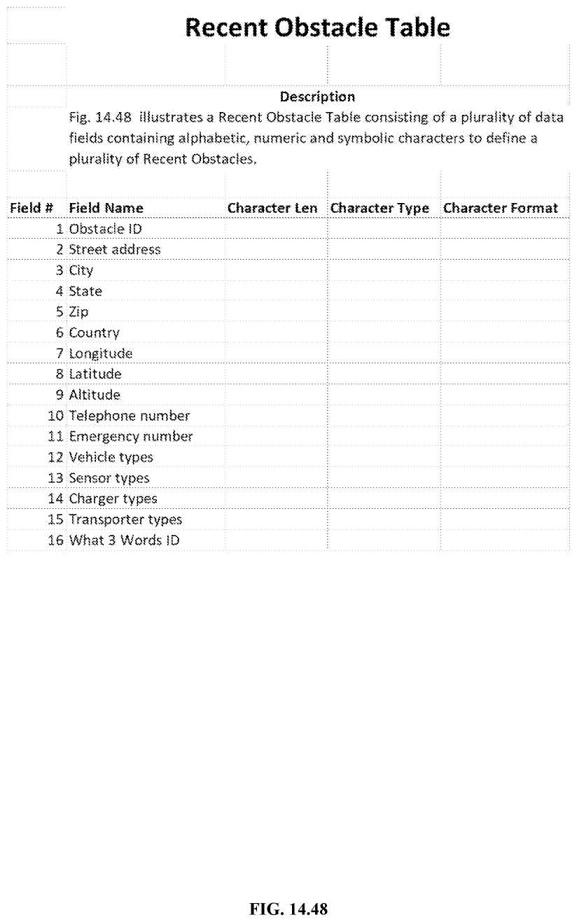

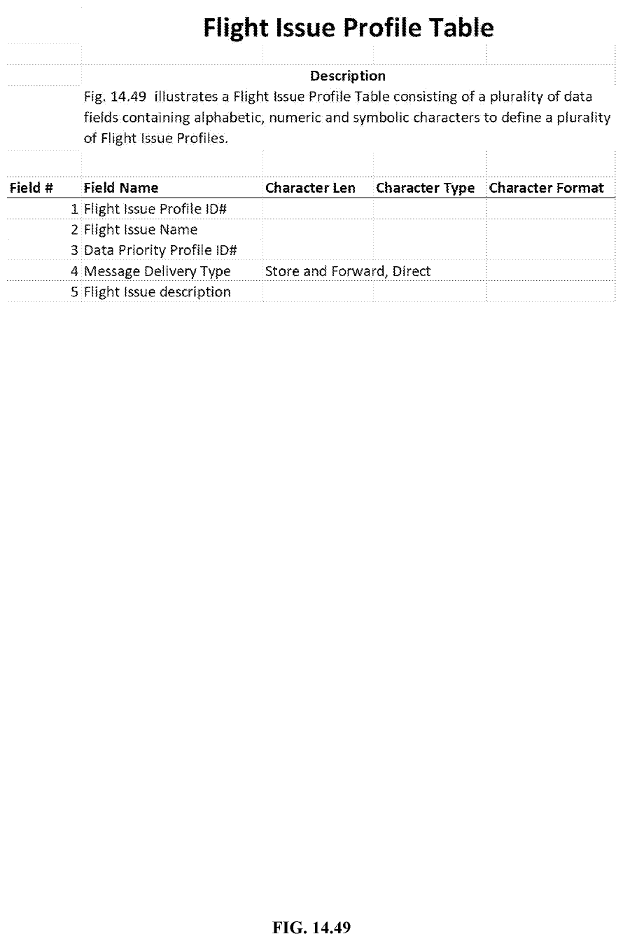

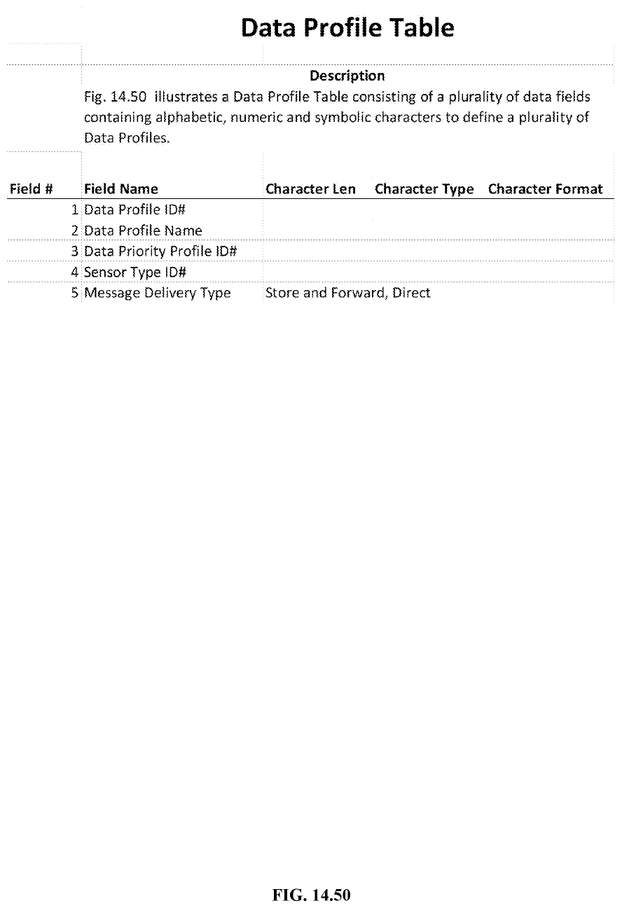

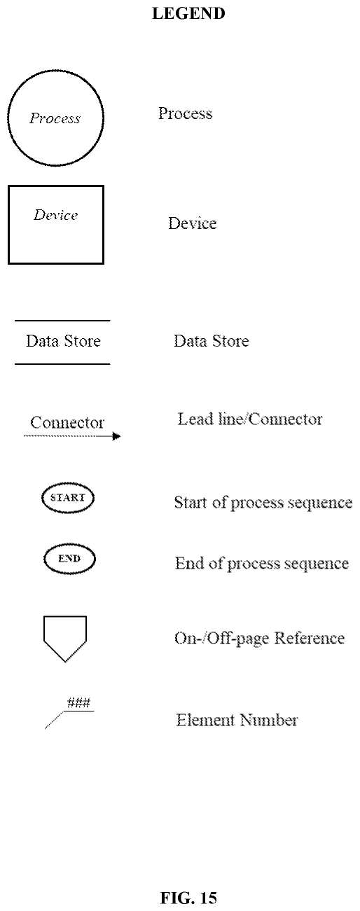

In FIG. 1, the process of the Vehicle Flight Management to Direct Vehicle Flight for the Next Priority Mission and the related processes of the present invention includes access to add data records, delete data records and edit data records in the following tables: FIG. 14.13, Geographic Area Table, FIG. 14.15, Mission Set Table, FIG. 14.24, Sensor Table, FIG. 14.25, Sensor Profile Table, FIG. 14.29, Vehicle Table, FIG. 14.30, Vehicle Profile Table, FIG. 14.35, Pilot Table, FIG. 14.36, Visual Observer Table, FIG. 14.39, FAA Waiver Table, FIG. 14.42, Flight Log Table, and FIG. 14.5, Charger Table. The process and the related processes described in FIG. 1 of the present invention includes the use of the following communication methods: FIG. 13.06, Sensor Data Snap, FIG. 13.08, Vehicle Data Snap, FIG. 13.44, Visual Observer Assigned to Vehicle Snap, FIG. 13.46, Mission Set Identification Snap, FIG. 13.49, Charger ID Snap, FIG. 13.50, Visual Observer ID Snap, FIG. 13.51, Pilot ID Snap, FIG. 13.55, Flight Log Snap, FIG. 13.58, FAA Waiver ID Snap, FIG. 13.61, Visual Observer Ready to Execute Mission Set Snap, FIG. 13.66, Geographic Area ID Snap, FIG. 13.77, FAA Waiver Data Snap and FIG. 13.79, Visual Operator Ready for Launch Snap.

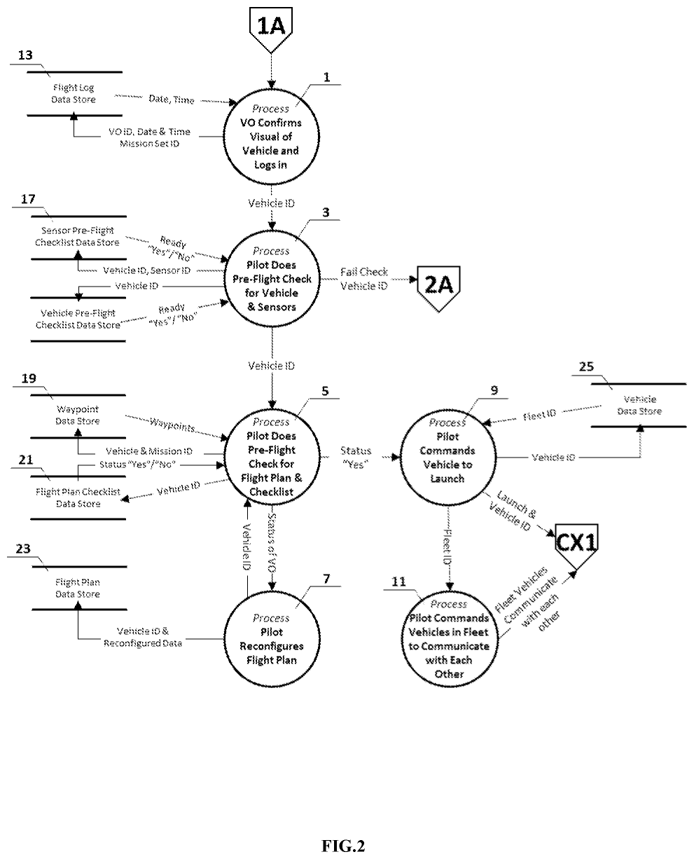

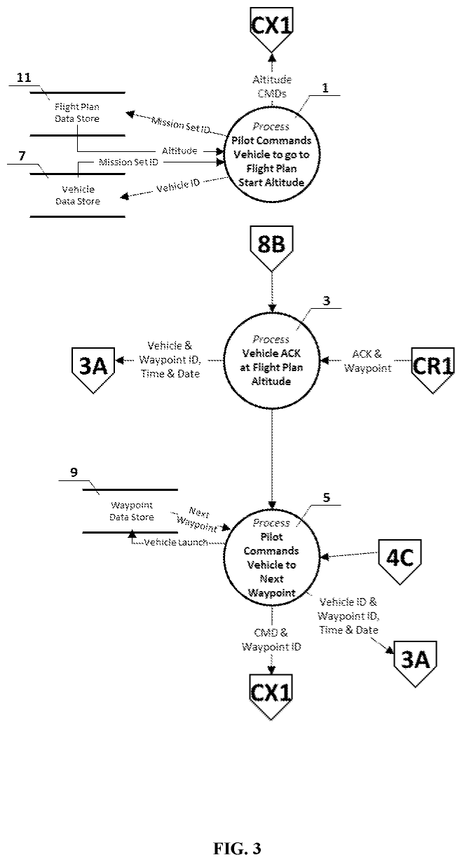

FIG. 2 illustrates an exemplary Vehicle Flight Management Process for Vehicle Pre-Flight Check and the related process of the present invention.

According to the process, VO Confirms Visual of Vehicle and Logs In, (2.1) the VO logs in after confirming visual sighting of the Vehicle. The process (2.1) interacts with an associated Flight Log Data Store (2.13) by providing the VO ID, Date & Time, and Mission Set ID; the Date and Time are then confirmed by the Data Store (2.13).

The process, Pilot Does Pre-Flight Check for Vehicle and Sensors, (2.3) is for the Pilot to perform a pre-flight check on the Vehicle and Sensors. The process (2.3) interacts with an associated Sensor Pre-Flight Checklist Data Store (2.17) by providing the Sensor ID and Vehicle ID, and a Ready Yes or No Message is then provided by the Data Store (2.17). The process (2.3) interacts with an associated Vehicle Pre-Flight Checklist Data Store (2.19) by providing the Vehicle ID, and the Data Store (2.19) then provides the Ready Yes or No Message.

According to the process, Pilot Does Pre-Flight Check for Flight Plan and Checklist, (2.5) pilot performs a pre-flight check on the flight plan and checklist. The process (2.5) interacts with an associated Waypoint Data Store (2.21) by providing the Waypoints and then the Vehicle and Mission ID are provided by the Data Store (2.21). The process (2.5) interacts with an associated Flight Plan Checklist Data Store (2.15) by providing the Vehicle ID, and the Data Store (2.15) then provides the Status, either Yes or No.

The process, Pilot Reconfigures Flight Plan, (2.7) allows the Pilot to reconfigure the Flight Plan. The process (2.7) interacts with an associated Flight Plan Table (2.23) by entering the Vehicle ID and the Reconfigured Flight Plan data.

The process, Pilot Commands Vehicle to Launch, (2.9) allows the Pilot to command vehicle Launch. The process (2.9) interacts with an associated Vehicle Data Store (2.25) by providing the Vehicle ID, and the Data Store (2.25) then provides the Fleet ID.

The process, Pilot Commands Vehicles in Fleet to Communicate with Each Other, (2.11) allows the Pilot to command Vehicles in the Fleet to communicate.

FIG. 2, the process of the Vehicle Flight Management for Vehicle Pre-Flight Check and the related processes of the present invention include access to add data records, delete data records and edit data records in the following tables: FIG. 14.12, Flight Plan Table, FIG. 14.29, Vehicle Table, FIG. 14.31, Waypoint Table, FIG. 14.42, Flight Log Table, FIG. 14.44, Pre-Flight Vehicle Checklist Table, FIG. 14.45, Pre-Flight Sensor Checklist Table, and FIG. 14.46, Pre-Flight Flight Plan Checklist Table. The process and the related processes described in FIG. 2 of the present invention includes the use of the following communication methods: FIG. 13.06, Sensor Data Snap, FIG. 13.08, Vehicle Data Snap, FIG. 13.12, Vehicle ID to Management Center Snap, FIG. 13.18, Flight Plan Approved Snap, FIG. 13.55, Flight Log Snap, FIG. 13.64, Fleet ID Snap, FIG. 13.75, Flight Plan Checklist ID Snap, FIG. 13.78, Waypoint Data Span, FIG. 13.82, Reconfigured Flight Plan Data Snap, FIG. 13.83, Status Snap, and FIG. 13.95, Launch Snap.

FIG. 3 illustrates an exemplary Vehicle Flight Management process to Direct A Vehicle to the Next Waypoint and the related processes of the present invention.

The process, Pilot Commands Vehicle to go to Flight Plan Start Altitude, (3.1) allows the Pilot to command the Vehicle to the starting altitude of the Flight Plan. The process (3.1) interacts with an associated Flight Plan Altitude Data Store (3.11) by providing the Mission ID and then the Altitude is provided by the Data Store (3.11). The process (3.1) interacts with an associated Vehicle Data Store (3.7) by providing the Vehicle ID and the Data Store (3.7) then provides the Mission Set ID.

The process, Vehicle Acknowledge Flight Plan Altitude, (3.3) allows the Vehicle to acknowledge that it has reached the Flight Plan altitude.

The process, Pilot Commands Vehicle to Next Waypoint, (3.5) allows the pilot to command the Vehicle to the next Waypoint in the Flight Plan. The process (3.5) interacts with an associated Waypoint Data Store (3.9) by providing the Vehicle Launch message, and then the Next Waypoint is provided by the Data Store (3.9).

The FIG. 3 process of the Vehicle Flight Management to Direct Vehicle to the Next Waypoint and the related processes of the present invention includes access to add data records, delete data records and edit data records in the following tables: FIG. 14.12, Flight Plan Table, FIG. 14.29, Vehicle Table, and FIG. 14.31, Waypoint Table. The process and the related processes described in FIG. 3 of the present invention includes the use of the following communication methods: FIG. 13.02, Autonomous Aerial Communications Coupler Snap, FIG. 13.12, Vehicle ID to Management Center Snap, FIG. 13.46, Mission Set Identification Snap, FIG. 13.78, Waypoint Data Span, FIG. 13.80, Mission Set Altitude Snap and FIG. 13.81, Next Waypoint Snap.

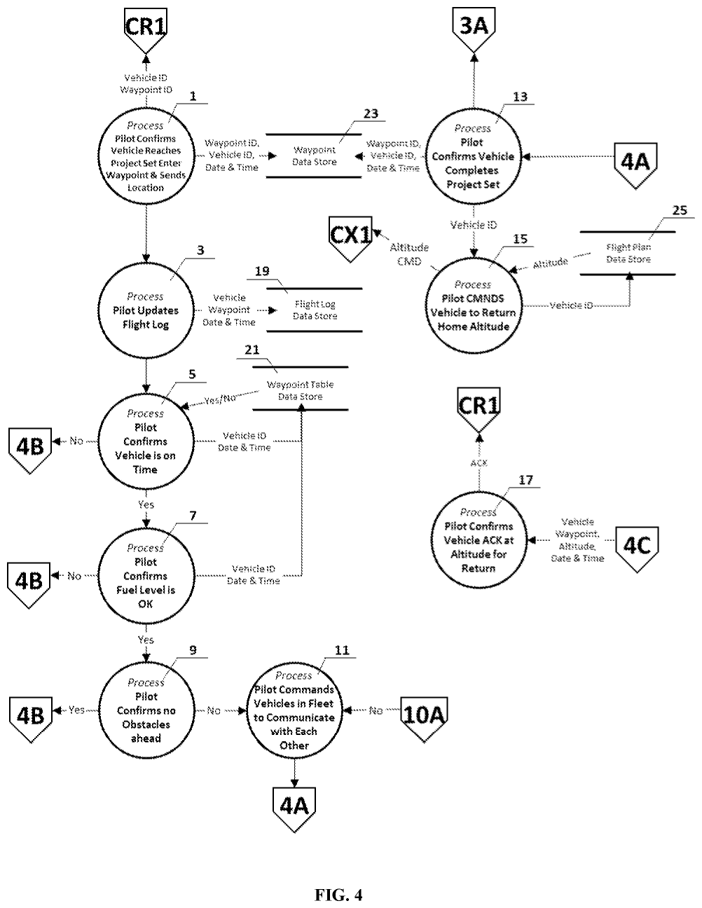

FIG. 4 illustrates an exemplary Vehicle Flight Management process to Operate and Control a Vehicle in Flight and the related processes of the present invention.

The process, Pilot Confirms Vehicle Reaches Project Set Enter Waypoint and Sends Location, (4.1) allows the pilot to confirm the Vehicle has reached the Project Set Enter Waypoint and Send the Vehicle location. The process (4.1) interacts with an associated Waypoint Data Store (4.23) by entering the Waypoint ID, Vehicle ID, and Date and Time.

The process, Pilot Updates Flight Log, (4.3) allows the pilot to update the Flight Log. The process (4.3), interacts with an associated Flight Log Data Store (4.19) by entering the Vehicle Waypoint and Date and Time.

The process, Pilot Confirms Vehicle is on Time, (4.5) is used for the pilot to confirm that the vehicle is on time. The process (4.5) interacts with an associated Waypoint Table Data Store (4.21) by providing the Vehicle ID and Date and Time, and a Yes or No confirmation message is then provided by the Data Store (4.21).

The process, Pilot Confirms Fuel Level OK, (4.7) is for the pilot to confirm that the Vehicle fuel level is OK if the Waypoint Table Data Store (4.21) provided the previous process (4.5) with a Yes message. The process (4.7) interacts with an associated Waypoint Table Data Store (4.21) by entering the Vehicle ID, Date, and Time.

The process, Pilot Confirms No Obstacles Ahead, (4.9) allows the pilot to confirm that there are no obstacles ahead in the Vehicle's flight path.

The process, Pilot Commands Vehicle to Travel to Next Waypoint, (4.11) allows the Pilot to command the Vehicle to travel to the next waypoint in the mission.

The process, Pilot Confirms Vehicle Completes Project Set, (4.13) is for the Pilot to confirm that the Vehicle has completed the Project Set. The process (4.13) interacts with an associated Waypoint Data Store (4.23) by entering the Waypoint ID, Vehicle ID, Date, and Time.

The process, Pilot Commands Vehicle to return to Home Altitude, (4.15) is for the Pilot to command the Vehicle to return to its home altitude. The process (4.15) interacts with an associated Flight Plan Data Store (4.25) by providing the Vehicle ID and the Home Altitude is then provided by the Data Store (4.25).

The process, Pilot Confirms Vehicle Acknowledge at Altitude for Return, (4.17) allows the Pilot to confirm a Vehicle acknowledgement at altitude for return.

FIG. 4, the process of the Vehicle Flight Management to Operate and Control Vehicle in Flight and the related processes of the present invention include access to add data records, delete data records and edit data records in the following tables: FIG. 14.12, Flight Plan Table, FIG. 14.31, Waypoint Table and FIG. 14.42, Flight Log Table. The process and the related processes described in FIG. 4 of the present invention include the use of the following communication methods: FIG. 13.12, Vehicle ID to Management Center Snap, FIG. 13.78, Waypoint Data Span, FIG. 13.80, Mission Set Altitude Snap, and FIG. 13.84, Date and Time Snap.

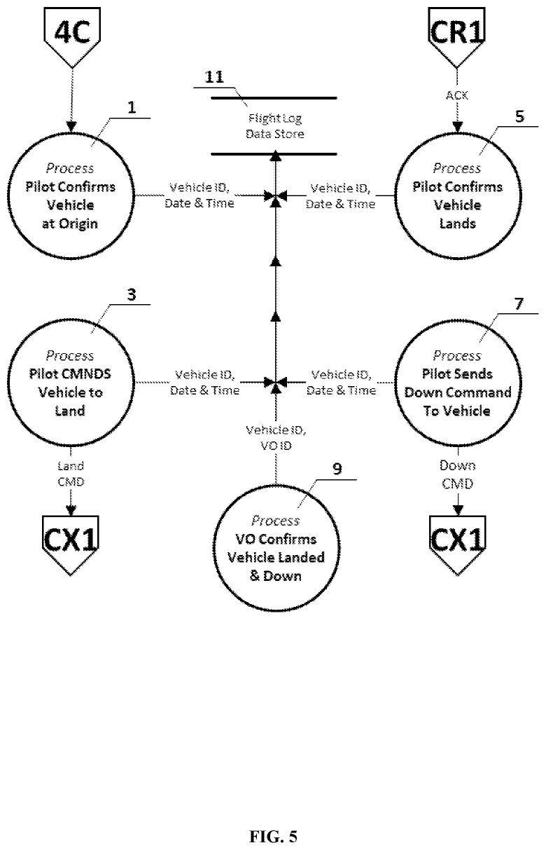

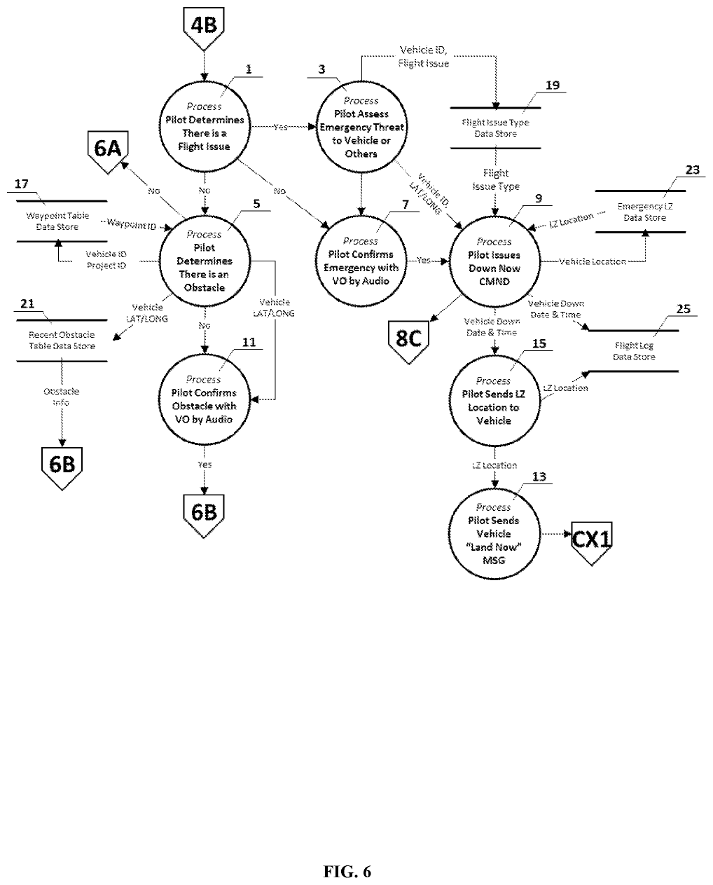

FIG. 5 illustrates an exemplary Vehicle Flight Management to Operate Vehicle to Return and the related processes of the present invention.

The process, Pilot Confirms Vehicle at Origin, (5.1) is for the Pilot to confirm the Vehicle is at origin. The process (5.1) interacts with an associated Flight Log Data Store (5.11) by entering the Vehicle ID, Date, and Time.

In the process Pilot Commands Vehicle to Land, (5.3) the Pilot commands Vehicle to land. The process (5.3) interacts with an associated Flight Log Data Store (5.11) by entering the Vehicle ID, Date, and Time.

The process Pilot Confirms Vehicle Lands, (5.5) allows the Pilot to confirm the Vehicle has landed. The process (5.5) interacts with an associated Flight Log Data Store (5.11) by entering the Vehicle ID, Date, and Time.

The process, Pilot Sends “Down” Command to Vehicle, (5.7) allows the Pilot to send Down Command to Vehicle. The process (5.1) interacts with an associated Flight Log Data Store (5.11) by entering the Vehicle ID, Date, and Time.

The process, VO Confirms Vehicle Landed and Down, (5.9) for the VO to confirm the Vehicle has landed and is down. The process (5.9) interacts with an associated Flight Log Data Store (5.11) by entering the Vehicle ID and VO ID.

FIG. 5, the process of the Vehicle Flight Management to Operate Vehicle to Return and the related processes of the present invention include access to add data records, delete data records and edit data records in the FIG. 14.42, Flight Log Table. The process and the related processes described in FIG. 5 of the present invention includes the use of the following communication methods: FIG. 13.12, Vehicle ID to Management Center Snap, FIG. 13.78, Waypoint Data Span, FIG. 13.80, Mission Set Altitude Snap, and FIG. 13.84, Date and Time Snap.

FIG. 6 illustrates an exemplary Vehicle Flight Management to Operate a Vehicle in an Emergency and for Obstacle Avoidance and the related processes of the present invention.

In the process, Pilot Determines There is a Flight Issue, (6.1), the Pilot determines there is a flight issue.

In the process, Pilot Determines There is an Obstacle, (6.5) the Pilot determines there is an obstacle in the flight path. The process (6.5) interacts with an associated Waypoint Table Data Store (6.17) by providing the Vehicle ID and Project ID and the Waypoint ID is then provided by the Data Store (6.17). The process, 6.5, interacts with an associated Recent Obstacle Table Data Store (6.21) by entering the Vehicle latitude and longitude (LAT/LONG).

In the process, Pilot Confirms Obstacle with VO by Audio, (6.11) the Pilot confirms an obstacle with the VO via an audio exchange.

The process, Pilot Assess Emergency Threat to Vehicle or Other, (6.3) allows the Pilot to assess an emergency threat to the Vehicle or to others. The process (6.3) interacts with an associated Flight Issue Type Data Store (6.19) by entering the Vehicle ID, and Flight Issue.

In the process, Pilot Confirms Emergency with VO by Audio, (6.7) the Pilot confirms an emergency with the VO via audio exchange.

The process, Pilot Issues Down Now Command, (6.9) the Pilot issues the Down Now Command. The process (6.9) interacts with an associated Flight Issue Type Data Store (6.19) by receiving the Flight Issue Type from the Data Store (6.19). The process (6.9) also interacts with an associated Emergency Landing Zone (LZ) Data Store (6.23) by providing the Vehicle Location, and the Data Store (6.23) then provides the LZ. The process, 6.9, interacts with an associated Flight Log Data Store (6.25) by entering the Vehicle Down Date and Time.

The process, Pilot Sends LZ Location to Vehicle, (6.15) the Pilot sends the LZ location to the Vehicle. The process (6.15) interacts with an associated Flight Log Data Store (6.25) by entering the LZ location. In the process, Pilot Sends Vehicle “Land Now” message, (6.13) the Pilot sends the “Land Now” message to the Vehicle.

FIG. 6, the process of the Vehicle Flight Management to Operate Vehicle in Emergency and for Obstacle Avoidance and the related processes of the present invention, include access to add data records, delete data records and edit data records in the following tables: FIG. 14.31, Waypoint Table, FIG. 14.42, Flight Log Table, FIG. 14.47, Emergency Landing Zone Location Table, FIG. 14.48, Recent Obstacle Table and FIG. 14.49, Flight Issue Profile Table. The process and the related processes described in FIG. 6 of the present invention includes the use of the following communication methods: FIG. 13.12, Vehicle ID to Management Center Snap, FIG. 13.78, Waypoint Data Span, FIG. 13.86, Project Set ID Snap, FIG. 13.87, Vehicle Location Snap, FIG. 13.88, Emergency Landing Data Snap, FIG. 13.89, Obstacle Data Snap, FIG. 13.90, Stop Command Snap, FIG. 13.91, Flight Issue Snap, and FIG. 13.95, Launch Snap.

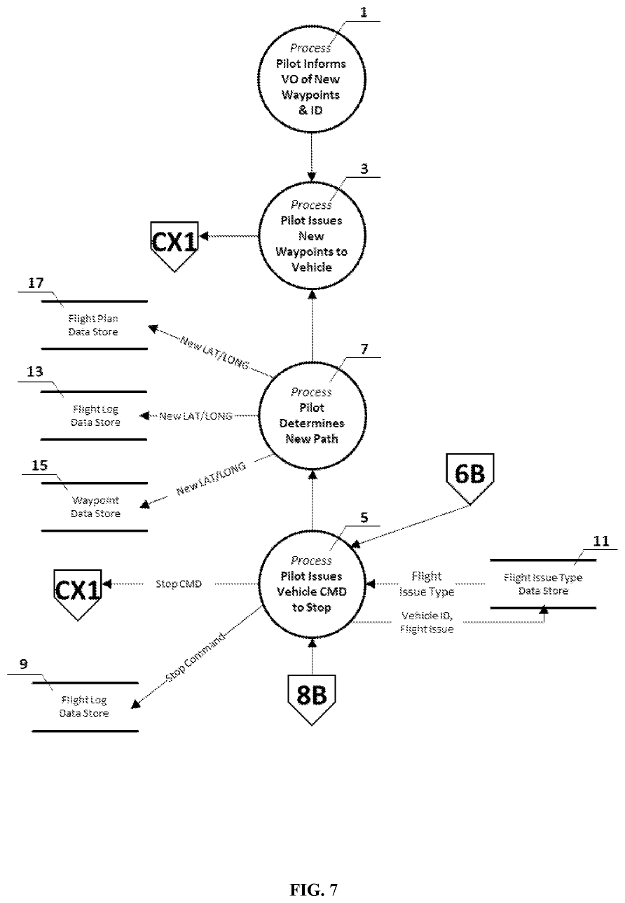

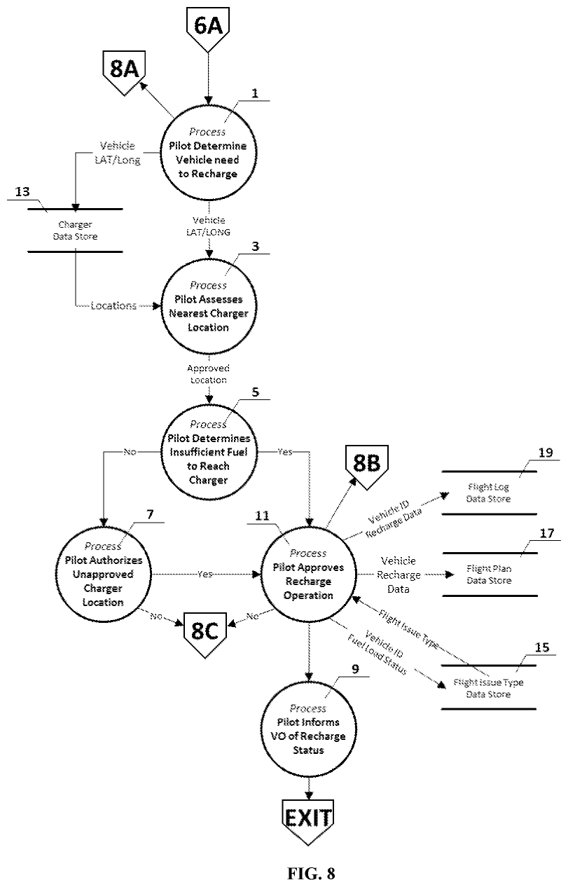

FIG. 7 illustrates an exemplary Vehicle Flight Management process to Create New Waypoints for Vehicle and the related processes of the present invention.

According to the process, Pilot Informs VO of New Waypoints and ID, (7.1) the Pilot informs the VO of new Waypoints for the Vehicle and the Waypoint ID.

In the process, Pilot Issues New Waypoints to Vehicle, (7.3) the Pilot issues the new Waypoints to the Vehicle.

In the process, Pilot Determines New Path, (7.7) the Pilot determines the new path for the Vehicle with the new Waypoints. The process (7.7) interacts with an associated Flight Plan Data Store (7.17) by entering the New LAT/LONG. The process (7.7) interacts with an associated Flight Log Data Store (7.13) by entering the New LAT/LONG. The process (7.7) interacts with an associated Waypoint Data Store (7.15) by entering the New LAT/LONG.

In the process, Pilot Issues Vehicle Command to Stop, (7.5) the Pilot issues a Stop Command to the Vehicle. The process (7.5) interacts with an associated Flight Issue Type Data Store (7.11) by providing the Vehicle ID and Flight Issue, and the Flight Issue Type is then provided by the Data Store (7.11). The process, 7.5, interacts with an associated Flight Log Data Store (6.9) by entering the Stop Command.

FIG. 7, the process of the Vehicle Flight Management to Create New Waypoints for Vehicle and the related processes of the present invention include access to add data records, delete data records and edit data records in the following tables: FIG. 14.12, Flight Plan Table, FIG. 14.31, Waypoint Table, FIG. 14.42, Flight Log Table and FIG. 14.48, Recent Obstacle Table. The process and the related processes described in FIG. 7 of the present invention includes the use of the following communication methods: FIG. 13.91, Flight Issue Snap, FIG. 13.90, Stop Command Snap, FIG. 13.87, Vehicle Location Snap and FIG. 13.12, Vehicle ID to Management Center Snap.

FIG. 8 illustrates an exemplary Vehicle Flight Management to Operate a Vehicle to Recharge and the related processes of the present invention.

In the process, Pilot Determine Vehicle Need to Recharge, (8.1) the Pilot determines that a Vehicle needs to Recharge. The process (8.1) interacts with an associated Charger Location Data Store (8.13) by entering the Vehicle LAT/LONG.

The process, Pilot Assesses Nearest Charger Location, (8.3) allows the Pilot to Assess the nearest Charger location for the Vehicle. The process (8.3) interacts with an associated Charger Location Data Store (8.13) by receiving the Charger Locations.

In the process, Pilot Determines Insufficient Fuel to Reach Charger, (8.5) the Pilot determines that the Vehicle has insufficient fuel to reach the charger.

In the process, Pilot Authorizes Unapproved Charger Location, (8.7) the Pilot authorizes use of an unapproved charger location.

According to the process, Pilot Approves Recharge Operation, (8.11) the Pilot approves a recharge operation. The process (8.11) interacts with an associated Flight Log Data Store (8.19) by entering the Vehicle ID and Recharge Data. The process (8.11) also interacts with an associated Flight Plan Data Store (8.17) by entering Vehicle ID and Recharge Data. Finally, the process (8.11) interacts with an associated Flight Issue Type Data Store (8.15) by providing the Vehicle ID and Fuel Low Status and the Data tore (8.15) provides the Flight Issue Type.

In the process, Pilot Informs VO of Recharge Status, (8.9) the Piot informs the VO of the Vehicle Recharge status.

FIG. 8, the process of the Vehicle Flight Management to Operate Vehicle to Recharge and the related processes of the present invention include access to add data records, delete data records and edit data records in the following tables: FIG. 14.12, Flight Plan Table, FIG. 14.41, Encryption Table, FIG. 14.49, Flight Issue Profile Table and FIG. 14.5, Charger Table. The process and the related processes described in FIG. 8 of the present invention includes the use of the following communication methods: FIG. 13.12, Vehicle ID to Management Center Snap, FIG. 13.87, Vehicle Location Snap, FIG. 13.91, Flight Issue Snap, FIG. 13.92, Charger Location Snap, FIG. 13.93, Vehicle Recharge Command Snap, and FIG. 13.94, Vehicle Fuel Level Snap.

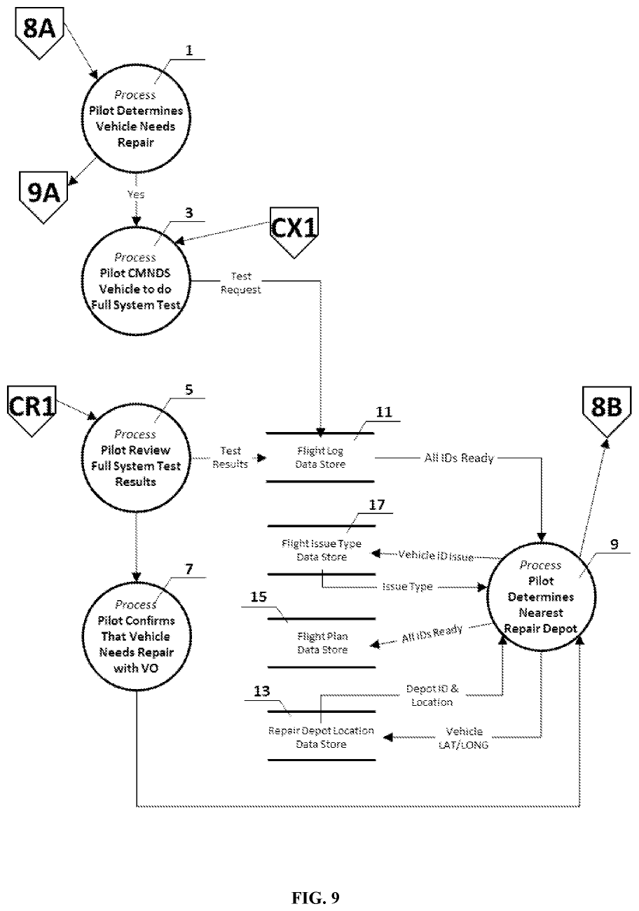

FIG. 9 illustrates an exemplary Vehicle Flight Management to Operate Vehicle to Repair and the related processes of the present invention.

In the process, Pilot Determines Vehicle Needs Repair, (9.1) the Pilot determines that a Vehicle needs repair.

In the process, Pilot Commands Vehicle to Perform a Full System Test, (9.3) the Pilot commands a Vehicle to perform a Full System Test. The process (9.3) interacts with an associated Flight Log Data Store (9.11) by entering the Test Request.

In the process, Pilot Review Full System Test Results, (9.5) the Pilot reviews the Full System Test results. The process (9.5) interacts with an associated Flight Log Data Store (9.11) by entering the Test Results.

In the process, Pilot Confirms that Vehicle Needs Repair with VO, (9.7) the Pilot confirms with the VO that the Vehicle needs repair.

In the process, Pilot Determines Nearest Repair Depot, (9.9) the pilot determines the nearest Repair Depot for the Vehicle. The process (9.9) interacts with an associated Flight Log Data Store (9.11) by receiving an All ID's Ready message. The process (9.9) interacts with an associated Flight Issue Type Data Store (9.17) by providing the Vehicle ID and Issue and the Data Store (9.17) then provides the Issue Type. The process (9.9) also interacts with an associated Flight Plan Data Store (9.15) by entering the All ID's Ready message. The process (9.9) interacts with an associated Repair Depot Location Data Store (9.13) by providing the Vehicle LAT/LONG and the Depot ID, and Location are then provided by the Data Store (9.13).

FIG. 9, the process of the Vehicle Flight Management to Operate a Vehicle to Repair and the related processes of the present invention include access to add data records, delete data records and edit data records in the following tables: FIG. 14.12, Flight Plan Table, FIG. 14.37, Repair Depot Table, FIG. 14.42, Flight Log Table and FIG. 14.49, Flight Issue Profile Table. The process and the related processes described in FIG. 9 of the present invention includes the use of the following communication methods: FIG. 13.12, Vehicle ID to Management Center Snap, FIG. 13.20, Vehicle Full System Test Request Snap, FIG. 13.65, Repair Depot ID Snap, FIG. 13.87, Vehicle Location Snap, FIG. 13.91, Flight Issue Snap, and FIG. 13.92, Charger Location Snap.

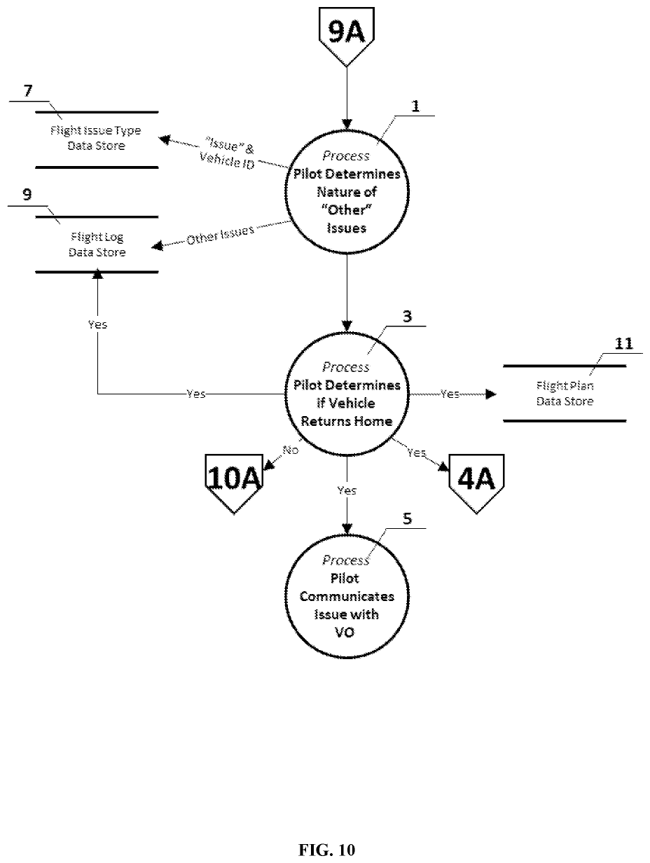

FIG. 10 illustrates an exemplary Vehicle Flight Management to Operate a Vehicle with “Other” Flight Issues and the related processes of the present invention.

The process, Pilot Determines Nature of “Other” Issues, (10.1) allows the Pilot to determine the nature of “other” issues. The process (10.1) interacts with an associated Flight Issue Type Data Store (10.7) by entering the “Issue” and Vehicle ID. The process (10.1) also interacts with an associated Flight Log Data Store (10.9) by entering the “Other” Issue message.

The process Pilot Determines if Vehicle Returns Home, (10.3) is for the Pilot to determine if the Vehicle returns home. The process (10.3) interacts with an associated Flight Log Data Store (10.9) by entering the message that the Vehicle has returned home. The process (10.3) interacts with an associated Flight Plan Data Store (10.11) by entering the message that the Vehicle Returns Home.

In the process, Pilot Communicates Issue with VO, (10.5) the Pilot confirms an issue with the VO.

FIG. 10, depicting the process of the Vehicle Flight Management to Operate a Vehicle with “Other” Flight Issues and the related processes of the present invention include access to add data records, delete data records and edit data records in the following tables: FIG. 14.12, Flight Plan Table, FIG. 14.42, Flight Log Table, and FIG. 14.49, Flight Issue Profile Table. The process and the related processes described in FIG. 10 of the present invention includes the use of the following communication methods: FIG. 13.12, Vehicle ID to Management Center Snap, FIG. 13.76, Flight Plan Checklist Data Snap, FIG. 13.91, Flight Issue Snap, and FIG. 13.96, Return to Origin Snap.

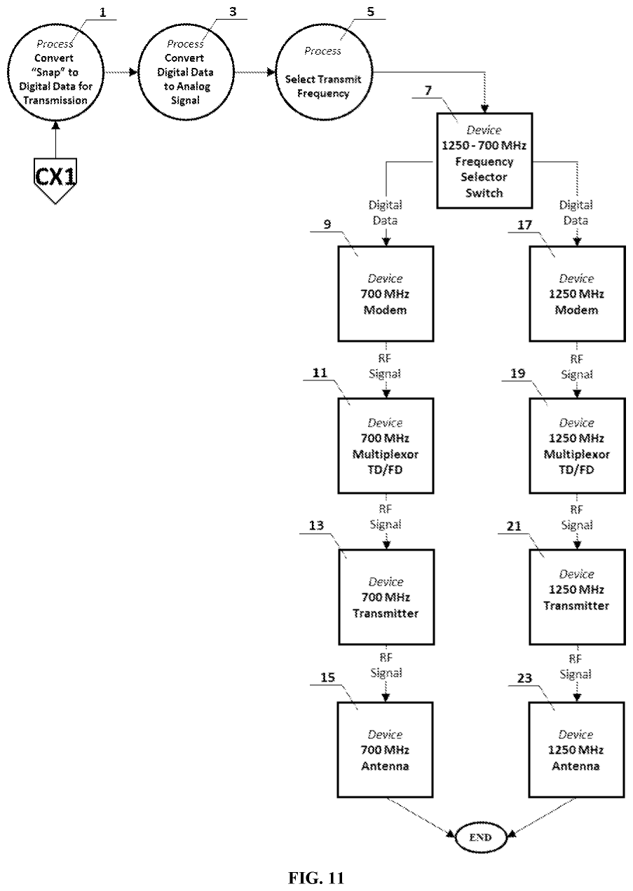

FIG. 11 illustrates an exemplary Vehicle Flight Management for Transmitting Radio Signals System and the related processes of the present invention. The process, Convert “Snap” to Digital Data for Transmission, (11.1) converts “Snap” to digital data for transmission. The process, Convert Digital Data to Analog Signal, (11.3) converts digital data to an analog signal. The process, Select Transmit Frequency, (11.5) selects a transmit frequency. The device (11.7) is a 1250-700 MHz Frequency Selector Switch. The device (11.9) is a 700 MHz Modem. The device (11.11) is a 700 MHz time division and frequency division Multiplexor. The device (11.13) is a 700 MHz Radio Transmitter. The device (11.15) is a 700 MHz Radio Antenna. The device (11.17) is a 1250 MHz Modem. The device (11.19) is a 1250 MHz time division and frequency Multiplexor. The device (11.21) is a 1250 MHz Radio Transmitter. The device (11.23) is a 1250 MHz Radio Antenna. y

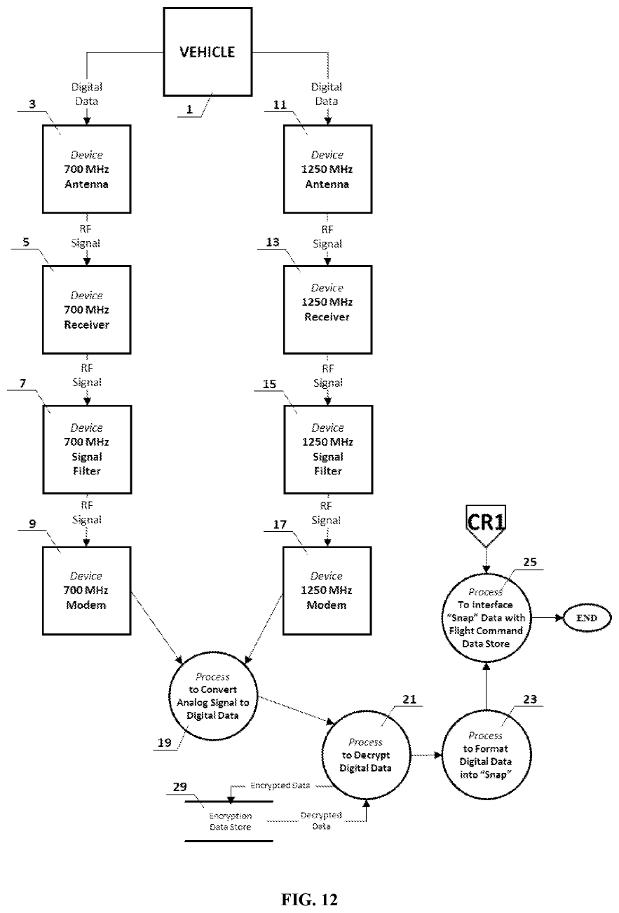

FIG. 12 illustrates an exemplary Vehicle Flight Management for Receiving Radio Signals System and the related processes of the present invention. The device (12.1) is a Vehicle. The device (12.3) is a 700 MHz Radio Antenna. The device (12.5) is a 700 MHz Radio Receiver. The device (12.7) is a 700 MHz Signal Filter. The device (12.9) is a 700 MHz Modem. The device (12.11) is a 1250 MHz Radio Antenna. The device (12.13) is a 1250 MHz Radio Receiver. The device (12.15) is a 1250 MHz Signal Filter. The device (12.17) is a 1250 MHz Modem. The process, Convert Analog Signal to Digital Data, (12.19) to converts analog signals to digital data. The process, Decrypt Digital Data, (12.21) decrypts digital data. The process (12.21) interacts with an associated Encryption Data Store (12.29) by providing the Encrypted Data and the Decrypted Data is then provided by the Data Store (12.29). The process, Format Digital Data into “Snap”, (12.23) formats digital data into a “Snap”. The process, Interface “Snap” Data with Flight Command Data Store, (12.25) interfaces the “Snap” Data with the Flight Command Data Store.

FIG. 12 depicts the process of the Management Control Center for Receiving Radio Signals System and the related processes of the present invention include access to add data records, delete data records and edit data records in FIG. 14.41, Encryption Table. The process and the related processes described in FIG. 12 of the present invention includes the use of the following communication methods: FIG. 13.97, Encrypted Data Snap, and FIG. 13.98, Decrypted Data Snap.

This disclosure is not intended to limit the invention to the described Vehicles, devices, and processes as is more fully described herein. As should be recognized by those skilled in the art, other claims and processes may be integrated and managed using similar methods and are intended to be included within the scope of this disclosure. Furthermore, while this invention has been described in conjunction with the exemplary embodiments outlined above, various alternatives, modifications, variations, improvements, and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later-developed alternatives, modifications, variations, improvements, and/or substantial equivalents.

What is claimed is:

1. A method for directing a flight and operation of Vehicles to a Vehicle's next priority Mission Set by a centralized Vehicle Flight Management, comprising:
determining a next priority Mission Set;
confirming a Visual Observer, Vehicle, Sensors onboard the Vehicle and FAA waivers are ready for flight;
updating Vehicle flight logs;
reconfiguring a Mission Set;
notifying Pilots in geographic areas adjacent to the Mission Set that a mission is active;
determining if the Mission Set requires visual line of sight operation or a Visual Observer; and
notifying the Visual Observer the mission is ready.

2. A method for pre-flight checking of a Vehicle by a centralized Vehicle Flight Management and including a related method of a Visual Observer confirming a visual inspection of the Vehicle and updating a Flight Log, comprising:
performing a pre-flight check for the Vehicle and Sensors;
performing a pre-flight check of a mission flight plan check;
reconfiguring a Vehicle flight plan;
issuing a command to a Vehicle to launch; and
issuing a command to Vehicles, which are assigned to a Fleet, to begin communicating, by radio transmission, with each other.

3. A method for directing a flight and operation of Vehicles to a Vehicle's next WayPoint in a Mission Set by a centralized Vehicle Flight Management, comprising:
sending a command to a Vehicle for the Vehicle to proceed to a flight plan altitude;
sending an acknowledgement to a Management Center that the Vehicle is at the flight plan altitude; and
sending the Vehicle a command to proceed to the next WayPoint.

4. A method for operating and controlling a Vehicle, while the Vehicle is in flight, by a centralized Vehicle Flight Management and a related method of a Pilot confirming the Vehicle has reached a Project Set, entering a first WayPoint and its location, comprising:
updating a flight log;
confirming the Vehicle is on time;
confirming the Vehicle fuel level is sufficient to complete a Mission Set;
confirming there are no obstacles ahead in a Vehicle's path;
sending a command to the Vehicle to travel to the first WayPoint;
confirming the Vehicle has completed the Project Set;
sending a command to the Vehicle to advance to a return home altitude; and
confirming the Vehicle acknowledging it has reached the return home altitude.

5. A method for operating and controlling a Vehicle to return to an origin location, by a centralized Vehicle Flight Management, comprising:
confirming the Vehicle reaching the origin location;
sending a command to the Vehicle to land, further comprising a related process of a Visual Observer confirming the Vehicle has landed;
confirming the Vehicle has landed; and
sending a command to the Vehicle to Down Vehicle systems and processes.

6. A method for operating and controlling a Vehicle by a centralized Vehicle Flight Management and determining if there is a flight issue;
determining if there is a flight obstacle;
determining there is a flight obstacle ahead;
confirming there is a flight issue with a Visual Observer;
determining there is an emergency threat to the Vehicle or to a public;
confirming there is a flight issue with the Visual Observer;
confirming with the Visual Observer there is an emergency threat to the Vehicle or to the public;
issuing a command to the Vehicle to immediately land and Down Vehicle systems and processes;
sending the Vehicle a location of a Landing Zone (L/Z) for the Vehicle; and
sending the Vehicle a command to immediately land at the L/Z.

7. A method for assigning Project Set WayPoints for a Vehicle by a centralized Vehicle Flight Management and notifying a Visual Observer about WayPoints for the Vehicle, comprising:
issuing new WayPoints to the Vehicle;
determining a new flight path for the Vehicle; and
sending to the Vehicle a command to stop moving.

8. A method for operating and controlling a Vehicle to recharge by a centralized Vehicle Flight Management, comprising:
determining if the Vehicle needs a recharge;
assessing the location of a nearest Charger to the Vehicle;
determining there is insufficient fuel for the Vehicle to reach the nearest Charger;
authorizing the Vehicle to proceed to a location of an unauthorized Charger for which the Vehicle is not authorized;
approving a recharging operation for the Vehicle; and
telling a Visual Observer recharge status for the Vehicle.

9. A method for operating and controlling a Vehicle to be repaired by a centralized Vehicle Flight Management and a related method of a Pilot determining the Vehicle needs repair, comprising:
sending the Vehicle to perform a Vehicle full system test;
reviewing the results of the Vehicle full system test;
confirming, with a Visual Observer, the Vehicle needs repair; and
determining a nearest Repair Depot.

10. A method for operating and controlling a Vehicle with flight issues other than equipment malfunctions by a centralized Vehicle Flight Management, comprising:
determining a nature of issues other than equipment malfunction;
determining if the Vehicle returns to home; and
advising a Visual Observer the nature of the issues other than equipment malfunction.

11. A method for a centralized Vehicle Flight Management for transmitting a radio frequency signal, comprising:
converting a ‘Snap’ to digital data for transmission;
converting the digital data to analog signals for transmission;
selecting a transmitting radio frequency;
selecting either a 700 MHz radio transmission system or a 1250 MHz radio transmission system;
inputting the digital data into a 700 MHz band modem device;
inputting the radio frequency signal into a 700 MHz band time division and frequency division Multiplexor;
inputting the radio frequency signal into a 700 MHz band radio transmitter;
inputting the radio frequency signal into a 700 MHz band radio antenna;
inputting the radio frequency signal into a 700 MHz band radio transmitter;
inputting the digital data into a 1250 MHz band modem device;
inputting the radio frequency signal into a 1250 MHz band time division and frequency division Multiplexor;
inputting the radio frequency signal into a 1250 MHz band radio transmitter; and
inputting the radio frequency signal into a 1250 MHz band radio antenna;

12. A method for a centralized Vehicle Flight Management process for receiving radio signals and receiving the radio frequency signal from a 1250 MHz band radio antenna, the method comprising:
inputting the radio frequency signal into a 1250 MHz band radio transmitter;
inputting the radio frequency signal into a 1250 MHz band signal filter;
inputting the radio frequency signal into a 1250 MHz band modem device;
receiving the radio frequency signal from a 700 MHz band radio antenna;
inputting the radio frequency signal into a 700 MHz band radio transmitter;
inputting the radio frequency signal into a 700 MHz band signal filter;
inputting the radio frequency signal into a 700 MHz band modem device;
converting the analog signals to digital data;
decrypting the digital data into a Snap; and
interfacing Snap data with a data store.

13. The method of claim 1 further comprising a step of the centralized Vehicle Flight Management confirming the plurality of Pilots, Visual Observers, Vehicles, Sensors, Waivers are ready for a Mission Set.

14. The method of claim 1 further comprising a step of the centralized Vehicle Flight Management having a Pilot log into a Flight Log.

15. The method of claim 1 further comprising a step of the centralized Vehicle Flight Management having a Pilot reconfigure Mission Set.

16. The method of claim 1 further comprising a step of the centralized Vehicle Flight Management having a Pilot notify Pilots in adjacent GEO Areas the Mission Set is active.

17. The method of claim 1 further comprising the centralized Vehicle Flight Management determining if beyond a visual line-of-sight a Visual Observer is required for the Mission Set.

18. The method of claim 1 further comprising the centralized Vehicle Flight Management having a Pilot communicate with a VO by audio.

19. The method of claim 1 further comprising the centralized Vehicle Flight Management having a Pilot determine the Next Priority Mission Set for a Vehicle.

20. The method of claim 2 further comprising the centralized Vehicle Flight Management having a VO confirm visual inspection of a Vehicle and log in confirmation in the Flight Log.

21. The method of claim 2 further comprising the centralized Vehicle Flight Management having a Pilot perform a remote Preflight Check of the Vehicle and Sensors on board the Vehicle.

22. The method of claim 2 further comprising the centralized Vehicle Flight Management having a Pilot perform actions required in a Pre-flight Flight Plan Checklist.

23. The method of claim 2 further comprising the centralized Vehicle Flight Management having a Pilot reconfigure the Vehicle flight plan.

24. The method of claim 2 further comprising the centralized Vehicle Flight Management having a Pilot Command a Vehicle to Launch.

25. The method of claim 2 further comprising the centralized Vehicle Flight Management having a Pilot command a plurality of Vehicles, in a fleet, to communicate with each other.

26. The method of claim 3 further comprising the centralized Vehicle Flight Management having a Pilot command a Vehicle to go to a starting altitude contained a Flight Plan.

27. The method of claim 3 further comprising the centralized Vehicle Flight Management having a Pilot confirm the Vehicle has reached a starting altitude contained a Flight Plan.

28. The method of claim 3 further comprising the centralized Vehicle Flight Management having a Pilot command a Vehicle to go to the next WayPoint in the Mission Set.

29. The method of claim 4 further comprising the centralized Vehicle Flight Management commanding a Vehicle to send its current location and altitude when the Vehicle reaches an entry WayPoint for the Project Set.

30. The method of claim 4 further comprising the centralized Vehicle Flight Management having a Pilot update a Vehicle Flight Log for the events, status, conditions of the Vehicle and onboard Sensors during a Mission Set.

31. The method of claim 4 further comprising the centralized Vehicle Flight Management having a Pilot confirm a Vehicle is on time in the operation and execution of the Mission Set.

32. The method of claim 4 further comprising the centralized Vehicle Flight Management having a Pilot confirm a Vehicle has sufficient fuel to complete the Project Set.

33. The method of claim 4 for the centralized Vehicle Flight Management having a Pilot confirm there are no obstacles in the Vehicle's path during operation and execution of a Mission Set.

34. The method of claim 4 further comprising the centralized Vehicle Flight Management having a Pilot confirm the Vehicle has completed the Project Set included in the Mission Set.

35. The method of claim 4 further comprising the centralized Vehicle Flight Management having the Pilot command the Vehicle to return to a Vehicle's origin and advance to an Origin altitude.

36. The method of claim 4 further comprising the centralized Vehicle Flight Management having a Pilot confirm a Vehicle acknowledges it is at the correct altitude to return to an Origin.

37. The method of claim 4 further comprising the centralized Vehicle Flight Management having a Pilot command the Vehicle to advance to a next WayPoint in the Project Set of the Mission Set.

38. The method of claim 5 further comprising the centralized Vehicle Flight Management having a Pilot confirm Vehicle arrived at a Vehicle Origin.

39. The method of claim 5 further comprising the centralized Vehicle Flight Management having a Pilot command the Vehicle to land.

40. The method of claim 5 further comprising the centralized Vehicle Flight Management having the Pilot confirm a Vehicle has landed on a ground at the origin location.

41. The method of claim 5 further comprising the centralized Vehicle Flight Management having a Pilot send a command to a Vehicle for the Vehicle to ‘Down’ itself.

42. The method of claim 5 further comprising the centralized Vehicle Flight Management having a Visual Observer confirm, by audio, a Vehicle has landed on a ground and is ‘Down’.

43. The method of claim 6 further comprising the centralized Vehicle Flight Management having a Pilot determine there is a flight issue during the operation and execution of a Mission Set.

44. The method of claim 6 further comprising the centralized Vehicle Flight Management having a Pilot assess if a flight issue is an emergency threat to Vehicle or the public.

45. The method of claim 6 further comprising the centralized Vehicle Flight Management having a Pilot determine whether there is an obstacle in the Vehicle flight path of a Mission Set.

46. The method of claim 6 further comprising the centralized Vehicle Flight Management having a Pilot confirm an emergency flight plan issue with the Visual Observer by audio.

47. The method of claim 6 further comprising the centralized Vehicle Flight Management having a Pilot issue a “Down Now” command to a Vehicle during the operation and execution of a Mission Set.

48. The method of claim 6 further comprising the centralized Vehicle Flight Management having a Pilot confirm, by audio, with the Visual Observer an obstacle in the Vehicle Flight Path of a Mission Set.

49. The method of claim 6 further comprising the centralized Vehicle Flight Management sending a command to a Vehicle, during a Mission Set, for the Vehicle to “Land Now”.

50. The method of claim 6 further comprising the centralized Vehicle Flight Management having a Pilot send the location and altitude to a Vehicle for a Landing Zone (L/Z) for the Vehicle to land.

51. The method of claim 7 further comprising the centralized Vehicle Flight Management having a Pilot issue a command to a Vehicle to stop, at its current location, during the operation and execution of a Mission Set.

52. The method of claim 7 further comprising the centralized Vehicle Flight Management having a Pilot inform a Visual Observer, by audio, of a new WayPoint, in a Mission Set, for a Vehicle.

53. The method of claim 7 further comprising the centralized Vehicle Flight Management having a Pilot issue a command to a Vehicle for a new WayPoint, in a Mission Set, for a Vehicle.

54. The method of claim 7 further comprising the centralized Vehicle Flight Management having a Pilot determine a new Vehicle Flight Path for a Mission Set.

55. The method of claim 8 further comprising the centralized Vehicle Flight Management having a Pilot determine the Vehicle needs to recharge during operation and execution of a Mission Set.

56. The method of claim 8 further comprising the centralized Vehicle Flight Management having a Pilot assess nearest Charger locations for a Vehicle to recharge during operation and execution of a Mission Set.

57. The method of claim 8 further comprising the centralized Vehicle Flight Management having a Pilot determine if a Vehicle has sufficient fuel to reach a nearest Charger for a Vehicle to recharge during operation and execution of a Mission Set.

58. The method of claim 8 further comprising the centralized Vehicle Flight Management having a Pilot approve a Vehicle to use a Charger location, not authorized for the Vehicle's use, for a Vehicle to recharge during operation and execution of a Mission Set.

59. The method of claim 8 further comprising the centralized Vehicle Flight Management having a Pilot inform a Visual Observer, by audio, of the Vehicle recharge status.

60. The method of claim 8 further comprising the centralized Vehicle Flight Management having a Pilot approve a Vehicle recharge operation during operation and execution of a Mission Set.

61. The method of claim 9 further comprising the centralized Vehicle Flight Management having a Pilot determine a Vehicle needs repair during operation and execution of a Mission Set.

62. The method of claim 9 further comprising the centralized Vehicle Flight Management having a Pilot command the Vehicle to perform the Vehicle full system test during operation and execution of a Mission Set.

63. The method of claim 9 further comprising the centralized Vehicle Flight Management to have a Pilot access and review a Vehicle full system test results, during operation and execution of a Mission Set.

64. The method of claim 9 further comprising the centralized Vehicle Flight Management having a Pilot confirm, by audio with the Visual Observer, a Vehicle needs repair during operation and execution of a Mission Set.

65. The method of claim 9 further comprising the centralized Vehicle Flight Management having a Pilot determine the nearest repair depot during operation and execution of a Mission Set.

66. The method of claim 10 further comprising the centralized Vehicle Flight Management having a Pilot determine the nature of an issue other than a Vehicle emergency issue or a Vehicle operating issue during operation and execution of a Mission Set.

67. The method of claim 10 further comprising the centralized Vehicle Flight Management having a Pilot determine if a Vehicle must return to the Vehicle Origin during operation and execution of a Mission Set.

68. The method of claim 10 further comprising the centralized Vehicle Flight Management having a Pilot communicate, by audio, with the Visual Observer about a Vehicle issue during operation and execution of a Mission Set.
